(19) United States
(12) Patent Application Publication
(10) Pub. No.: US 2008/0091871 A1
(43) Pub. Date: Apr. 17, 2008

(54) Non-volatile memory with worst-case control data management

(76) Inventors: Alan David Bennett, Edinburgh (GB); Neil David Hutchison, Larbert (GB); Sergey Anatolievich Gorobets, Edinburgh (GB)

Correspondence Address: DAVIS WRIGHT TREMAINE LLP, 505 MONTGOMERY STREET, SUITE 800, SAN FRANCISCO, CA, 94111, US

(21) Appl. No.: 11/549,040

(22) Filed: Oct. 12, 2006

(51) Int. Cl. G06F 13/00; G06F 12/00

(52) U.S. Cl. 711/103; 711/165

(57) ABSTRACT

In a nonvolatile memory with a block management system, data written to blocks include host write data and also system control data for managing the blocks. When a block is full or no longer accepting data, it is closed after valid versions of the data on it are relocated to another block in a rewrite operation. An improved pre-emptive rewrite scheme prevents a worst-case situation where multiple rewrites to occur at once when they happened to be full at the same time. Particularly, the scheduling of the pre-emptive rewrites for control data is based on a number of considerations including the time required for each control block rewrite and the time available for control block rewrites based on the configuration of the update blocks for storing host data, the time required in the foreground host operation and the host write latency.

### CROSS REFERENCE TO RELATED APPLICATIONS

This application is also related to the following U.S. patent application: U.S. application Ser. No. ______, entitled “Method for Non-Volatile Memory With Worst-Case Control Data Management,” by Bennett et al, filed concurrently herewith, on Oct. 12, 2006.

### FIELD OF THE INVENTION

This invention relates generally to non-volatile semiconductor memory and specifically to those having a memory block management system with an improved system for managing system data used to control the operation of the memory.

### BACKGROUND OF THE INVENTION

Solid-state memory capable of nonvolatile storage of charge, particularly in the form of EEPROM and flash EEPROM packaged as a small form factor card, has recently become the storage of choice in a variety of mobile and handheld devices, notably information appliances and consumer electronics products. Unlike RAM (random access memory) that is also solid-state memory, flash memory is non-volatile, and retaining its stored data even after power is turned off. Also, unlike ROM (read only memory), flash memory is rewritable similar to a disk storage device. In spite of the higher cost, flash memory is increasingly being used in mass storage applications. Conventional mass storage, based on rotating magnetic medium such as hard drives and floppy disks, is unsuitable for the mobile and handheld environment. This is because disk drives tend to be bulky, are prone to mechanical failure and have high latency and high power requirements. These undesirable attributes make disk-based storage impractical in most mobile and portable applications. On the other hand, flash memory, both embedded and in the form of a removable card is ideally suited in the mobile and handheld environment because of its small size, low power consumption, high speed and high reliability features.

Flash EEPROM is similar to EEPROM (electrically erasable and programmable read-only memory) in that it is a non-volatile memory that can be erased and have new data written or “programmed” into their memory cells. Both utilize a floating (unconnected) conductive gate, in a field effect transistor structure, positioned over a channel region in a semiconductor substrate, between source and drain regions. A control gate is then provided over the floating gate. The threshold voltage characteristic of the transistor is controlled by the amount of charge that is retained on the floating gate. That is, for a given level of charge on the floating gate, there is a corresponding voltage (threshold) that must be applied to the control gate before the transistor is turned “on” to permit conduction between its source and drain regions. In particular, flash memory such as Flash EEPROM allows entire blocks of memory cells to be erased at the same time.

The floating gate can hold a range of charges and therefore can be programmed to any threshold voltage level within a threshold voltage window. The size of the threshold voltage window is delimited by the minimum and maximum threshold levels of the device, which in turn correspond to the range of the charges that can be programmed onto the floating gate. The threshold window generally depends on the memory device's characteristics, operating conditions and history. Each distinct, resolvable threshold voltage level range within the window may, in principle, be used to designate a definite memory state of the cell. When the threshold voltage is partitioned into two distinct regions, each memory cell will be able to store one bit of data. Similarly, when the threshold voltage window is partitioned into more than two distinct regions, each memory cell will be able to store more than one bit of data.

The transistor serving as a memory cell is typically programmed to a “programmed” state by one of two mechanisms. In “hot electron injection,” a high voltage applied to the drain accelerates electrons across the substrate channel region. At the same time a high voltage applied to the control gate pulls the hot electrons through a thin gate dielectric onto the floating gate. In “tunneling injection,” a high voltage is applied to the control gate relative to the substrate. In this way, electrons are pulled from the substrate to the intervening floating gate. While the term “program” has been used historically to describe writing to a memory by injecting electrons to an initially erased charge storage unit of the memory cell so as to alter the memory state, it has now been used interchangeable with more common terms such as “write” or “record.”

The memory device may be erased by a number of mechanisms. For EEPROM, a memory cell is electrically erasable, by applying a high voltage to the substrate relative to the control gate so as to induce electrons in the floating gate to tunnel through a thin oxide to the substrate channel region (i.e., Fowler-Nordheim tunneling.) Typically, the EEPROM is erasable byte by byte. For flash EEPROM, the memory is electrically erasable either all at once or one or more minimum erasable blocks at a time, where a minimum erasable block may consist of one or more sectors and each sector may store 512 bytes or more of data.

The memory device typically comprises one or more memory chips that may be mounted on a card. Each memory chip comprises an array of memory cells supported by peripheral circuits such as decoders and erase, write and read circuits. The more sophisticated memory devices also come with a controller that performs intelligent and higher level memory operations and interfacing.

There are many commercially successful non-volatile solid-state memory devices being used today. These memory devices may be flash EEPROM or may employ other types of nonvolatile memory cells. Examples of flash memory and systems and methods of manufacturing them are given in U.S. Pat. Nos. 5,070,032, 5,095,344, 5,315,541, 5,343,063, and 5,661,053, 5,313,421 and 6,222,762. In particular, flash memory devices with NAND string structures are described in U.S. Pat. Nos. 5,570,315, 5,903,495, 6,046,935. Also nonvolatile memory devices are also manufactured from memory cells with a dielectric layer for storing charge. Instead of the conductive floating gate elements described earlier, a dielectric layer is used. Such memory devices utilizing dielectric storage element have been described by Eitan et al., “NROM: A Novel Localized Trapping, 2-Bit Nonvolatile Memory Cell,” IEEE Electron Device Letters, vol. 21, no. 11, November 2000, pp. 543-545. An ONO dielectric layer extends across the channel between source and drain diffusions. The charge for one data bit is localized in the dielectric layer adjacent to the drain, and the charge for the other data bit is localized in the dielectric layer adjacent to the source. For example, U.S. Pat. Nos. 5,768,192 and 6,011,725 disclose a nonvolatile memory cell having a trapping dielectric sandwiched between two silicon dioxide layers. Multi-state data storage is implemented by separately reading the binary states of the spatially separated charge storage regions within the dielectric.

In order to improve read and program performance, multiple charge storage elements or memory transistors in an array are read or programmed in parallel. Thus, a “page” of memory elements are read or programmed together. In existing memory architectures, a row typically contains several interleaved pages or it may constitute one page. All memory elements of a page will be read or programmed together.

In flash memory systems, erase operation may take as much as an order of magnitude longer than read and program operations. Thus, it is desirable to have the erase block of substantial size. In this way, the erase time is amortized over a large aggregate of memory cells.

The nature of flash memory predicates that data must be written to an erased memory location. If data of a certain logical address from a host is to be updated, one way is rewrite the update data in the same physical memory location. That is, the logical to physical address mapping is unchanged. However, this will mean the entire erase block contain that physical location will have to be first erased and then rewritten with the updated data. This method of update is inefficient, as it requires an entire erase block to be erased and rewritten, especially if the data to be updated only occupies a small portion of the erase block. It will also result in a higher frequency of erase recycling of the memory block, which is undesirable in view of the limited endurance of this type of memory device.

Another problem with managing flash memory system has to do with system control and directory data. The data is produced and accessed during the course of various memory operations. Thus, its efficient handling and ready access will directly impact performance. It would be desirable to maintain this type of data in flash memory because flash memory is meant for storage and is nonvolatile. However, with an intervening file management system between the controller and the flash memory, the data can not be accessed as directly. Also, system control and directory data tends to be active and fragmented, which is not conducive to storing in a system with large size block erase. Conventionally, this type of data is set up in the controller RAM, thereby allowing direct access by the controller. After the memory device is powered up, a process of initialization enables the flash memory to be scanned in order to compile the necessary system control and directory information to be placed in the controller RAM. This process takes time and requires controller RAM capacity, all the more so with ever increasing flash memory capacity.

U.S. Pat. No. 6,567,307 discloses a method of dealing with sector updates among large erase block including recording the update data in multiple erase blocks acting as scratch pad and eventually consolidating the valid sectors among the various blocks and rewriting the sectors after rearranging them in logically sequential order. In this way, a block needs not be erased and rewritten at every slightest update.

WO 03/027828 and WO 00/49488 both disclose a memory system dealing with updates among large erase block including partitioning the logical sector addresses in zones. A small zone of logical address range is reserved for active system control data separate from another zone for user data. In this way, manipulation of the system control data in its own zone will not interact with the associated user data in another zone. Updates are at the logical sector level and a write pointer points to the corresponding physical sectors in a block to be written. The mapping information is buffered in RAM and eventually stored in a sector allocation table in the main memory. The latest version of a logical sector will obsolete all previous versions among existing blocks, which become partially obsolete. Garbage collection is performed to keep partially obsolete blocks to an acceptable number.

Prior art systems tend to have the update data distributed over many blocks or the update data may render many existing blocks partially obsolete. The result often is a large amount of garbage collection necessary for the partially obsolete blocks, which is inefficient and causes premature aging of the memory. Also, there is no systematic and efficient way of dealing with sequential update as compared to non-sequential update.

In a data storage system organized into blocks of memory locations, a host can store host data into a set of host data blocks. In the meantime, the system also stores control data into another set of control data blocks to keep track of how the blocks are allocated and where the data are located among the blocks. In either case, as data and their updates fill up a block, the block will be closed after its latest version of the data is relocated to an empty block. This rewrite process is generally referred to as a garbage collection. There are different types of garbage collections with some taking more time than others.

Garbage collections may be triggered during a host write when a block boundary is crossed or when there is a defect encountered. Similarly, garbage collections may be triggered during the memory system's internal or housekeeping operations, such as when a control block boundary is crossed (control block rewrite) or when there is a program error or a defect encountered (error handling.) Other examples of garbage collection include wear leveling and read scrub.

Since garbage collections are time consuming and in some worst-case situation, several garbage collections may take place in succession, system timings are likely to be violated and the memory may become inoperative.

Therefore there is a general need for high capacity and high performance non-volatile memory. In particular, there is a need to have a high capacity nonvolatile memory able to conduct memory operations without the aforementioned problems.

### SUMMARY OF INVENTION

Thus it is an object of the invention to provide a robust data storage system able to handle internal operations in any host update sequence in the foreground without violating timing requirements.

In particular, it is an object of the invention to reduce the number of reserved blocks in a pool of memory blocks for storing system control data used for controlling memory operations and to reduce the worst case timing for a control block update.

According to the present invention, an improved scheme is provided to avoid possible lengthy cascade updates of the control data. This is accomplished by setting a block margin for each type of control data and rewrite the block at the earliest opportunity when the block margin has been reached. In particular, the margin is set just sufficient to accommodate data accumulated in a predetermined interval before the rewrite can take place so as not to totally fill the block before the rewrite can take place. The predetermined interval is determined, among other things, by considering a host write pattern that yields a worst-case interval before the rewrite can take place. Other considerations for setting the margin include the time required for each control block rewrite and the time available for control block rewrites based on the configuration of the update blocks for storing host data, the time required in the foreground host operation and the host write latency.

In one implementation, when there are more than one control block rewrites pending, the one with a control data type that is more active is preferentially executed in the next available opportunity found in a host operation. In this way, a minimum of reserved blocks need be set aside as resource for the control block rewrites as only one control block rewrite will take place at a time.

The improvement also makes allowance for multiple program errors per the cascade control update, so that it is able to handle more than one ECC or program error occurring one soon after another within the timing limitation. This feature is particularly important for one-time programmable (“OTP”) memory since the risk is quite high if the defects are not patched on the lower level. The improvement also enables a minimum of blocks to be reserved in a pool of update blocks for storing control data. The reserved blocks enable the memory control system to handle the worst cascade update where all control data blocks can potentially be filled at the same time, and must all be rewritten in the same busy period. If fewer blocks are required to be reserved for control data, more blocks will be available for host data updates.

The advantages of the invention include the following. An increased number of errors can be handled in the worst-case update sequence. A worst-case of a longest combination of garbage collections (GC) and control block compaction can be avoided. For example, Chaotic GC takes longer than Sequential GC, so by avoiding doing control updates at the same time as Chaotic GC the worst case command latency can be reduced. Optimized performance is obtained by optimum selection of the block margins (e.g., by selecting a fuller control block to compact) and scheduling of an internal operation to perform. Reduced number of reserved erased blocks is required to handle the worst case update sequence. Errors can be handled much quicker in the cases of pre-emptive internal operations as the error handling can be rescheduled. Partial error handling and schedule completion of the error handling is possible. It is possible to schedule ECC error handling during read operation, which has short latency, to be done later (e.g., during next write operation.)

Additional features and advantages of the present invention will be understood from the following description of its preferred embodiments, which description should be taken in conjunction with the accompanying drawings.

### BRIEF DESCRIPTION OF THE DRAWINGS

FIG. 1 illustrates schematically the main hardware components of a memory system suitable for implementing the present invention.

FIG. 2 illustrates the memory being organized into physical groups of sectors (or metablocks) and managed by a memory manager of the controller, according to a preferred embodiment of the invention.

FIGS. 3A(i)-3A(iii) illustrate schematically the mapping between a logical group and a metablock, according to a preferred embodiment of the present invention.

FIG. 3B illustrates schematically the mapping between logical groups and metablocks.

FIG. 4 illustrates the alignment of a metablock with structures in physical memory.

FIG. 5A illustrates metablocks being constituted from linking of minimum erase units of different planes.

FIG. 5B illustrates one embodiment in which one minimum erase unit (MEU) is selected from each plane for linking into a metablock.

FIG. 5C illustrates another embodiment in which more than one MEU are selected from each plane for linking into a metablock.

FIG. 6 is a schematic block diagram of the metablock management system as implemented in the controller and flash memory.

FIG. 7A illustrates an example of sectors in a logical group being written in sequential order to a sequential update block.

FIG. 7B illustrates an example of sectors in a logical group being written in chaotic order to a chaotic update block.

FIG. 8 illustrates an example of sectors in a logical group being written in sequential order to a sequential update block as a result of two separate host write operations that has a discontinuity in logical addresses.

FIG. 9 is a flow diagram illustrating a process by the update block manager to update a logical group of data, according a general embodiment of the invention.

FIG. 10 is a flow diagram illustrating a process by the update block manager to update a logical group of data, according a preferred embodiment of the invention.

FIG. 11A is a flow diagram illustrating in more detail the consolidation process of closing a chaotic update block shown in FIG. 10.

FIG. 11B is a flow diagram illustrating in more detail the compaction process for closing a chaotic update block shown in FIG. 10.

FIG. 12A illustrates all possible states of a Logical Group, and the possible transitions between them under various operations.

FIG. 12B is a table listing the possible states of a Logical Group.

FIG. 13A illustrates all possible states of a metablock, and the possible transitions between them under various operations. A metablock is a Physical Group corresponding to a Logical Group.

FIG. 13B is a table listing the possible states of a metablock.

FIGS. 14(A)-14(J) are state diagrams showing the effect of various operations on the state of the logical group and also on the physical metablock.

FIG. 15 illustrates a preferred embodiment of the structure of an allocation block list (ABL) for keeping track of opened and closed update blocks and erased blocks for allocation.

FIG. 16A illustrates the data fields of a chaotic block index (CBI) sector.

FIG. 16B illustrates an example of the chaotic block index (CBI) sectors being recorded in a dedicated metablock.

FIG. 16C is a flow diagram illustrating access to the data of a logical sector of a given logical group undergoing chaotic update.

FIG. 16D is a flow diagram illustrating access to the data of a logical sector of a given logical group undergoing chaotic update, according to an alternative embodiment in which logical group has been partitioned into subgroups.

FIG. 16E illustrates examples of Chaotic Block Indexing (CBI) sectors and their functions for the embodiment where each logical group is partitioned into multiple subgroups.

FIG. 17A illustrates the data fields of a group address table (GAT) sector.

FIG. 17B illustrates an example of the group address table (GAT) sectors being recorded in a GAT block.

FIG. 18 is a schematic block diagram illustrating the distribution and flow of the control and directory information for usage and recycling of erased blocks.

FIG. 19 is a flow chart showing the process of logical to physical address translation.

FIG. 20 illustrates the hierarchy of the operations performed on control data structures in the course of the operation of the memory management.

FIG. 21 illustrates schematically the two prescribed limits on the number of update blocks for a block managing system.

FIG. 22 illustrates typical examples of combinations of the two limits optimized for various memory devices.

FIG. 23A illustrates schematically an update pool with a “5-2” configuration as described in FIG. 22.

FIG. 23B illustrates schematically the closing of the least active update block in order to make room for a new update block.

FIG. 23C illustrates schematically introducing a newly allocated update block into the pool after a closed update block has been removed to make room.

FIG. 24A illustrates schematically an update pool with a “5-2” configuration as described in FIG. 22.

FIG. 24B illustrates schematically the closing of the chaotic update block in order to make room for a new chaotic update block.

FIG. 24C illustrates schematically introducing a newly allocated chaotic update block into the pool after a closed chaotic update block has been removed to make room.

FIG. 25A illustrates schematically a timing diagram for a memory executing a host write involving a simple sequential update.

FIG. 25B illustrates schematically a timing diagram for a memory executing a host write involving a sequential update plus a closure of another sequential block.

FIG. 25C illustrates schematically a timing diagram for a memory executing a host write involving a chaotic update plus a closure and relocation of another chaotic update block.

FIG. 25D illustrates schematically a timing diagram for a memory executing a host write involving a chaotic update plus two passes in closing another chaotic update block.

FIG. 26 illustrates schematically a pool of blocks reserved for storing control data.

FIG. 27A is a table illustrates a worst-case write pattern producing a maximum frequency of chaotic block consolidations for a memory configuration with a “7-3” update pool.

FIG. 27B is a table illustrates a worst-case write pattern producing a continuous run of sequential block closes for a memory configuration with a “7-3” update pool.

FIG. 28A is a table illustrates a worst-case write pattern producing a maximum frequency of chaotic block consolidations for a memory configuration with a “3-1” update pool.

FIG. 28B is a table illustrates a worst-case write pattern producing a continuous run of sequential block closes for a memory configuration with a “3-1” update pool.

FIG. 29A is a table illustrates a worst-case write pattern producing a maximum frequency of chaotic block consolidations for a memory configuration with a “3-3” update pool.

FIG. 29B is a table illustrates a worst-case write pattern producing a continuous run of sequential block closes for a memory configuration with a “3-3” update pool.

FIG. 30 is a table listing example calculated margins for each control data type by applying the control block rewrite schedule of Method 1.

FIG. 31 is a table listing example calculated margins for each control data type by applying the control block rewrite schedule of Method 2.

FIG. 32 is a table listing example calculated margins for each control data type by applying the control block rewrite schedule of Method 3.

FIG. 33 is a table listing example calculated margins for each control data type by applying the control block rewrite schedule of Method 4.

FIG. 34 is a flow diagram illustrating a scheme for pre-emptive rewrites of control data blocks based on worst-case considerations.

FIG. 35 is a flow diagram illustrating an alternative scheme for pre-emptive rewrites similar to that of FIG. 34 except with the additional preferential treatment of a higher ranked data type.

FIG. 36 illustrates an alternative step for one of the steps of the flow diagrams of FIGS. 34 and 35.

FIG. 37 illustrates another alternative step for one of the steps of the flow diagram of FIGS. 34 and 35.

### DETAILED DESCRIPTION OF THE PREFERRED EMBODIMENTS

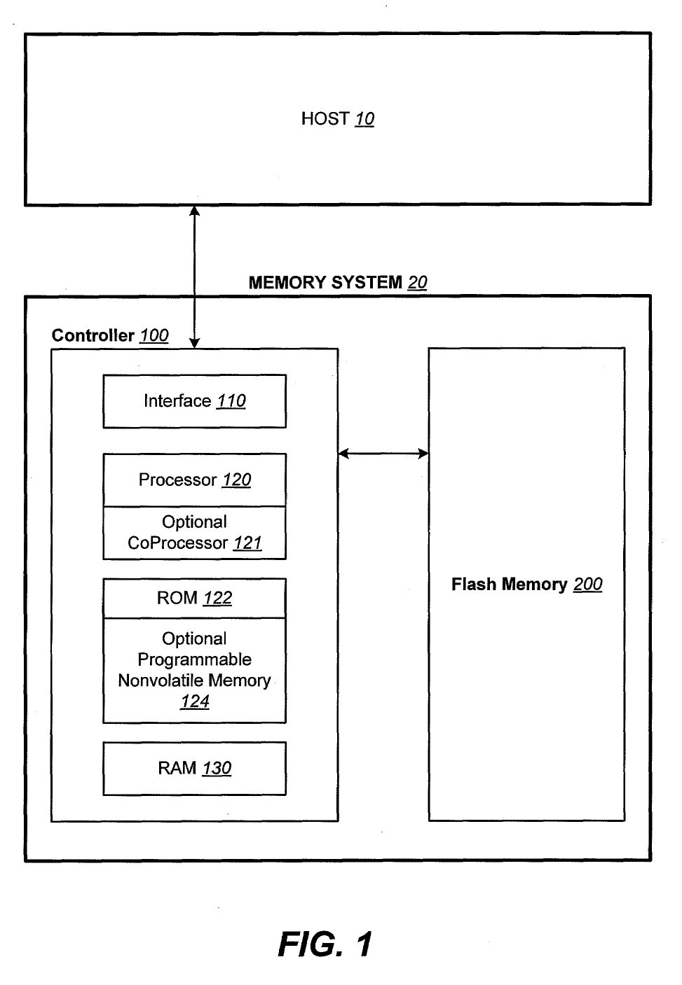

FIG. 1 to FIG. 20 illustrate examples of memory systems with block management in which the various aspects of the present invention may be implemented. Similar memory systems have been disclosed in the following U.S. Patent Application Publications. U.S. Patent Application Publications No. US-2005-0144365-A1, entitled “Non-Volatile Memory and Method with Control Data Management,” by Gorobets et al. U.S. Application Publication No. US-2006-0155922-A1 published Jul. 13, 2006, entitled “Non-Volatile Memory And Method With Improved Indexing For Scratch Pad And Update Blocks”, by Gorobets et al.

FIG. 1 illustrates schematically the main hardware components of a memory system suitable for implementing the present invention. The memory system 20 typically operates with a host 10 through a host interface. The memory system is typically in the form of a memory card or an embedded memory system. The memory system 20 includes a memory 200 whose operations are controlled by a controller 100. The memory 200 comprises of one or more array of non-volatile memory cells distributed over one or more integrated circuit chip. The controller 100 includes an interface 110, a processor 120, an optional coprocessor 121, ROM 122 (read-only-memory), RAM 130 (random access memory) and optionally programmable nonvolatile memory 124. The interface 110 has one component interfacing the controller to a host and another component interfacing to the memory 200. Firmware stored in nonvolatile ROM 122 and/or the optional nonvolatile memory 124 provides codes for the processor 120 to implement the functions of the controller 100. Error correction codes may be processed by the processor 120 or the optional coprocessor 121. In an alternative embodiment, the controller 100 is implemented by a state machine (not shown.) In yet another embodiment, the controller 100 is implemented within the host.

### Logical And Physical Block Structures

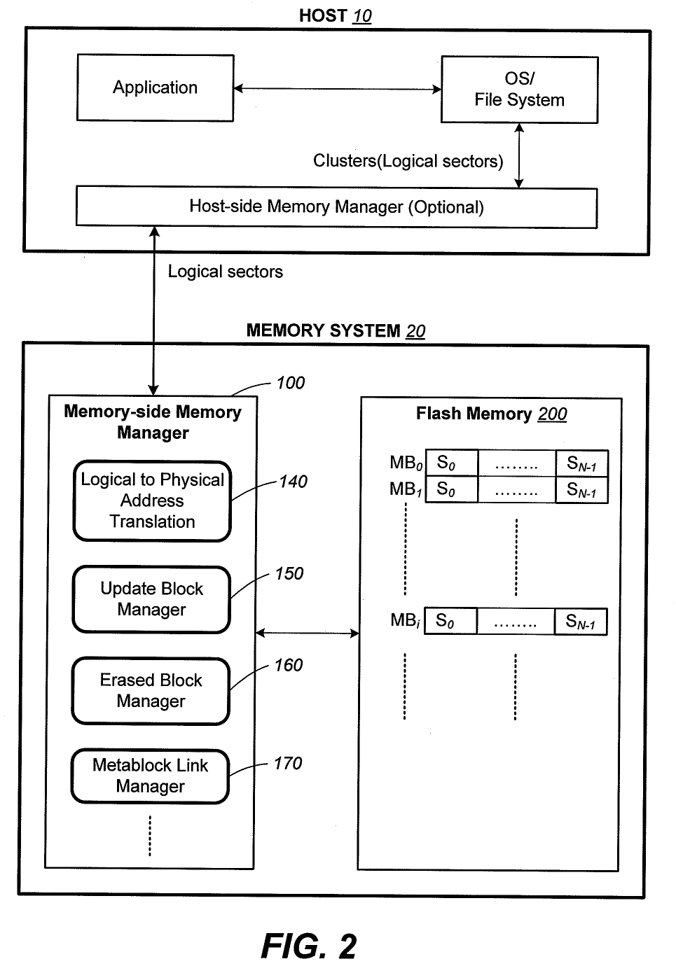

FIG. 2 illustrates the memory being organized into physical groups of sectors (or metablocks) and managed by a memory manager of the controller, according to a preferred embodiment of the invention. The memory 200 is organized into metablocks, where each metablock is a group of physical sectors S₀, . . . , S_{N-1} that are erasable together.

The host 10 accesses the memory 200 when running an application under a file system or operating system. Typically, the host system addresses data in units of logical sectors where, for example, each sector may contain 512 bytes of data. Also, it is usual for the host to read or write to the memory system in unit of logical clusters, each consisting of one or more logical sectors. In some host systems, an optional host-side memory manager may exist to perform lower level memory management at the host. In most cases during read or write operations, the host 10 essentially issues a command to the memory system 20 to read or write a segment containing a string of logical sectors of data with contiguous addresses.

A memory-side memory manager is implemented in the controller 100 of the memory system 20 to manage the storage and retrieval of the data of host logical sectors among metablocks of the flash memory 200. In the preferred embodiment, the memory manager contains a number of software modules for managing erase, read and write operations of the metablocks. The memory manager also maintains system control and directory data associated with its operations among the flash memory 200 and the controller RAM 130.

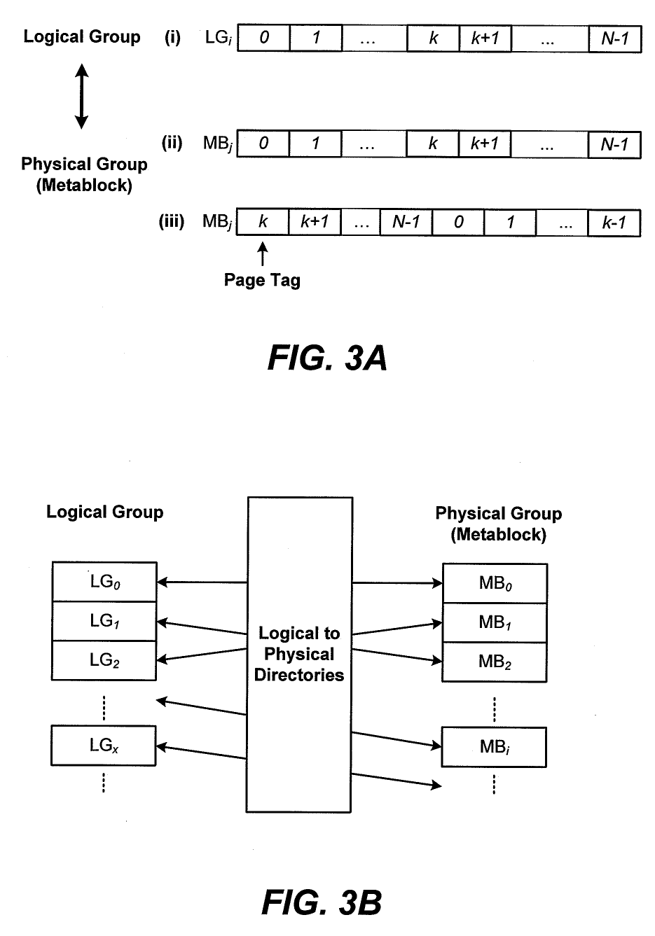

FIGS. 3A(i)-3A(iii) illustrate schematically the mapping between a logical group and a metablock, according to a preferred embodiment of the present invention. The metablock of the physical memory has N physical sectors for storing N logical sectors of data of a logical group. FIG. 3A(i) shows the data from a logical group LGᵢ, where the logical sectors are in contiguous logical order 0, 1, . . . , N−1. FIG. 3A(ii) shows the same data being stored in the metablock in the same logical order. The metablock when stored in this manner is said to be “sequential.” In general, the metablock may have data stored in a different order, in which case the metablock is said to be “non-sequential” or “chaotic.”

There may be an offset between the lowest address of a logical group and the lowest address of the metablock to which it is mapped. In this case, logical sector address wraps round as a loop from bottom back to top of the logical group within the metablock. For example, in FIG. 3A(iii), the metablock stores in its first location beginning with the data of logical sector k. When the last logical sector N−1 is reached, it wraps around to sector 0 and finally storing data associated with logical sector k−1 in its last physical sector. In the preferred embodiment, a page tag is used to identify any offset, such as identifying the starting logical sector address of the data stored in the first physical sector of the metablock. Two blocks will be considered to have their logical sectors stored in similar order when they only differ by a page tag.

FIG. 3B illustrates schematically the mapping between logical groups and metablocks. Each logical group is mapped to a unique metablock, except for a small number of logical groups in which data is currently being updated. After a logical group has been updated, it may be mapped to a different metablock. The mapping information is maintained in a set of logical to physical directories, which will be described in more detail later.

Other types of logical group to metablock mapping are also comtemplated. For example, metablocks with variable size are disclosed in co-pending and co-owned United States Patent application, entitled, “Adaptive Metablocks,” filed by Alan Sinclair, on the same day as the present application. The entire disclosure of the co-pending application is hereby incorporated herein by reference.

One feature of the invention is that the system operates with a single logical partition, and groups of logical sectors throughout the logical address range of the memory system are treated identically. For example, sectors containing system data and sectors containing user data can be distributed anywhere among the logical address space.

Unlike prior art systems, there is no special partitioning or zoning of system sectors (i.e., sectors relating to file allocation tables, directories or sub-directories) in order to localize in logical address space sectors that are likely to contain data with high-frequency and small-size updates. Instead, the present scheme of updating logical groups of sectors will efficiently handle the patterns of access that are typical of system sectors, as well as those typical of file data.

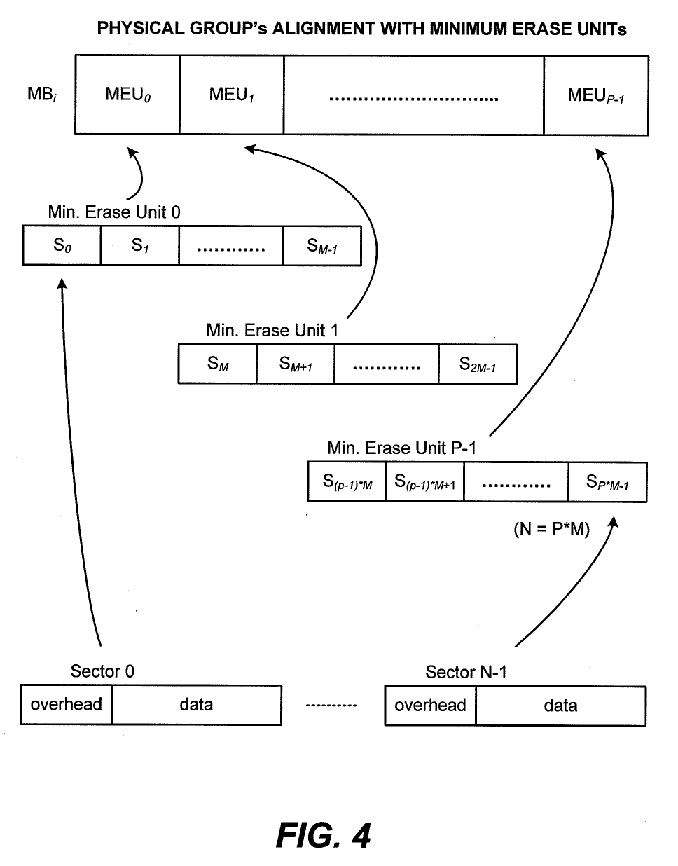

FIG. 4 illustrates the alignment of a metablock with structures in physical memory. Flash memory comprises blocks of memory cells which are erasable together as a unit. Such erase blocks are the minimum unit of erasure of flash memory or minimum erasable unit (MEU) of the memory. The minimum erase unit is a hardware design parameter of the memory, although in some memory systems that supports multiple MEUs erase, it is possible to configure a “super MEU” comprising more than one MEU. For flash EEPROM, a MEU may comprise one sector but preferably multiple sectors. In the example shown, it has M sectors. In the preferred embodiment, each sector can store 512 bytes of data and has a user data portion and a header portion for storing system or overhead data. If the metablock is constituted from P MEUs, and each MEU contains M sectors, then, each metablock will have N=P*M sectors.

The metablock represents, at the system level, a group of memory locations, e.g., sectors that are erasable together. The physical address space of the flash memory is treated as a set of metablocks, with a metablock being the minimum unit of erasure. Within this specification, the terms “metablock” and “block” are used synonymously to define the minimum unit of erasure at the system level for media management, and the term “minimum erase unit” or MEU is used to denote the minimum unit of erasure of flash memory.

### Linking of Minimum Erase Units (Meus) to Form a Metablock

In order to maximize programming speed and erase speed, parallelism is exploited as much as possible by arranging for multiple pages of information, located in multiple MEUs, to be programmed in parallel, and for multiple MEUs to be erased in parallel.

In flash memory, a page is a grouping of memory cells that may be programmed together in a single operation. A page may comprise one or more sector. Also, a memory array may be partitioned into more than one plane, where only one MEU within a plane may be programmed or erased at a time. Finally, the planes may be distributed among one or more memory chips.

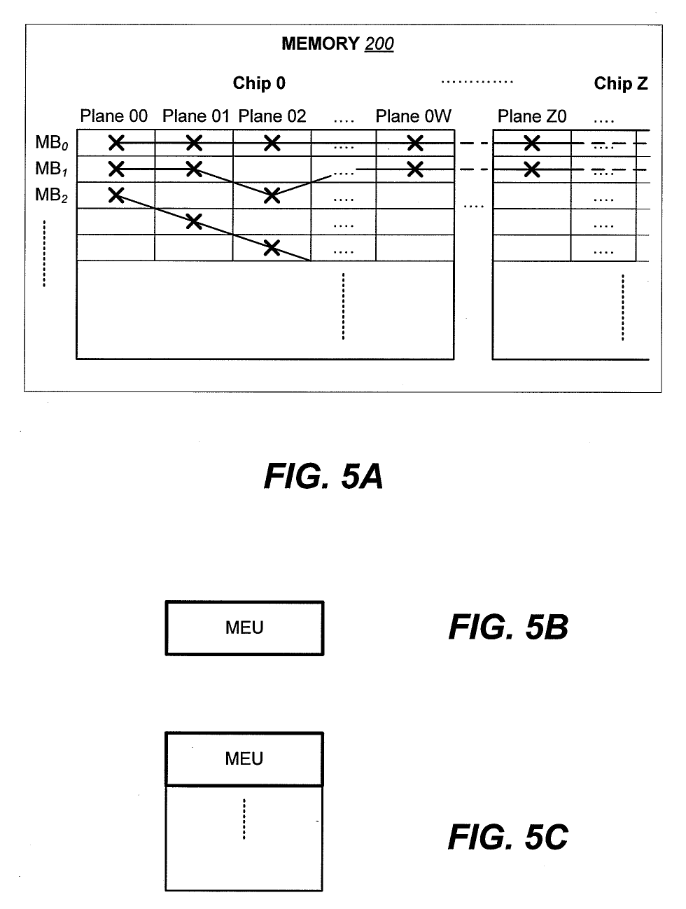

In flash memory, the MEUs may comprise one or more page. MEUs within a flash memory chip may be organized in planes. Since one MEU from each plane may be programmed or erased concurrently, it is expedient to form a multiple MEU metablock by selecting one MEU from each plane (see FIG. 5B below.)

FIG. 5A illustrates metablocks being constituted from linking of minimum erase units of different planes. Each metablock, such as MB0, MB1, . . . , is constituted from MEUs from different planes of the memory system, where the different planes may be distributed among one or more chips. The metablock link manager 170 shown in FIG. 2 manages the linking of the MEUs for each metablock. Each metablock is configured during an initial formatting process, and retains its constituent MEUs throughout the life of the system, unless there is a failure of one of the MEUs.

FIG. 5B illustrates one embodiment in which one minimum erase unit (MEU) is selected from each plane for linking into a metablock.

FIG. 5C illustrates another embodiment in which more than one MEU are selected from each plane for linking into a metablock. In another embodiment, more than one MEU may be selected from each plane to form a super MEU. For example, a super MEU may be formed from two MEUs. In this case, it may take more than one pass for read or write operation.

The linking and re-linking of MEUs into metablocks is also disclosed in co-pending and co-owned United States Patent application, entitled “Adaptive Deterministic Grouping of Blocks into Multi-Block Structures,” filed by Carlos Gonzales et al, on the same day as the present application. The entire disclosure of the co-pending application is hereby incorporated herein by reference.

### Metablock Management

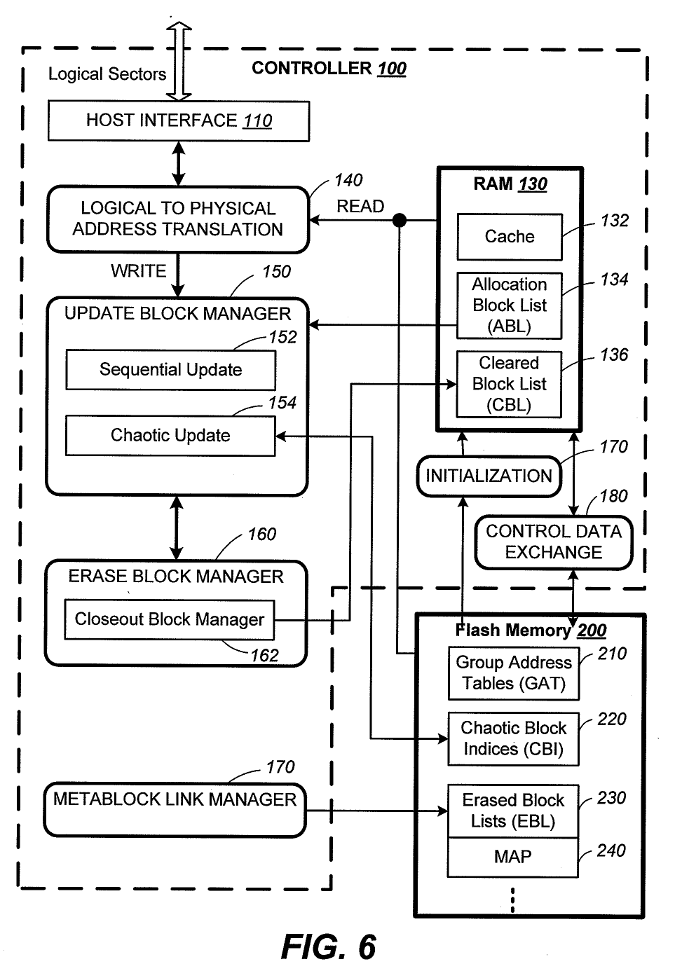

FIG. 6 is a schematic block diagram of the metablock management system as implemented in the controller and flash memory. The metablock management system comprises various functional modules implemented in the controller 100 and maintains various control data (including directory data) in tables and lists hierarchically distributed in the flash memory 200 and the controller RAM 130. The function modules implemented in the controller 100 includes an interface module 110, a logical-to-physical address translation module 140, an update block manager module 150, an erase block manager module 160 and a metablock link manager 170.

The interface 110 allows the metablock management system to interface with a host system. The logical to physical address translation module 140 maps the logical address from the host to a physical memory location. The update block Manager module 150 manages data update operations in memory for a given logical group of data. The erased block manager 160 manages the erase operation of the metablocks and their allocation for storage of new information. A metablock link manager 170 manages the linking of subgroups of minimum erasable blocks of sectors to constitute a given metablock. Detailed description of these modules will be given in their respective sections.

During operation the metablock management system generates and works with control data such as addresses, control and status information. Since much of the control data tends to be frequently changing data of small size, it can not be readily stored and maintained efficiently in a flash memory with a large block structure. A hierarchical and distributed scheme is employed to store the more static control data in the nonvolatile flash memory while locating the smaller amount of the more varying control data in controller RAM for more efficient update and access. In the event of a power shutdown or failure, the scheme allows the control data in the volatile controller RAM to be rebuilt quickly by scanning a small set of control data in the nonvolatile memory. This is possible because the invention restricts the number of blocks associated with the possible activity of a given logical group of data. In this way, the scanning is confined. In addition, some of the control data that requires persistence are stored in a nonvolatile metablock that can be updated sector-by-sector, with each update resulting in a new sector being recorded that supercedes a previous one. A sector indexing scheme is employed for control data to keep track of the sector-by-sector updates in a metablock.

The non-volatile flash memory 200 stores the bulk of control data that are relatively static. This includes group address tables (GAT) 210, chaotic block indices (CBI) 220, erased block lists (EBL) 230 and MAP 240. The GAT 210 keeps track of the mapping between logical groups of sectors and their corresponding metablocks. The mappings do not change except for those undergoing updates. The CBI 220 keeps track of the mapping of logically non-sequential sectors during an update. The EBL 230 keeps track of the pool of metablocks that have been erased. MAP 240 is a bitmap showing the erase status of all metablocks in the flash memory.

The volatile controller RAM 130 stores a small portion of control data that are frequently changing and accessed. This includes an allocation block list (ABL) 134 and a cleared block list (CBL) 136. The ABL 134 keeps track of the allocation of metablocks for recording update data while the CBL 136 keeps track of metablocks that have been deallocated and erased. In the preferred embodiment, the RAM 130 acts as a cache for control data stored in flash memory 200.

### Update Block Manager

The update block manager 150 (shown in FIG. 2) handles the update of logical groups. According to one aspect of the invention, each logical group of sectors undergoing an update is allocated a dedicated update metablock for recording the update data. In the preferred embodiment, any segment of one or more sectors of the logical group will be recorded in the update block. An update block can be managed to receive updated data in either sequential order or non-sequential (also known as chaotic) order. A chaotic update block allows sector data to be updated in any order within a logical group, and with any repetition of individual sectors. In particular, a sequential update block can become a chaotic update block, without need for relocation of any data sectors. No predetermined allocation of blocks for chaotic data update is required; a non-sequential write at any logical address is automatically accommodated. Thus, unlike prior art systems, there is no special treatment whether the various update segments of the logical group is in logical sequential or non-sequential order. The generic update block will simply be used to record the various segments in the order they are requested by the host. For example, even if host system data or system control data tends to be updated in chaotic fashion, regions of logical address space corresponding to host system data do not need to be treated differently from regions with host user data.

Data of a complete logical group of sectors is preferably stored in logically sequential order in a single metablock. In this way, the index to the stored logical sectors is predefined. When the metablock has in store all the sectors of a given logical group in a predefined order it is said to be “intact.” As for an update block, when it eventually fills up with update data in logically sequential order, then the update block will become an updated intact metablock that readily replace the original metablock. On the other hand, if the update block fills up with update data in a logically different order from that of the intact block, the update block is a non-sequential or chaotic update block and the out of order segments must be further processed so that eventually the update data of the logical group is stored in the same order as that of the intact block. In the preferred case, it is in logically sequential order in a single metablock. The further processing involves consolidating the updated sectors in the update block with unchanged sectors in the original block into yet another update metablock. The consolidated update block will then be in logically sequential order and can be used to replace the original block. Under some predetermined condition, the consolidation process is preceded by one or more compaction processes. The compaction process simply re-records the sectors of the chaotic update block into a replacing chaotic update block while eliminating any duplicate logical sector that has been rendered obsolete by a subsequent update of the same logical sector.

The update scheme allows for multiple update threads running concurrently, up to a predefined maximum. Each thread is a logical group undergoing updates using its dedicated update metablock.

### Sequential Data Update

When data belonging to a logical group is first updated, a metablock is allocated and dedicated as an update block for the update data of the logical group. The update block is allocated when a command is received from the host to write a segment of one or more sectors of the logical group for which an existing metablock has been storing all its sectors intact. For the first host write operation, a first segment of data is recorded on the update block. Since each host write is a segment of one or more sector with contiguous logical address, it follows that the first update is always sequential in nature. In subsequent host writes, update segments within the same logical group are recorded in the update block in the order received from the host. A block continues to be managed as a sequential update block whilst sectors updated by the host within the associated logical group remain logically sequential. All sectors updated in this logical group are written to this sequential update block, until the block is either closed or converted to a chaotic update block.

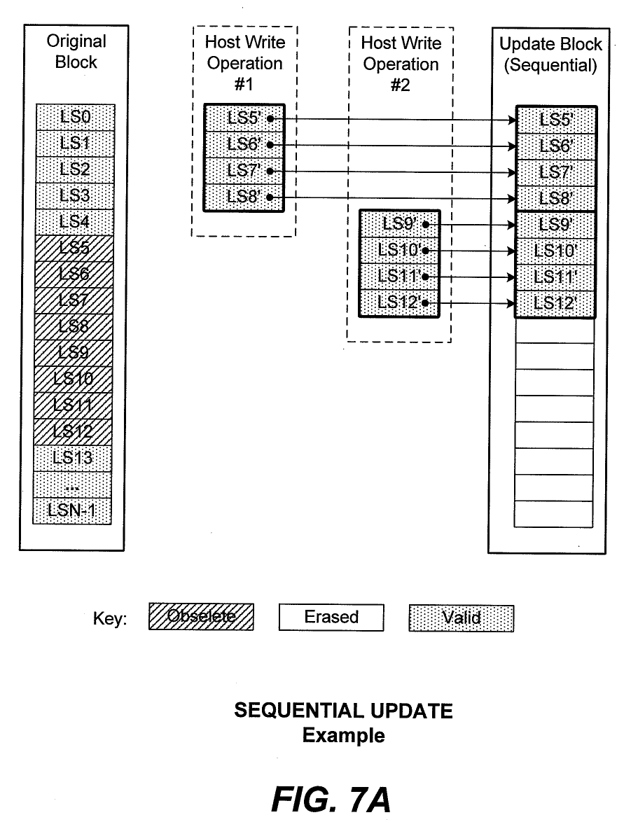

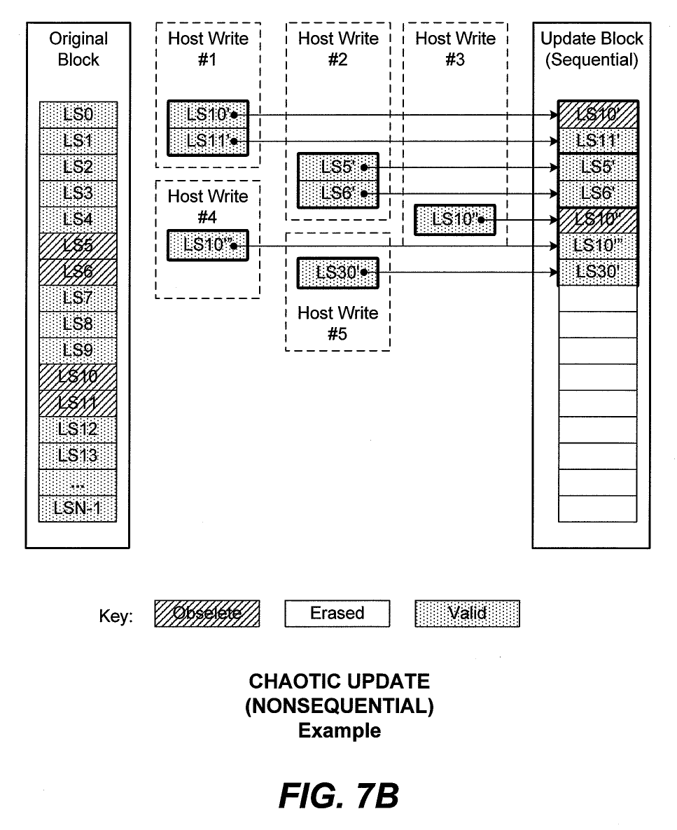

FIG. 7A illustrates an example of sectors in a logical group being written in sequential order to a sequential update block as a result of two separate host write operations, whilst the corresponding sectors in the original block for the logical group become obsolete. In host write operation #1, the data in the logical sectors LS5-LS8 are being updated. The updated data as LS5′-LS8′ are recorded in a newly allocated dedicated update block.

For expediency, the first sector to be updated in the logical group is recorded in the dedicated update block starting from the first physical sector location. In general, the first logical sector to be updated is not necessarily the logical first sector of the group, and there may therefore be an offset between the start of the logical group and the start of the update block. This offset is known as page tag as described previously in connection with FIG. 3A. Subsequent sectors are updated in logically sequential order. When the last sector of the logical group is written, group addresses wrap around and the write sequence continues with the first sector of the group.

In host write operation #2, the segment of data in the logical sectors LS9-LS12 are being updated. The updated data as LS9′-LS12′ are recorded in the dedicated update block in a location directly following where the last write ends. It can be seen that the two host writes are such that the update data has been recorded in the update block in logically sequential order, namely LS5′-LS12′. The update block is regarded as a sequential update block since it has been filled in logically sequential order. The update data recorded in the update block obsoletes the corresponding ones in the original block.

### Chaotic Data Update

Chaotic update block management may be initiated for an existing sequential update block when any sector updated by the host within the associated logical group is logically non-sequential. A chaotic update block is a form of data update block in which logical sectors within an associated logical group may be updated in any order and with any amount of repetition. It is created by conversion from a sequential update block when a sector written by a host is logically non-sequential to the previously written sector within the logical group being updated. All sectors subsequently updated in this logical group are written in the next available sector location in the chaotic update block, whatever their logical sector address within the group.

FIG. 7B illustrates an example of sectors in a logical group being written in chaotic order to a chaotic update block as a result of five separate host write operations, whilst superseded sectors in the original block for the logical group and duplicated sectors in the chaotic update block become obsolete. In host write operation #1, the logical sectors LS10-LS11 of a given logical group stored in an original metablock is updated. The updated logical sectors LS10′-LS11′ are stored in a newly allocated update block. At this point, the update block is a sequential one. In host write operation #2, the logical sectors LS5-LS6 are updated as LS5′-LS6′ and recorded in the update block in the location immediately following the last write. This converts the update block from a sequential to a chaotic one. In host write operation #3, the logical sector LS10 is being updated again and is recorded in the next location of the update block as LS10″. At this point LS10″ in the update block supersedes LS10′ in a previous recording which in turns supercedes LS10 in the original block. In host write operation #4, the data in the logical sector LS10 is again updated and is recorded in the next location of the update block as LS10′″. Thus, LS10′″ is now the latest and only valid data for the logical sector LS10. In host write operation #5, the data in logical sector LS30 is being updated and recorded in the update block as LS30′. Thus, the example illustrates that sectors within a logical group can be written in a chaotic update block in any order and with any repetition.

### Forced Sequential Update

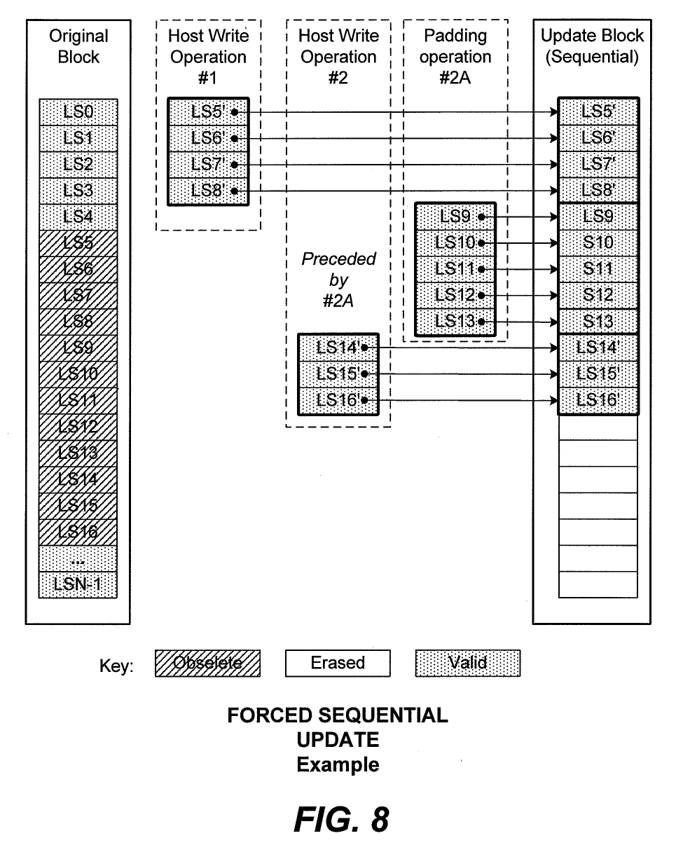

FIG. 8 illustrates an example of sectors in a logical group being written in sequential order to a sequential update block as a result of two separate host write operations that has a discontinuity in logical addresses. In host write #1, the update data in the logical sectors LS5-LS8 is recorded in a dedicated update block as LS5′-LS8′. In host write #2, the update data in the logical sectors LS 14-LS 16 is being recorded in the update block following the last write as LS14′-LS16′. However, there is an address jump between LS8 and LS14 and the host write #2 would normally render the update block non-sequential. Since the address jump is not substantial, one option is to first perform a padding operation (#2A) by copying the data of the intervening sectors from the original block to the update block before executing host write #2. In this way, the sequential nature of the update block is preserved.

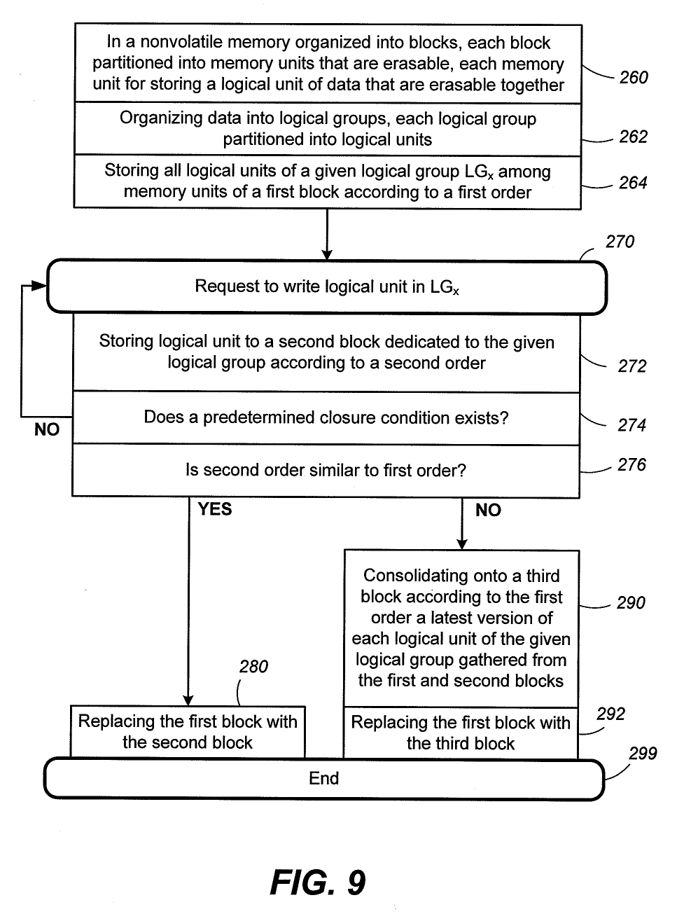

FIG. 9 is a flow diagram illustrating a process by the update block manager to update a logical group of data, according a general embodiment of the invention. The update process comprises the following steps:

STEP 260: The memory is organized into blocks, each block partitioned into memory units that are erasable together, each memory unit for storing a logical unit of data.

STEP 262: The data is organized into logical groups, each logical group partitioned into logical units.

STEP 264: In the standard case, all logical units of a logical group is stored among the memory units of an original block according to a first prescribed order, preferably, in logically sequential order. In this way, the index for accessing the individual logical units in the block is known.

STEP 270: For a given logical group (e.g., LG_{X}) of data, a request is made to update a logical unit within LG_{X}. (A logical unit update is given as an example. In general the update will be a segment of one or more contiguous logical units within LGx.)

STEP 272: The requested update logical unit is to be stored in a second block, dedicated to recording the updates of LG_{X}. The recording order is according to a second order, typically, the order the updates are requested. One feature of the invention allows an update block to be set up initially generic to recording data in logically sequential or chaotic order. So depending on the second order, the second block can be a sequential one or a chaotic one.

STEP 274: The second block continues to have requested logical units recorded as the process loops back to STEP 270. The second block will be closed to receiving further update when a predetermined condition for closure materializes. In that case, the process proceeds to STEP 276.

STEP 276: Determination is made whether or not the closed, second block has its update logical units recorded in a similar order as that of the original block. The two blocks are considered to have similar order when they recorded logical units differ by only a page tag, as described in connection with FIG. 3A. If the two blocks have similar order the process proceeds to STEP 280, otherwise, some sort of garbage collection need to be performed in STEP 290.

STEP 280: Since the second block has the same order as the first block, it is used to replace the original, first block. The update process then ends at STEP 299.

STEP 290: The latest version of each logical units of the given logical group are gathered from among the second block (update block) and the first block (original block). The consolidated logical units of the given logical group are then written to a third block in an order similar to the first block.

STEP 292: Since the third block (consolidated block) has a similar order to the first block, it is used to replace the original, first block. The update process then ends at STEP 299.

STEP 299: When a closeout process creates an intact update block, it becomes the new standard block for the given logical group. The update thread for the logical group will be terminated.

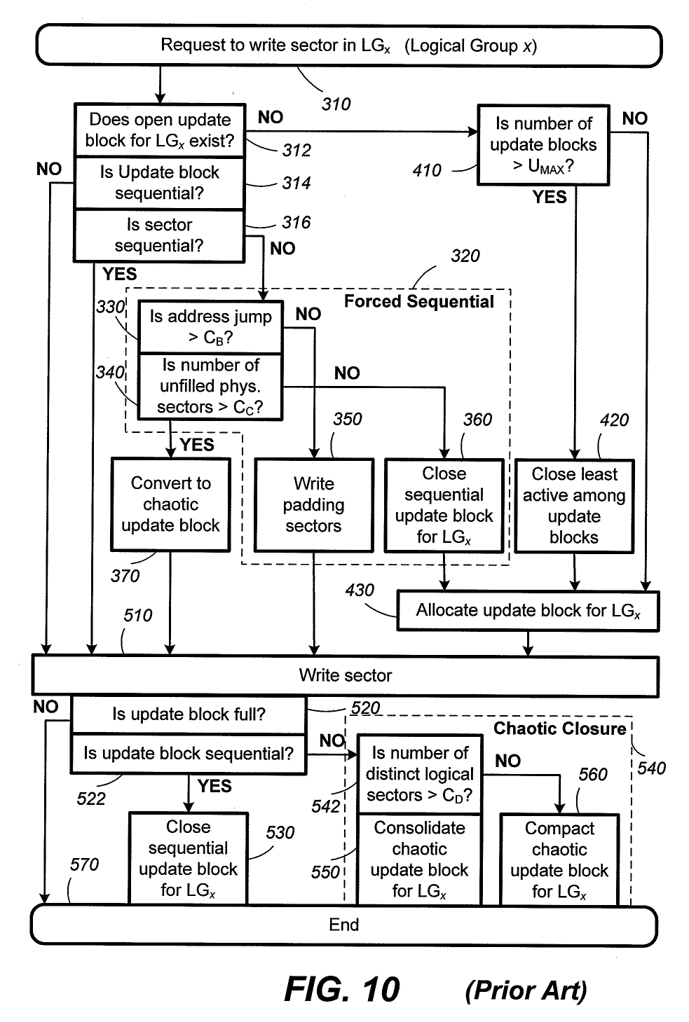

FIG. 10 is a flow diagram illustrating a process by the update block manager to update a logical group of data, according a preferred embodiment of the invention. The update process comprises the following steps:

STEP 310: For a given logical group (e.g., LG_{X}) of data, a request is made to update a logical sector within LG_{X}. (A sector update is given as an example. In general the update will be a segment of one or more contiguous logical sectors within LG.)

STEP 312: If an update block dedicated to LG_{X} does not already exist, proceed to STEP 410 to initiate a new update thread for the logical group. This will be accomplished by allocating an update block dedicated to recording update data of the logical group. If there is already an update block open, proceed to STEP 314 to begin recording the update sector onto the update block.

STEP 314: If the current update block is already chaotic (i.e., non-sequential) then simply proceed to STEP 510 for recording the requested update sector onto the chaotic update block. If the current update block is sequential, proceed to STEP 316 for processing of a sequential update block.

STEP 316: One feature of the invention allows an update block to be set up initially generic to recording data in logically sequential or chaotic order. However, since the logical group ultimately has its data stored in a metablock in a logically sequential order, it is desirable to keep the update block sequential as far as possible. Less processing will then be required when an update block is closed to further updates as garbage collection will not be needed.

Thus determination is made whether the requested update will follow the current sequential order of the update block. If the update follows sequentially, then proceed to STEP 510 to perform a sequential update, and the update block will remain sequential. On the other hand, if the update does not follow sequentially (chaotic update), it will convert the sequential update block to a chaotic one if no other actions are taken.

In one embodiment, nothing more is done to salvage the situation and the process proceeds directly to STEP 370 where the update is allowed to turn the update block into a chaotic one.

### Optional Forced Sequential Process

In another embodiment, a forced sequential process STEP 320 is optionally performed to preserve the sequential update block as far as possible in view of a pending chaotic update. There are two situations, both of which require copying missing sectors from the original block to maintain the sequential order of logical sectors recorded on the update block. The first situation is where the update creates a short address jump. The second situation is to prematurely close out an update block in order to keep it sequential. The forced sequential process STEP 320 comprises the following substeps:

STEP 330: If the update creates a logical address jump not greater a predetermined amount, C_{B}, the process proceeds to a forced sequential update process in STEP 350, otherwise the process proceeds to STEP 340 to consider if it qualifies for a forced sequential closeout.

STEP 340: If the number of unfilled physical sectors exceeds a predetermined design parameter, C_{C}, whose typical value is half of the size of the update block, then the update block is relatively unused and will not be prematurely closed. The process proceeds to STEP 370 and the update block will become chaotic. On the other hand, if the update block is substantially filled, it is considered to have been well utilized already and therefore is directed to STEP 360 for forced sequential closeout.

STEP 350: Forced sequential update allows current sequential update block to remain sequential as long as the address jump does not exceed a predetermined amount, C_{B}. Essentially, sectors from the update block's associated original block are copied to fill the gap spanned by the address jump. Thus, the sequential update block will be padded with data in the intervening addresses before proceeding to STEP 510 to record the current update sequentially.

STEP 360: Forced sequential closeout allows the currently sequential update block to be closed out if it is already substantially filled rather than converted to a chaotic one by the pending chaotic update. A chaotic or non-sequential update is defined as one with a forward address transition not covered by the address jump exception described above, a backward address transition, or an address repetition. To prevent a sequential update block to be converted by a chaotic update, the unwritten sector locations of the update block are filled by copying sectors from the update block's associated original partly-obsolete block. The original block is then fully obsolete and may be erased. The current update block now has the full set of logical sectors and is then closed out as an intact metablock replacing the original metablock. The process then proceeds to STEP 430 to have a new update block allocated in its place to accept the recording of the pending sector update that was first requested in STEP 310.

### Conversion to Chaotic Update Block

STEP 370: When the pending update is not in sequential order and optionally, if the forced sequential conditions are not satisfied, the sequential update block is allowed to be converted to a chaotic one by virtue of allowing the pending update sector, with non-sequential address, to be recorded on the update block when the process proceeds to STEP 510. If the maximum number of chaotic update blocks exist, it is necessary to close the least recently accessed chaotic update block before allowing the conversion to proceed; thus preventing the maximum number of chaotic blocks from being exceeded. The identification of the least recently accessed chaotic update block is the same as the general case described in STEP 420, but is constrained to chaotic update blocks only. Closing a chaotic update block at this time is achieved by consolidation as described in STEP 550.

### Allocation of New Update Block Subject to System Restriction

STEP 410: The process of allocating an erase metablock as an update block begins with the determination whether a predetermined system limitation is exceeded or not. Due to finite resources, the memory management system typically allows a predetermined maximum number of update blocks, U_{MAX}, to exist concurrently. This limit is the aggregate of sequential update blocks and chaotic update blocks, and is a design parameter. In a preferred embodiment, the limit is, for example, a maximum of 8 update blocks. Also, due to the higher demand on system resources, there may also be a corresponding predetermined limit on the maximum number of chaotic update blocks that can be open concurrently (e.g., 4.)

Thus, when U_{MAX} update blocks have already been allocated, then the next allocation request could only be satisfied after closing one of the existing allocated ones. The process proceeds to STEP 420. When the number of open update blocks is less than CA, the process proceeds directly to STEP 430.

STEP 420: In the event the maximum number of update blocks, CA, is exceeded, the least-recently accessed update block is closed and garbage collection is performed. The least recently accessed update block is identified as the update block associated with the logical block that has been accessed least recently. For the purpose of determining the least recently accessed blocks, an access includes writes and optionally reads of logical sectors. A list of open update blocks is maintained in order of access; at initialization, no access order is assumed. The closure of an update block follows along the similar process described in connection with STEP 360 and STEP 530 when the update block is sequential, and in connection with STEP 540 when the update block is chaotic. The closure makes room for the allocation of a new update block in STEP 430.

STEP 430: The allocation request is fulfilled with the allocation of a new metablock as an update block dedicated to the given logical group LGx. The process then proceeds to STEP 510.

### Record Update Data onto Update Block

STEP 510: The requested update sector is recorded onto next available physical location of the update block. The process then proceeds to STEP 520 to determine if the update block is ripe for closeout.

### Update Block Closeout

STEP 520: If the update block still has room for accepting additional updates, proceed to STEP 570. Otherwise proceed to STEP 522 to closeout the update block. There are two possible implementations of filling up an update block when the current requested write attempts to write more logical sectors than the block has room for. In the first implementation, the write request is split into two portions, with the first portion writing up to the last physical sector of the block. The block is then closed and the second portion of the write will be treated as the next requested write. In the other implementation, the requested write is withheld while the block has it remaining sectors padded and is then closed. The requested write will be treated as the next requested write.

STEP 522: If the update block is sequential, proceed to STEP 530 for sequential closure. If the update block is chaotic, proceed to STEP 540 for chaotic closure.

### Sequential Update Block Closeout

STEP 530: Since the update block is sequential and fully filled, the logical group stored in it is intact. The metablock is intact and replaces the original one. At this time, the original block is fully obsolete and may be erased. The process then proceeds to STEP 570 where the update thread for the given logical group ends.

### Chaotic Update Block Closeout

STEP 540: Since the update block is non-sequentially filled and may contain multiple updates of some logical sectors, garbage collection is performed to salvage the valid data in it. The chaotic update block will either be compacted or consolidated. Which process to perform will be determined in STEP 542.

STEP 542: To perform compaction or consolidation will depend on the degeneracy of the update block. If a logical sector is updated multiple times, its logical address is highly degenerate. There will be multiple versions of the same logical sector recorded on the update block and only the last recorded version is the valid one for that logical sector. In an update block containing logical sectors with multiple versions, the number of distinct logical sectors will be much less than that of a logical group.

In the preferred embodiment, when the number of distinct logical sectors in the update block exceeds a predetermined design parameter, C_{D}, whose typical value is half of the size of a logical group, the closeout process will perform a consolidation in STEP 550, otherwise the process will proceed to compaction in STEP 560.

STEP 550: If the chaotic update block is to be consolidated, the original block and the update block will be replaced by a new standard metablock containing the consolidated data. After consolidation the update thread will end in STEP 570.

STEP 560: If the chaotic update block is to be compacted, it will be replaced by a new update block carrying the compacted data. After compaction the processing of the compacted update block will end in STEP 570. Alternatively, compaction can be delayed until the update block is written to again, thus removing the possibility of compaction being followed by consolidation without intervening updates. The new update block will then be used in further updating of the given logical block when a next request for update in LG_{X} appears in STEP 502.

STEP 570: When a closeout process creates an intact update block, it becomes the new standard block for the given logical group. The update thread for the logical group will be terminated. When a closeout process creates a new update block replacing an existing one, the new update block will be used to record the next update requested for the given logical group. When an update block is not closed out, the processing will continue when a next request for update in LG_{X} appears in STEP 310.

As can be seen from the process described above, when a chaotic update block is closed, the update data recorded on it is further processed. In particular its valid data is garbage collected either by a process of compaction to another chaotic block, or by a process of consolidation with its associated original block to form a new standard sequential block.

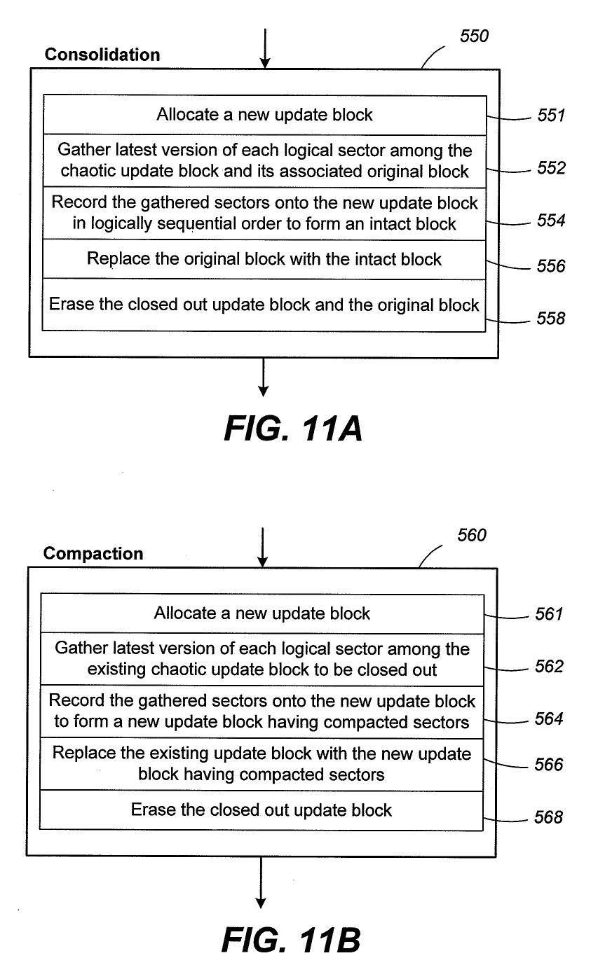

FIG. 11A is a flow diagram illustrating in more detail the consolidation process of closing a chaotic update block shown in FIG. 10. Chaotic update block consolidation is one of two possible processes performed when the update block is being closed out, e.g., when the update block is full with its last physical sector location written. Consolidation is chosen when the number of distinct logical sectors written in the block exceeds a predetermined design parameter, C_{D}. The consolidation process STEP 550 shown in FIG. 10 comprises the following substeps:

STEP 551: When a chaotic update block is being closed, a new metablock replacing it will be allocated.

STEP 552: Gather the latest version of each logical sector among the chaotic update block and its associated original block, ignoring all the obsolete sectors.

STEP 554: Record the gathered valid sectors onto the new metablock in logically sequential order to form an intact block, i.e., a block with all the logical sectors of a logical group recorded in sequential order.

STEP 556: Replace the original block with the new intact block.

STEP 558: Erase the closed out update block and the original block.

FIG. 11B is a flow diagram illustrating in more detail the compaction process for closing a chaotic update block shown in FIG. 10. Compaction is chosen when the number of distinct logical sectors written in the block is below a predetermined design parameter, C_{D}. The compaction process STEP 560 shown in FIG. 10 comprises the following substeps:

STEP 561: When a chaotic update block is being compacted, a new metablock replacing it will be allocated.

STEP 562: Gather the latest version of each logical sector among the existing chaotic update block to be compacted.

STEP 564: Record the gathered sectors onto the new update block to form a new update block having compacted sectors.

STEP 566: Replace the existing update block with the new update block having compacted sectors.

STEP 568: Erase the closed out update block

### Logical and Metablock States

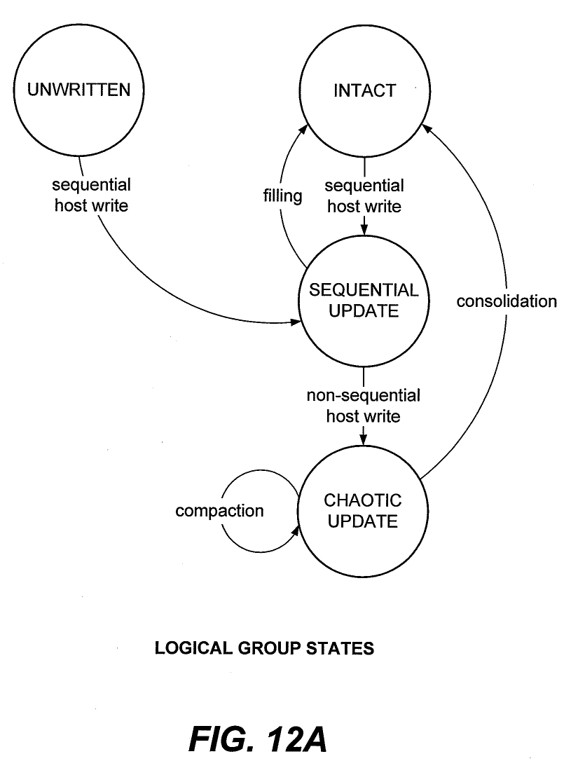

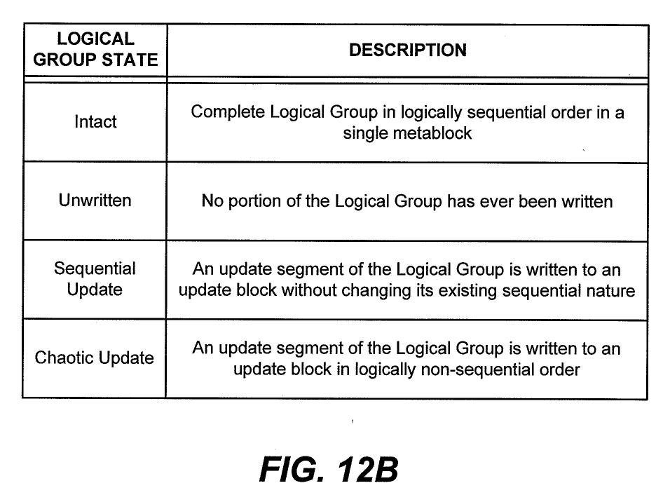

FIG. 12A illustrates all possible states of a Logical Group, and the possible transitions between them under various operations.

FIG. 12B is a table listing the possible states of a Logical Group. The Logical Group states are defined as follows:

### 1. Intact: All logical sectors in the Logical Group have been written in logically sequential order, possibly using page tag wrap around, in a single metablock.

2. Unwritten: No logical sector in the Logical Group has ever been written. The Logical Group is marked as unwritten in a group address table and has no allocated metablock. A predefined data pattern is returned in response to a host read for every sector within this group.

### 3. Sequential Update: Some sectors within the Logical Group have been written in logically sequential order in a metablock, possibly using page tag, so that they supersede the corresponding logical sectors from any previous Intact state of the group.

4. Chaotic Update: Some sectors within the Logical Group have been written in logically non-sequential order in a metablock, possibly using page tag, so that they supersede the corresponding logical sectors from any previous Intact state of the group. A sector within the group may be written more than once, with the latest version superseding all previous versions.

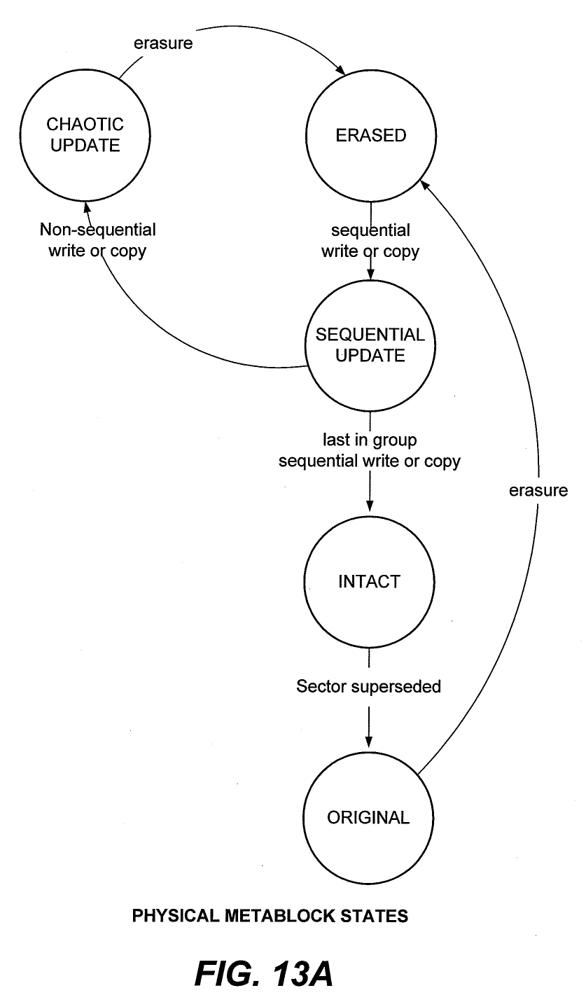

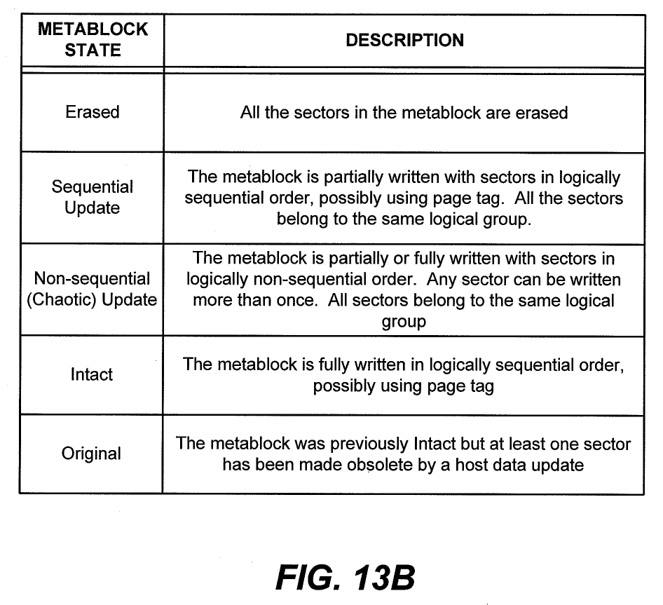

FIG. 13A illustrates all possible states of a metablock, and the possible transitions between them under various operations.

FIG. 13B is a table listing the possible states of a metablock. The metablock states are defined as follows:

### 1. Erased: All the sectors in the metablock are erased.

2. Sequential Update: The metablock is partially written with sectors in logically sequential order, possibly using page tag. All the sectors belong to the same Logical Group.
3. Chaotic Update: The metablock is partially or fully written with sectors in logically non-sequential order. Any sector can be written more than once. All sectors belong to the same Logical Group.

### 4: Intact: The metablock is fully written in logically sequential order, possibly using page tag.

### 5: Original: The metablock was previously Intact but at least one sector has been made obsolete by a host data update.

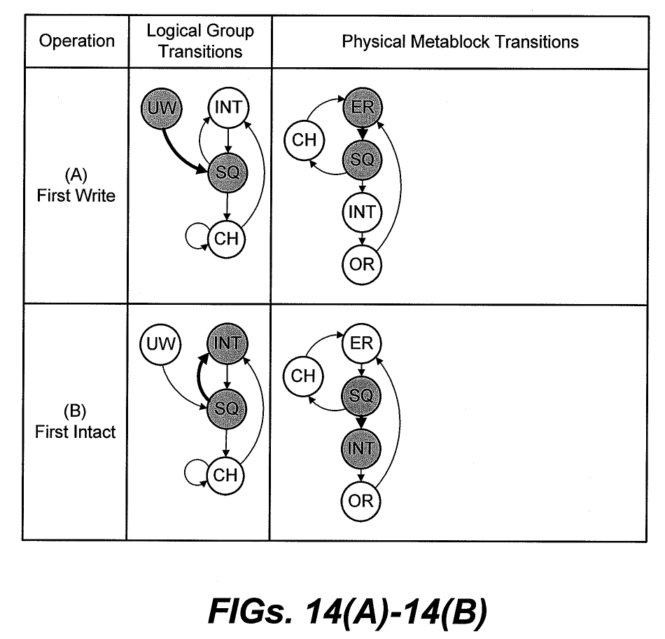

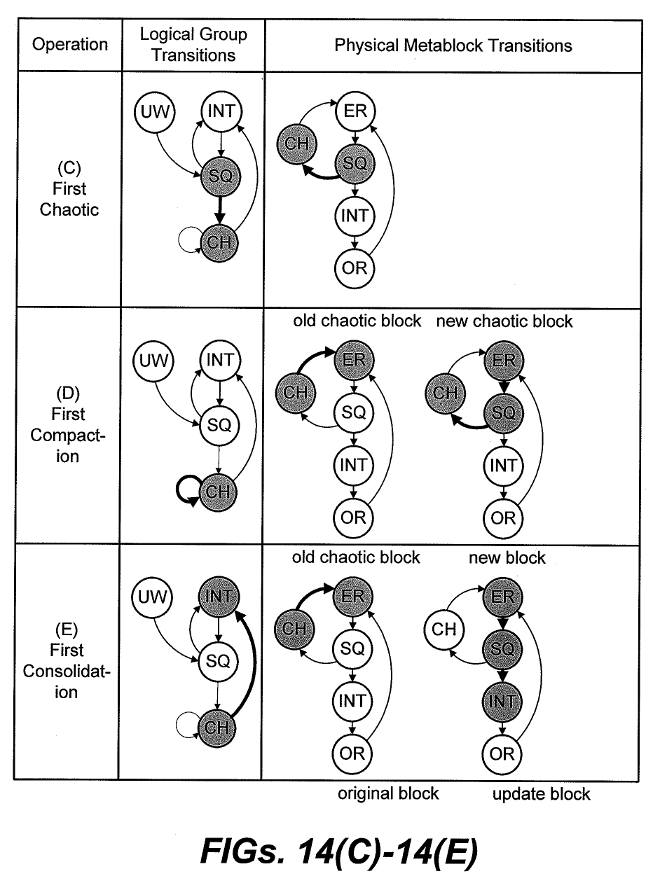

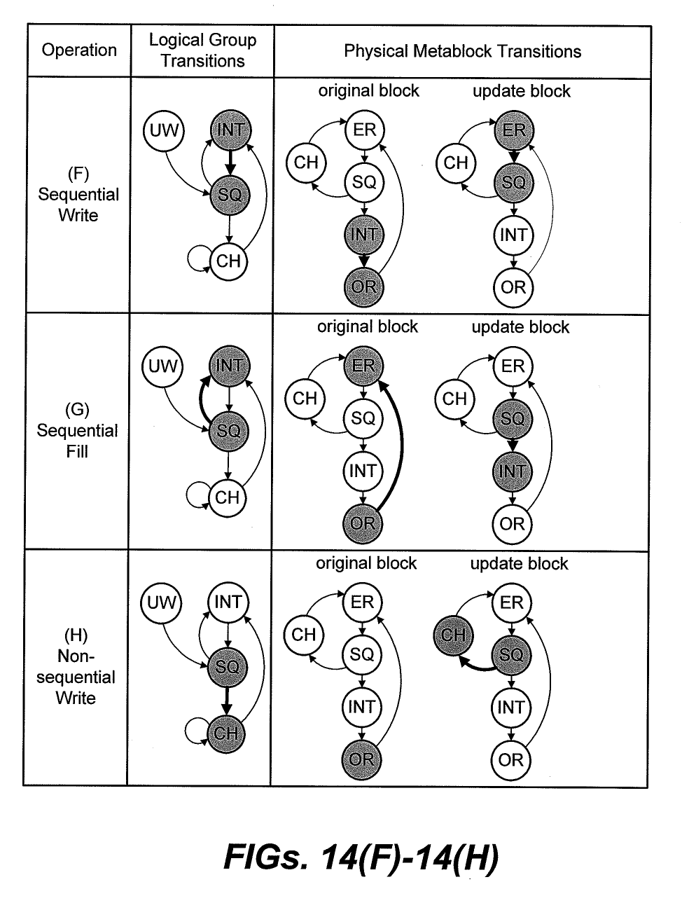

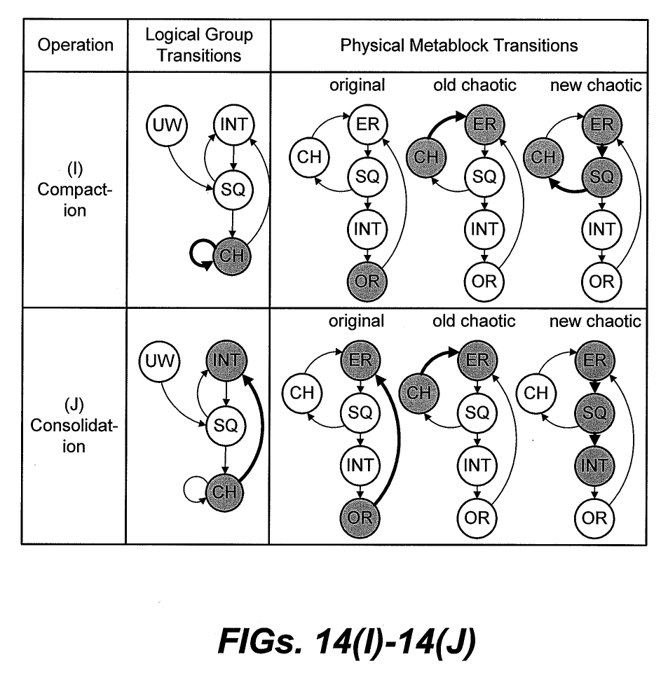

FIGS. 14(A)-14(J) are state diagrams showing the effect of various operations on the state of the logical group and also on the physical metablock.

FIG. 14(A) shows state diagrams corresponding to the logical group and the metablock transitions for a first write operation. The host writes one or more sectors of a previously unwritten Logical Group in logically sequential order to a newly allocated Erased metablock. The Logical Group and the metablock go to the Sequential Update state.

FIG. 14(B) shows state diagrams corresponding to the logical group and the metablock transitions for a first intact operation. A previously unwritten Sequential Update Logical Group becomes Intact as all the sectors are written sequentially by the host. The transition can also happen if the card fills up the group by filling the remaining unwritten sectors with a predefined data pattern. The metablock becomes Intact.

FIG. 14(C) shows state diagrams corresponding to the logical group and the metablock transitions for a first chaotic operation. A previously unwritten Sequential Update Logical Group becomes Chaotic when at least one sector has been written non-sequentially by the host.

FIG. 14(D) shows state diagrams corresponding to the logical group and the metablock transitions for a first compaction operation. All valid sectors within a previously unwritten Chaotic Update Logical Group are copied to a new Chaotic metablock from the old block, which is then erased.

FIG. 14(E) shows state diagrams corresponding to the logical group and the metablock transitions for a first consolidation operation. All valid sectors within a previously unwritten Chaotic Update Logical Group are moved from the old Chaotic block to fill a newly allocated Erased block in logically sequential order. Sectors unwritten by the host are filled with a predefined data pattern. The old chaotic block is then erased.

FIG. 14(F) shows state diagrams corresponding to the logical group and the metablock transitions for a sequential write operation. The host writes one or more sectors of an Intact Logical Group in logically sequential order to a newly allocated Erased metablock. The Logical Group and the metablock go to Sequential Update state. The previously Intact metablock becomes an Original metablock.

FIG. 14(G) shows state diagrams corresponding to the logical group and the metablock transitions for a sequential fill operation. A Sequential Update Logical Group becomes Intact when all its sectors are written sequentially by the host. This may also occur during garbage collection when the Sequential Update Logical Group is filled with valid sectors from the original block in order to make it Intact, after which the original block is erased.

FIG. 14(H) shows state diagrams corresponding to the logical group and the metablock transitions for a non-sequential write operation. A Sequential Update Logical Group becomes Chaotic when at least one sector is written non-sequentially by the host. The non-sequential sector writes may cause valid sectors in either the Update block or the corresponding Original block to become obsolete.

FIG. 14(I) shows state diagrams corresponding to the logical group and the metablock transitions for a compaction operation. All valid sectors within a Chaotic Update Logical Group are copied into a new chaotic metablock from the old block, which is then erased. The Original block is unaffected.

FIG. 14(J) shows state diagrams corresponding to the logical group and the metablock transitions for a consolidation operation. All valid sectors within a Chaotic Update Logical Group are copied from the old chaotic block and the Original block to fill a newly allocated Erased block in logically sequential order. The old chaotic block and the Original block are then erased.

### Update Block Tracking and Management

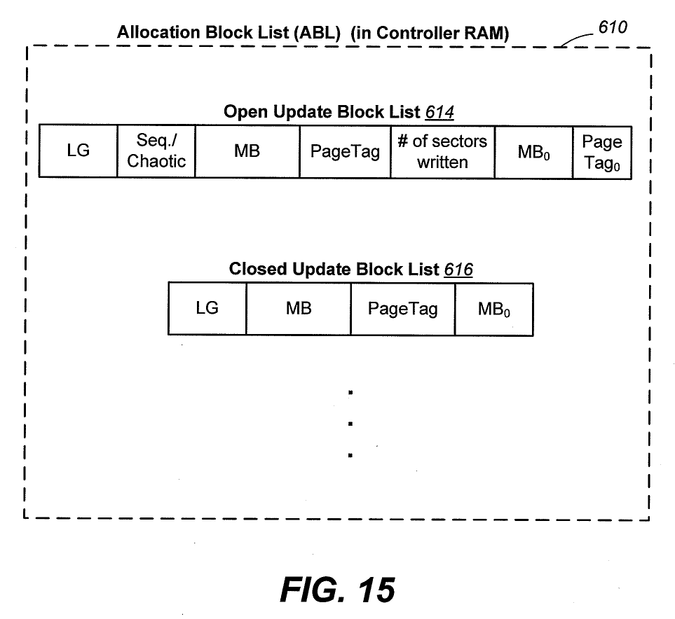

FIG. 15 illustrates a preferred embodiment of the structure of an allocation block list (ABL) for keeping track of opened and closed update blocks and erased blocks for allocation. The allocation block list (ABL) 610 is held in controller RAM 130, to allow management of allocation of erased blocks, allocated update blocks, associated blocks and control structures, and to enable correct logical to physical address translation. In the preferred embodiment, the ABL includes a list of erased blocks, an open update block list 614 and a closed update block list 616.

The open update block list 614 is the set of block entries in the ABL with the attributes of Open Update Block. The open update block list has one entry for each data update block currently open. Each entry holds the following information. LG is the logical group address the current update metablock is dedicated to. Sequential/Chaotic is a status indicating whether the update block has been filled with sequential or chaotic update data. MB is the metablock address of the update block. Page tag is the starting logical sector recorded at the first physical location of the update block. Number of sectors written indicates the number of sectors currently written onto the update block. MB₀ is the metablock address of the associated original block. Page Tag₀ is the page tag of the associated original block.

The closed update block list 616 is a subset of the Allocation Block List (ABL). It is the set of block entries in the ABL with the attributes of Closed Update Block. The closed update block list has one entry for each data update block which has been closed, but whose entry has not been updated in a logical to a main physical directory. Each entry holds the following information. LG is the logical group address the current update block is dedicated to. MB is the metablock address of the update block. Page tag is the starting logical sector recorded at the first physical location of the update block. MB₀ is the metablock address of the associated original block.

### Chaotic Block Indexing

A sequential update block has the data stored in logically sequential order, thus any logical sector among the block can be located easily. A chaotic update block has its logical sectors stored out of order and may also store multiple update generations of a logical sector. Additional information must be maintained to keep track of where each valid logical sector is located in the chaotic update block.

In the preferred embodiment, chaotic block indexing data structures allow tracking and fast access of all valid sectors in a chaotic block. Chaotic block indexing independently manages small regions of logical address space, and efficiently handles system data and hot regions of user data. The indexing data structures essentially allow indexing information to be maintained in flash memory with infrequent update requirement so that performance is not significantly impacted. On the other hand, lists of recently written sectors in chaotic blocks are held in a chaotic sector list in controller RAM. Also, a cache of index information from flash memory is held in controller RAM in order to minimize the number of flash sector accesses for address translation. Indexes for each chaotic block are stored in chaotic block index (CBI) sectors in flash memory.

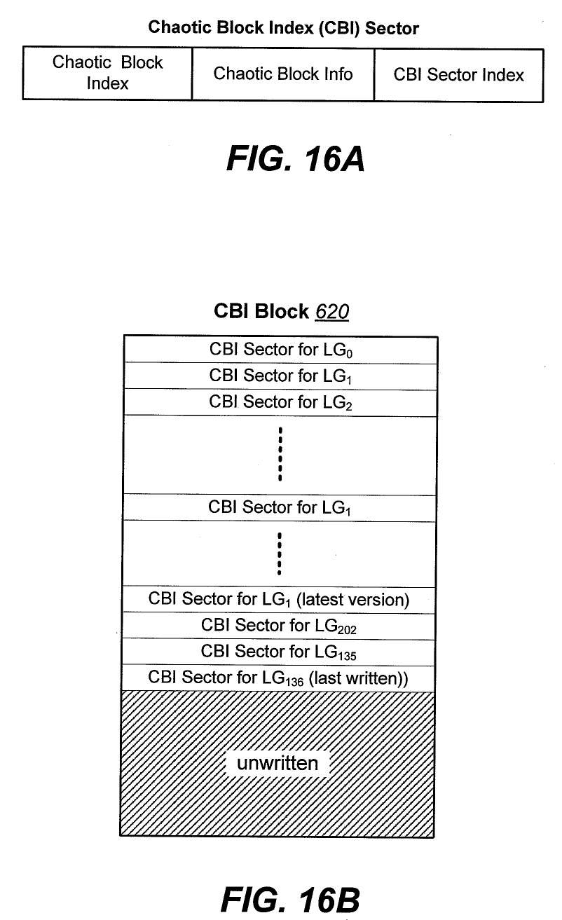

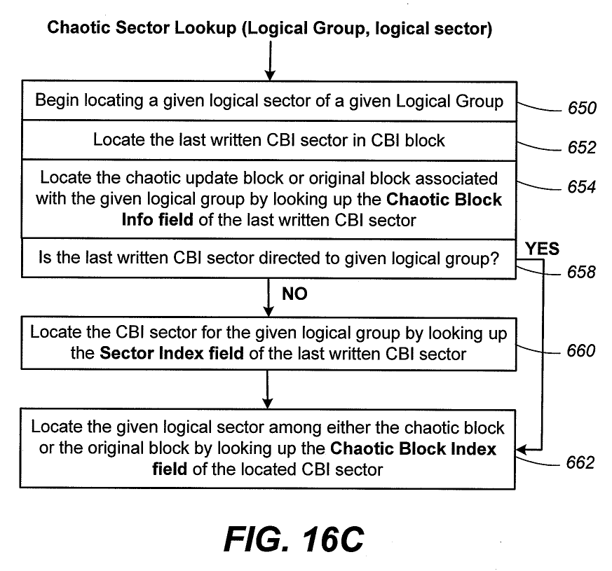

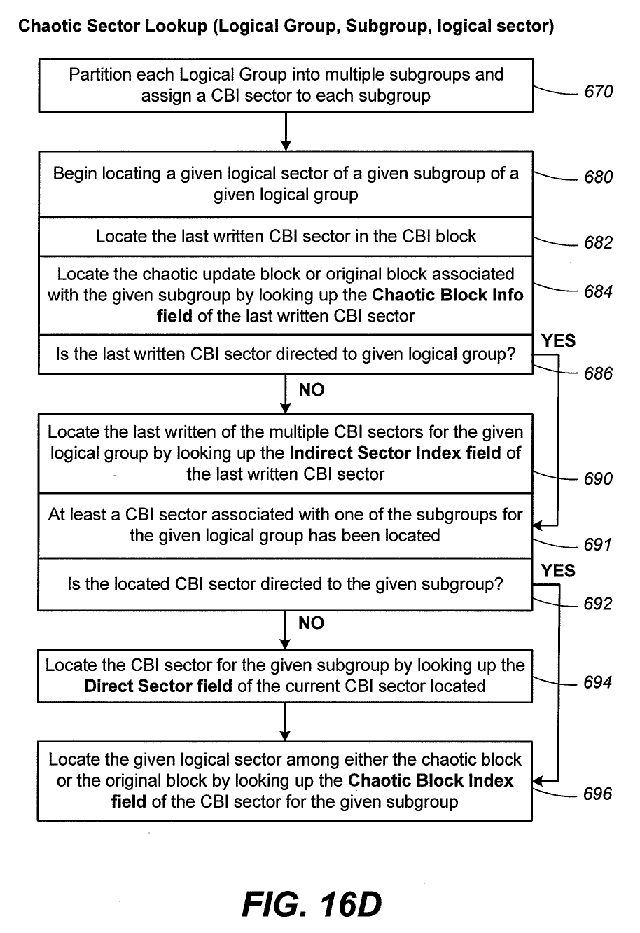

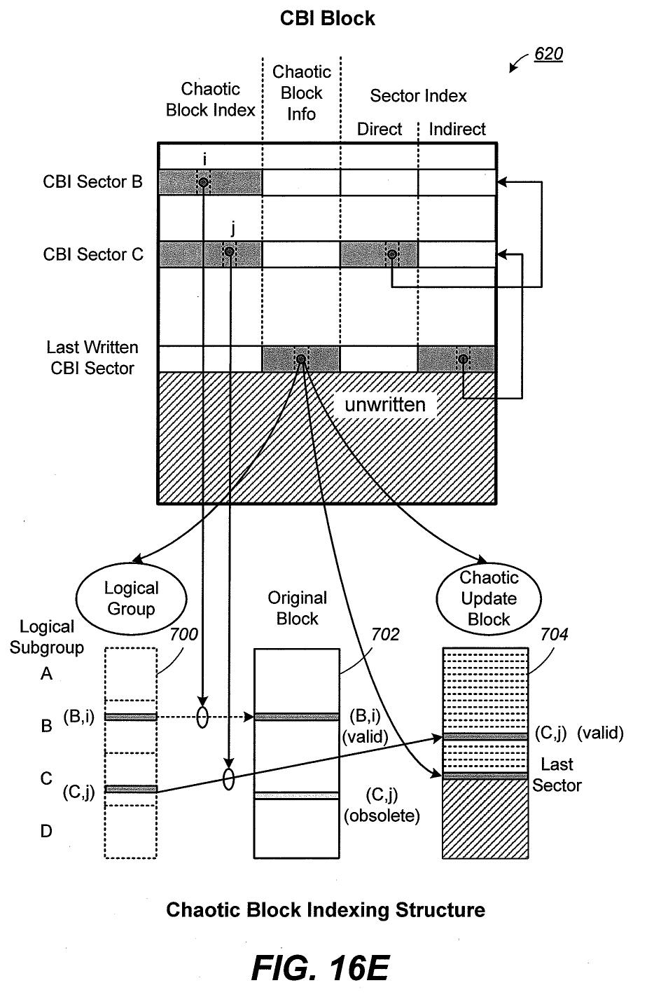

FIG. 16A illustrates the data fields of a chaotic block index (CBI) sector. A Chaotic Block Index Sector (CBI sector) contains an index for each sector in a logical group mapped to a chaotic update block, defining the location of each sector of the logical group within the chaotic update block or its associated original block. A CBI sector includes a chaotic block index field for keeping track of valid sectors within the chaotic block, a chaotic block info field for keeping track of address parameters for the chaotic block, and a sector index field for keeping track of the valid CBI sectors within the metablock (CBI block) storing the CBI sectors.

FIG. 16B illustrates an example of the chaotic block index (CBI) sectors being recorded in a dedicated metablock. The dedicated metablock will be referred to as a CBI block 620. When a CBI sector is updated, it is written in the next available physical sector location in the CBI block 620. Multiple copies of a CBI sector may therefore exist in the CBI block, with only the last written copy being valid. For example the CBI sector for the logical group LG₁ has been updated three times with the latest version being the valid one. The location of each valid sector in the CBI block is identified by a set of indices in the last written CBI sector in the block. In this example, the last written CBI sector in the block is CBI sector for LG₁₃₆ and its set of indices is the valid one superceding all previous ones. When the CBI block eventually becomes fully filled with CBI sectors, the block is compacted during a control write operation by rewriting all valid sectors to a new block location. The full block is then erased.

The chaotic block index field within a CBI sector contains an index entry for each logical sector within a logical group or sub-group mapped to a chaotic update block. Each index entry signifies an offset within the chaotic update block at which valid data for the corresponding logical sector is located. A reserved index value indicates that no valid data for the logical sector exists in the chaotic update block, and that the corresponding sector in the associated original block is valid. A cache of some chaotic block index field entries is held in controller RAM.

The chaotic block info field within a CBI sector contains one entry for each chaotic update block that exists in the system, recording address parameter information for the block. Information in this field is only valid in the last written sector in the CBI block. This information is also present in data structures in RAM.

The entry for each chaotic update block includes three address parameters. The first is the logical address of the logical group (or logical group number) associated with the chaotic update block. The second is the metablock address of the chaotic update block. The third is the physical address offset of the last sector written in the chaotic update block. The offset information sets the start point for scanning of the chaotic update block during initialization, to rebuild data structures in RAM.

The sector index field contains an entry for each valid CBI sector in the CBI block. It defines the offsets within the CBI block at which the most recently written CBI sectors relating to each permitted chaotic update block are located. A reserved value of an offset in the index indicates that a permitted chaotic update block does not exist.

FIG. 16C is a flow diagram illustrating access to the data of a logical sector of a given logical group undergoing chaotic update. During the update process, the update data is recorded in the chaotic update block while the unchanged data remains in the original metablock associated with the logical group. The process of accessing a logical sector of the logical group under chaotic update is as follows:

STEP 650: Begin locating a given logical sector of a given logical group.

STEP 652: Locate last written CBI sector in the CBI block

STEP 654: Locate the chaotic update block or original block associated with the given logical group by looking up the Chaotic Block Info field of the last written CBI sector. This step can be performed any time just before STEP 662.

STEP 658: If the last written CBI sector is directed to the given logical group, the CBI sector is located. Proceed to STEP 662. Otherwise, proceed to STEP 660.

STEP 660: Locate the CBI sector for the given logical group by looking up the sector index field of the last written CBI sector.

STEP 662: Locate the given logical sector among either the chaotic block or the original block by looking up the Chaotic Block Index field of the located CBI sector.

FIG. 16D is a flow diagram illustrating access to the data of a logical sector of a given logical group undergoing chaotic update, according to an alternative embodiment in which logical group has been partitioned into subgroups. The finite capacity of a CBI sector can only keep track of a predetermined maximum number of logical sectors. When the logical group has more logical sectors than a single CBI sector can handle, the logical group is partitioned into multiple subgroups with a CBI sector assigned to each subgroup. In one example, each CBI sector has enough capacity for tracking a logical group consisting of 256 sectors and up to 8 chaotic update blocks. If the logical group has a size exceeding 256 sectors, a separate CBI sector exists for each 256-sector sub-group within the logical group. CBI sectors may exist for up to 8 sub-groups within a logical group, giving support for logical groups up to 2048 sectors in size.

In the preferred embodiment, an indirect indexing scheme is employed to facilitate management of the index. Each entry of the sector index has direct and indirect fields.

The direct sector index defines the offsets within the CBI block at which all possible CBI sectors relating to a specific chaotic update block are located. Information in this field is only valid in the last written CBI sector relating to that specific chaotic update block. A reserved value of an offset in the index indicates that the CBI sector does not exist because the corresponding logical subgroup relating to the chaotic update block either does not exist, or has not been updated since the update block was allocated.

The indirect sector index defines the offsets within the CBI block at which the most recently written CBI sectors relating to each permitted chaotic update block are located. A reserved value of an offset in the index indicates that a permitted chaotic update block does not exist.

FIG. 16D shows the process of accessing a logical sector of the logical group under chaotic update as follows:

STEP 670: Partition each Logical Group into multiple subgroups and assign a CBI sector to each subgroup

STEP 680: Begin locating a given logical sector of a given subgroup of a given logical group.

STEP 682: Locate the last written CBI sector in the CBI block.

STEP 684: Locate the chaotic update block or original block associated with the given subgroup by looking up the Chaotic Block Info field of the last written CBI sector. This step can be performed any time just before STEP 696.

STEP 686: If the last written CBI sector is directed to the given logical group, proceed to STEP 691. Otherwise, proceed to STEP 690.

STEP 690: Locate the last written of the multiple CBI sectors for the given logical group by looking up the Indirect Sector Index field of the last written CBI sector.

STEP 691: At least a CBI sector associate with one of the subgroups for the given logical group has been located. Continue.

STEP 692: If the located CBI sector directed to the given subgroup, the CBI sector for the given subgroup is located. Proceed to STEP 696. Otherwise, proceed to STEP 694.

STEP 694: Locate the CBI sector for the given subgroup by looking up the direct sector index field of the currently located CBI sector.

STEP 696: Locate the given logical sector among either the chaotic block or the original block by looking up the Chaotic Block Index field of the CBI sector for the given subgroup.

FIG. 16E illustrates examples of Chaotic Block Indexing (CBI) sectors and their functions for the embodiment where each logical group is partitioned into multiple subgroups. A logical group 700 originally has its intact data stored in an original metablock 702. The logical group is then undergoing updates with the allocation of a dedicated chaotic update block 704. In the present examples, the logical group 700 is partitioned into subgroups, such subgroups A, B, C, D, each having 256 sectors.

In order to locate the ith sector in the subgroup B, the last written CBI sector in the CBI block 620 is first located. The chaotic block info field of the last written CBI sector provides the address to locate the chaotic update block 704 for the given logical group. At the same time it provides the location of the last sector written in the chaotic block. This information is useful in the event of scanning and rebuilding indices.

If the last written CBI sector turns out to be one of the four CBI sectors of the given logical group, it will be further determined if it is exactly the CBI sector for the given subgroup B that contains the ith logical sector. If it is, then the CBI sector's chaotic block index will point to the metablock location for storing the data for the ith logical sector. The sector location could be either in the chaotic update block 704 or the original block 702.

If the last written CBI sector turns out to be one of the four CBI sectors of the given logical group but is not exactly for the subgroup B, then its direct sector index is looked up to locate the CBI sector for the subgroup B. Once this exact CBI sector is located, its chaotic block index is looked up to locate the ith logical sector among the chaotic update block 704 and the original block 702.

If the last written CBI sector turns out not to be anyone of the four CBI sectors of the given logical group, its indirect sector index is looked up to locate one of the four. In the example shown in FIG. 16E, the CBI sector for subgroup C is located. Then this CBI sector for subgroup C has its direct sector index looked up to locate the exact CBI sector for the subgroup B. The example shows that when its chaotic block index is looked up, the ith logical sector is found to be unchanged and it valid data will be located in the original block.

Similar consideration applies to locating the jth logical sector in subgroup C of the given logical group. The example shows that the last written CBI sector turns out not to be any one of the four CBI sectors of the given logical group. Its indirect sector index points to one of the four CBI sectors for the given group. The last written of four pointed to also turns out to be exactly the CBI sector for the subgroup C. When its chaotic block index is looked up, the jth logical sector is found to be located at a designated location in the chaotic update block 704.

A list of chaotic sectors exists in controller RAM for each chaotic update block in the system. Each list contains a record of sectors written in the chaotic update block since a related CBI sector was last updated in flash memory. The number of logical sector addresses for a specific chaotic update block, which can be held in a chaotic sector list, is a design parameter with a typical value of 8 to 16. The optimum size of the list is determined as a tradeoff between its effects on overhead for chaotic data-write operations and sector scanning time during initialization.

During system initialization, each chaotic update block is scanned as necessary to identify valid sectors written since the previous update of one of its associated CBI sectors. A chaotic sector list in controller RAM for each chaotic update block is constructed. Each block need only be scanned from the last sector address defined in its chaotic block info field in the last written CBI sector.

When a chaotic update block is allocated, a CBI sector is written to correspond to all updated logical sub-groups. The logical and physical addresses for the chaotic update block are written in an available chaotic block info field in the sector, with null entries in the chaotic block index field. A chaotic sector list is opened in controller RAM.

When a chaotic update block is closed, a CBI sector is written with the logical and physical addresses of the block removed from the chaotic block info field in the sector. The corresponding chaotic sector list in RAM becomes unused.

The corresponding chaotic sector list in controller RAM is modified to include records of sectors written to a chaotic update block. When a chaotic sector list in controller RAM has no available space for records of further sector writes to a chaotic update block, updated CBI sectors are written for logical sub-groups relating to sectors in the list, and the list is cleared.

When the CBI block 620 becomes full, valid CBI sectors are copied to an allocated erased block, and the previous CBI block is erased.

### Address Tables

The logical to physical address translation module 140 shown in FIG. 2 is responsible for relating a host's logical address to a corresponding physical address in flash memory. Mapping between logical groups and physical groups (metablocks) are stored in a set of table and lists distributed among the nonvolatile flash memory 200 and the volatile but more agile RAM 130 (see FIG. 1.) An address table is maintained in flash memory, containing a metablock address for every logical group in the memory system. In addition, logical to physical address records for recently written sectors are temporarily held in RAM. These volatile records can be reconstructed from block lists and data sector headers in flash memory when the system is initialized after power-up. Thus, the address table in flash memory need be updated only infrequently, leading to a low percentage of overhead write operations for control data.

The hierarchy of address records for logical groups includes the open update block list, the closed update block list in RAM and the group address table (GAT) maintained in flash memory.

The open update block list is a list in controller RAM of data update blocks which are currently open for writing updated host sector data. The entry for a block is moved to the closed update block list when the block is closed. The closed update block list is a list in controller RAM of data update blocks which have been closed. A subset of the entries in the list is moved to a sector in the Group Address Table during a control write operation.

The Group Address Table (GAT) is a list of metablock addresses for all logical groups of host data in the memory system. The GAT contains one entry for each logical group, ordered sequentially according to logical address. The nth entry in the GAT contains the metablock address for the logical group with address n. In the preferred embodiment, it is a table in flash memory, comprising a set of sectors (referred to as GAT sectors) with entries defining metablock addresses for every logical group in the memory system. The GAT sectors are located in one or more dedicated control blocks (referred to as GAT blocks) in flash memory.

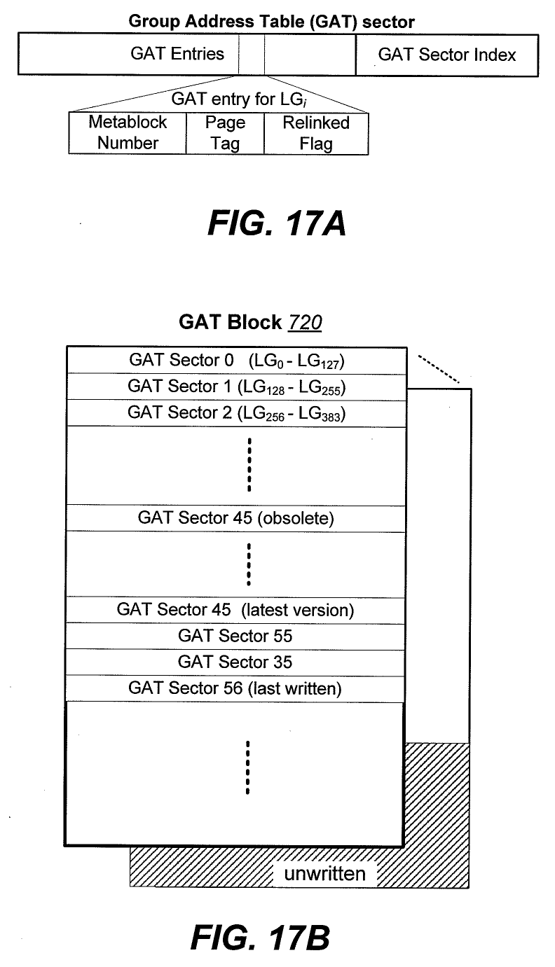

FIG. 17A illustrates the data fields of a group address table (GAT) sector. A GAT sector may for example have sufficient capacity to contain GAT entries for a set of 128 contiguous logical groups. Each GAT sector includes two components, namely a set of GAT entries for the metablock address of each logical group within a range, and a GAT sector index. The first component contains information for locating the metablock associated with the logical address. The second component contains information for locating all valid GAT sectors within the GAT block. Each GAT entry has three fields, namely, the metablock number, the page tag as defined earlier in connection with FIG. 3A(iii), and a flag indicating whether the metablock has been relinked. The GAT sector index lists the positions of valid GAT sectors in a GAT block. This index is in every GAT sector but is superceded by the version of the next written GAT sector in the GAT block. Thus only the version in the last written GAT sector is valid.

FIG. 17B illustrates an example of the group address table (GAT) sectors being recorded in one or more GAT block. A GAT block is a metablock dedicated to recording GAT sectors. When a GAT sector is updated, it is written in the next available physical sector location in the GAT block 720. Multiple copies of a GAT sector may therefore exist in the GAT block, with only the last written copy being valid. For example the GAT sector 255 (containing pointers for the logical groups LG₃₉₆₈-LG₄₀₉₈) has been updated at least two times with the latest version being the valid one. The location of each valid sector in the GAT block is identified by a set of indices in the last written GAT sector in the block. In this example, the last written GAT sector in the block is GAT sector 236 and its set of indices is the valid one superceding all previous ones. When the GAT block eventually becomes fully filled with GAT sectors, the block is compacted during a control write operation by rewriting all valid sectors to a new block location. The full block is then erased.

As described earlier, a GAT block contains entries for a logically contiguous set of groups in a region of logical address space. GAT sectors within a GAT block each contain logical to physical mapping information for 128 contiguous logical groups. The number of GAT sectors required to store entries for all logical groups within the address range spanned by a GAT block occupy only a fraction of the total sector positions in the block. A GAT sector may therefore be updated by writing it at the next available sector position in the block. An index of all valid GAT sectors and their position in the GAT block is maintained in an index field in the most recently written GAT sector. The fraction of the total sectors in a GAT block occupied by valid GAT sectors is a system design parameter, which is typically 25%. However, there is a maximum of 64 valid GAT sectors per GAT block. In systems with large logical capacity, it may be necessary to store GAT sectors in more than one GAT block. In this case, each GAT block is associated with a fixed range of logical groups.

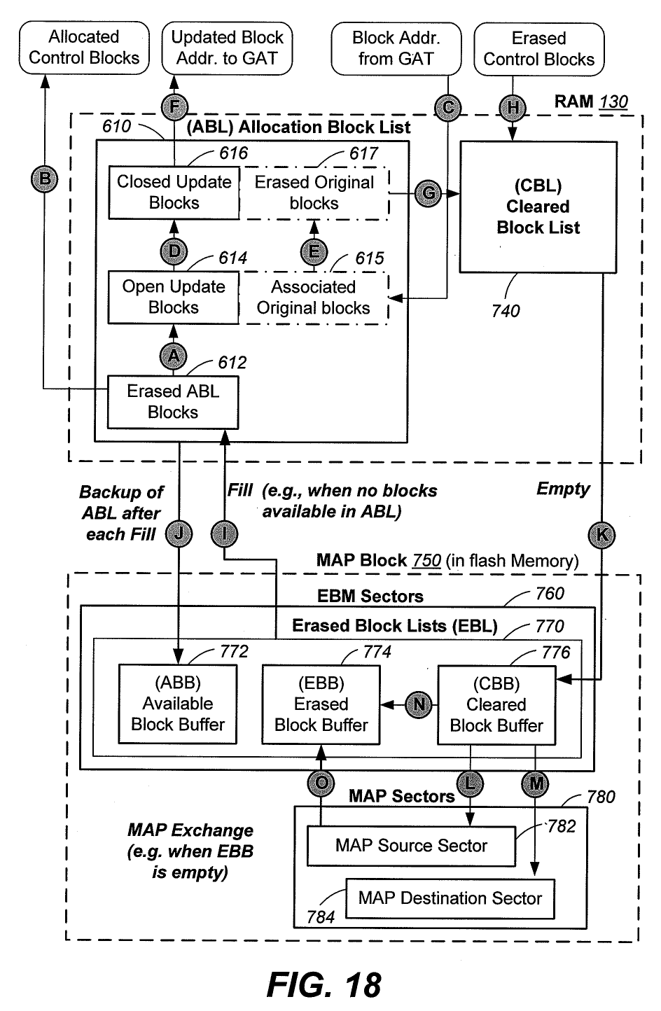

A GAT update is performed as part of a control write operation, which is triggered when the ABL runs out of blocks for allocation (see FIG. 18.) It is performed concurrently with ABL fill and CBL empty operations. During a GAT update operation, one GAT sector has entries updated with information from corresponding entries in the closed update block list. When a GAT entry is updated, any corresponding entries are removed from the closed update block list (CUBL). For example, the GAT sector to be updated is selected on the basis of the first entry in the closed update block list. The updated sector is written to the next available sector location in the GAT block.

A GAT rewrite operation occurs during a control write operation when no sector location is available for an updated GAT sector. A new GAT block is allocated, and valid GAT sectors as defined by the GAT index are copied in sequential order from the full GAT block. The full GAT block is then erased.

A GAT cache is a copy in controller RAM 130 of entries in a subdivision of the 128 entries in a GAT sector. The number of GAT cache entries is a system design parameter, with typical value 32. A GAT cache for the relevant sector subdivision is created each time an entry is read from a GAT sector. Multiple GAT caches are maintained. The number is a design parameter with a typical value of 4. A GAT cache is overwritten with entries for a different sector subdivision on a least-recently-used basis.

### Erased Metablock Management

The erase block manager 160 shown in FIG. 2 manages erase blocks using a set of lists for maintaining directory and system control information. These lists are distributed among the controller RAM 130 and flash memory 200. When an erased metablock must be allocated for storage of user data, or for storage of system control data structures, the next available metablock number in the allocation block list (ABL) (see FIG. 15) held in controller RAM is selected. Similarly, when a metablock is erased after it has been retired, its number is added to a cleared block list (CBL) also held in controller RAM. Relatively static directory and system control data are stored in flash memory. These include erased block lists and a bitmap (MAP) listing the erased status of all metablocks in the flash memory. The erased block lists and MAP are stored in individual sectors and are recorded to a dedicated metablock, known as a MAP block. These lists, distributed among the controller RAM and flash memory, provide a hierarchy of erased block records to efficiently manage erased metablock usage.

FIG. 18 is a schematic block diagram illustrating the distribution and flow of the control and directory information for usage and recycling of erased blocks. The control and directory data are maintained in lists which are held either in controller RAM 130 or in a MAP block 750 residing in flash memory 200.

In the preferred embodiment, the controller RAM 130 holds the allocation block list (ABL) 610 and a cleared block list (CBL) 740. As described earlier in connection with FIG. 15, the allocation block list (ABL) keeps track of which metablocks have recently been allocated for storage of user data, or for storage of system control data structures. When a new erased metablock need be allocated, the next available metablock number in the allocation block list (ABL) is selected. Similarly, the cleared block list (CBL) is used to keep track of update metablocks that have been de-allocated and erased. The ABL and CBL are held in controller RAM 130 (see FIG. 1) for speedy access and easy manipulation when tracking the relatively active update blocks.

The allocation block list (ABL) keeps track of a pool of erased metablocks and the allocation of the erased metablocks to be an update block. Thus, each of these metablocks that may be described by an attribute designating whether it is an erased block in the ABL pending allocation, an open update block, or a closed update block. FIG. 18 shows the ABL containing an erased ABL list 612, the open update block list 614 and the closed update block list 616. In addition, associated with the open update block list 614 is the associated original block list 615. Similarly, associated with the closed update block list is the associated erased original block list 617. As shown previously in FIG. 15, these associated lists are subset of the open update block list 614 and the closed update block list 616 respectively. The erased ABL block list 612, the open update block list 614, and the closed update block list 616 are all subsets of the allocation block list (ABL) 610, the entries in each having respectively the corresponding attribute.

The MAP block 750 is a metablock dedicated to storing erase management records in flash memory 200. The MAP block stores a time series of MAP block sectors, with each MAP sector being either an erase block management (EBM) sector 760 or a MAP sector 780. As erased blocks are used up in allocation and recycled when a metablock is retired, the associated control and directory data is preferably contained in a logical sector which may be updated in the MAP block, with each instance of update data being recorded to a new block sector. Multiple copies of EBM sectors 760 and MAP sectors 780 may exist in the MAP block 750, with only the latest version being valid. An index to the positions of valid MAP sectors is contained in a field in the EMB block. A valid EMB sector is always written last in the MAP block during a control write operation. When the MAP block 750 is full, it is compacted during a control write operation by rewriting all valid sectors to a new block location. The full block is then erased.

Each EBM sector 760 contains erased block lists (EBL) 770, which are lists of addresses of a subset of the population of erased blocks. The erased block lists (EBL) 770 act as a buffer containing erased metablock numbers, from which metablock numbers are periodically taken to re-fill the ABL, and to which metablock numbers are periodically added to re-empty the CBL. The EBL 770 serves as buffers for the available block buffer (ABB) 772, the erased block buffer (EBB) 774 and the cleared block buffer (CBB) 776.

The available block buffer (ABB) 772 contains a copy of the entries in the ABL 610 immediately following the previous ABL fill operation. It is in effect a backup copy of the ABL just after an ABL fill operation.

The erased block buffer (EBB) 774 contains erased block addresses which have been previously transferred either from MAP sectors 780 or from the CBB list 776 (described below), and which are available for transfer to the ABL 610 during an ABL fill operation.

The cleared block buffer (CBB) 776 contains addresses of erased blocks which have been transferred from the CBL 740 during a CBL empty operation and which will be subsequently transferred to MAP sectors 780 or to the EBB list 774.

Each of the MAP sectors 780 contains a bitmap structure referred to as MAP. The MAP uses one bit for each metablock in flash memory, which is used to indicate the erase status of each block. Bits corresponding to block addresses listed in the ABL, CBL, or erased block lists in the EBM sector are not set to the erased state in the MAP.

Any block which does not contain valid data structures and which is not designated as an erased block within the MAP, erased block lists, ABL or CBL is never used by the block allocation algorithm and is therefore inaccessible for storage of host or control data structures. This provides a simple mechanism for excluding blocks with defective locations from the accessible flash memory address space.

The hierarchy shown in FIG. 18 allows erased block records to be managed efficiently and provides full security of the block address lists stored in the controller's RAM. Erased block entries are exchanged between these block address lists and one or more MAP sectors 780, on an infrequent basis. These lists may be reconstructed during system initialization after a power-down, via information in the erased block lists and address translation tables stored in sectors in flash memory, and limited scanning of a small number of referenced data blocks in flash memory.

The algorithms adopted for updating the hierarchy of erased metablock records results in erased blocks being allocated for use in an order which interleaves bursts of blocks in address order from the MAP block 750 with bursts of block addresses from the CBL 740 which reflect the order blocks were updated by the host. For most metablock sizes and system memory capacities, a single MAP sector can provide a bitmap for all metablocks in the system. In this case, erased blocks are always allocated for use in address order as recorded in this MAP sector.

### Erase Block Management Operations

As described earlier, the ABL 610 is a list with address entries for erased metablocks which may be allocated for use, and metablocks which have recently been allocated as data update blocks. The actual number of block addresses in the ABL lies between maximum and minimum limits, which are system design variables. The number of ABL entries formatted during manufacturing is a function of the card type and capacity. In addition, the number of entries in the ABL may be reduced near the end of life of the system, as the number of available erased blocks is reduced by failure of blocks during life. For example, after a fill operation, entries in the ABL may designate blocks available for the following purposes. Entries for Partially written data update blocks with one entry per block, not exceeding a system limit for a maximum of concurrently opened update blocks. Between one to twenty entries for Erased blocks for allocation as data update blocks. Four entries for erased blocks for allocation as control blocks.

### ABL Fill Operation

As the ABL 610 becomes depleted through allocations, it will need to be refilled. An operation to fill the ABL occurs during a control write operation. This is triggered when a block must be allocated, but the ABL contains insufficient erased block entries available for allocation as a data update block, or for some other control data update block. During a control write, the ABL fill operation is concurrent with a GAT update operation.

The following actions occur during an ABL fill operation.

1. ABL entries with attributes of current data update blocks are retained.

2. ABL entries with attributes of closed data update blocks are retained, unless an entry for the block is being written in the concurrent GAT update operation, in which case the entry is removed from the ABL.

3. ABL entries for unallocated erase blocks are retained.

4. The ABL is compacted to remove gaps created by removal of entries, maintaining the order of entries.

5. The ABL is completely filled by appending the next available entries from the EBB list.

6. The ABB list is over-written with the current entries in the ABL.

### CBL Empty Operation

The CBL is a list of erased block addresses in controller RAM with the same limitation on the number of erased block entries as the ABL. An operation to empty the CBL occurs during a control write operation. It is therefore concurrent with an ABL fill/GAT update operations, or CBI block write operations. In a CBL empty operation, entries are removed from the CBL 740 and written to the CBB list 776.

### MAP Exchange Operation

A MAP exchange operation between the erase block information in the MAP sectors 780 and the EBM sectors 760 may occur periodically during a control write operation, when the EBB list 774 is empty. If all erased metablocks in the system are recorded in the EBM sector 760, no MAP sector 780 exists and no MAP exchange is performed. During a MAP exchange operation, a MAP sector feeding the EBB 774 with erased blocks is regarded as a source MAP sector 782. Conversely, a MAP sector receiving erased blocks from the CBB 776 is regarded as a destination MAP sector 784. If only one MAP sector exists, it acts as both source and destination MAP sector, as defined below.

The following actions are performed during a MAP exchange.

1. A source MAP sector is selected, on the basis of an incremental pointer.

2. A destination MAP sector is selected, on the basis of the block address in the first CBB entry that is not in the source MAP sector.

3. The destination MAP sector is updated, as defined by relevant entries in the CBB, and the entries are removed from the CBB.

4. The updated destination MAP sector is written in the MAP block, unless no separate source MAP sector exists.

5. The source MAP sector is updated, as defined by relevant entries in the CBB, and the entries are removed from the CBB.

6. Remaining entries in the CBB are appended to the EBB.

7. The EBB is filled to the extent possible with erased block addresses defined from the source MAP sector.

8. The updated source MAP sector is written in the MAP block.

9. An updated EBM sector is written in the MAP block.

### List Management

FIG. 18 shows the distribution and flow of the control and directory information between the various lists. For expediency, operations to move entries between elements of the lists or to change the attributes of entries, identified in FIG. 18 as [A] to [0], are as follows.

### [A] When an erased block is allocated as an update block for host data, the attributes of its entry in the ABL are changed from Erased ABL Block to Open Update Block.

### [B] When an erased block is allocated as a control block, its entry in the ABL is removed.

[C] When an ABL entry is created with Open Update Block attributes, an Associated Original Block field is added to the entry to record the original metablock address for the logical group being updated. This information is obtained from the GAT.

### [D] When an update block is closed, the attributes of its entry in the ABL are changed from Open Update Block to Closed Update Block.

### [E] When an update block is closed, its associated original block is erased and the attributes of the Associated Original Block field in its entry in the ABL are changed to Erased Original Block.

### [F] During an ABL fill operation, any closed update block whose address is updated in the GAT during the same control write operation has its entry removed from the ABL.

### [G] During an ABL fill operation, when an entry for a closed update block is removed from the ABL, an entry for its associated erased original block is moved to the CBL.

### [H] When a control block is erased, an entry for it is added to the CBL.

### [I] During an ABL fill operation, erased block entries are moved to the ABL from the EBB list, and are given attributes of Erased ABL Blocks.

### [J] After modification of all relevant ABL entries during an ABL fill operation, the block addresses in the ABL replace the block addresses in the ABB list.

### [K] Concurrently with an ABL fill operation during a control write, entries for erased blocks in the CBL are moved to the CBB list.

### [L] During a MAP exchange operation, all relevant entries are moved from the CBB list to the MAP destination sector.

### [M] During a MAP exchange operation, all relevant entries are moved from the CBB list to the MAP source sector.

### [N] Subsequent to [L] and [M] during a MAP exchange operation, all remaining entries are moved from the CBB list to the EBB list.

[O] Subsequent to [N] during a MAP exchange operation, entries other than those moved in [M] are moved from the MAP source sector to fill the EBB list, if possible.

### Logical to Physical Address Translation

To locate a logical sector's physical location in flash memory, the logical to physical address translation module 140 shown in FIG. 2 performs a logical to physical address translation. Except for those logical groups that have recently been updated, the bulk of the translation could be performed using the group address table (GAT) residing in the flash memory 200 or the GAT cache in controller RAM 130. Address translations for the recently updated logical groups will require looking up address lists for update blocks which reside mainly in controller RAM 130. The process for logical to physical address translation for a logical sector address is therefore dependent on the type of block associated with the logical group within which the sector is located. The types of blocks are: intact block, sequential data update block, chaotic data update block, closed data update block.

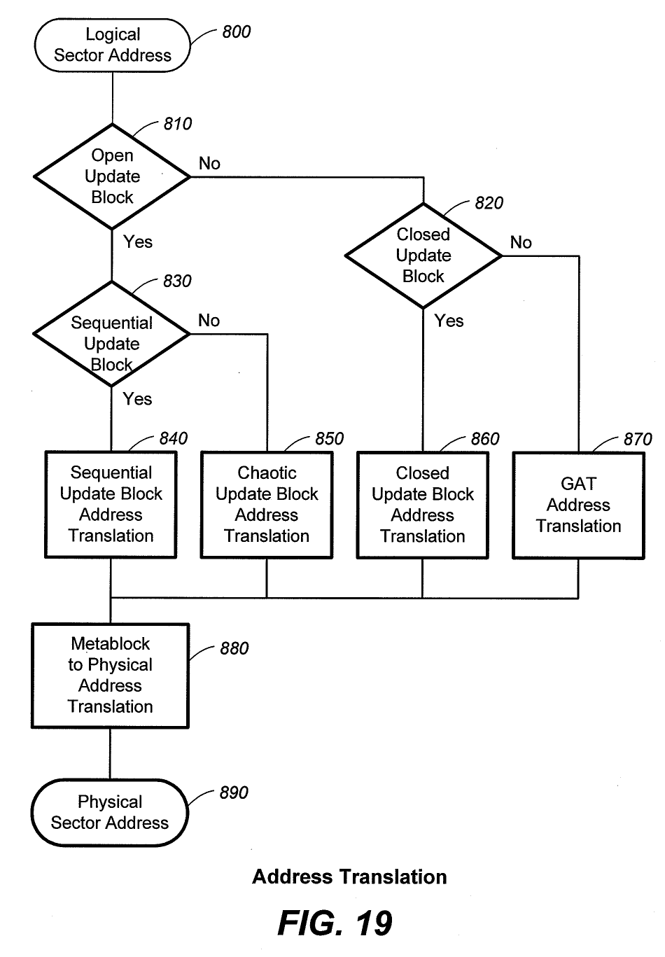

FIG. 19 is a flow chart showing the process of logical to physical address translation. Essentially, the corresponding metablock and the physical sector is located by using the logical sector address first to lookup the various update directories such as the open update block list and the close update block list. If the associated metablock is not part of an update process, then directory information is provided by the GAT. The logical to physical address translation includes the following steps:

STEP 800: A logical sector address is given.

STEP 810: Look up given logical address in the open update blocks list 614 (see FIGS. 15 and 18) in controller RAM. If lookup fails, proceed to STEP 820, otherwise proceed to STEP 830.

STEP 820: Look up given logical address in the closed update block list 616. If lookup fails, the given logical address is not part of any update process; proceed to STEP 870 for GAT address translation. Otherwise proceed to STEP 860 for closed update block address translation.

STEP 830: If the update block containing the given logical address is sequential, proceed to STEP 840 for sequential update block address translation. Otherwise proceed to STEP 850 for chaotic update block address translation.

STEP 840: Obtain the metablock address using sequential update block address translation. Proceed to STEP 880.

STEP 850: Obtain the metablock address using chaotic update block address translation. Proceed to STEP 880.

STEP 860: Obtain the metablock address using closed update block address translation. Proceed to STEP 880.

STEP 870: Obtain the metablock address using group address table (GAT) translation. Proceed to STEP 880.

STEP 880: Convert the Metablock Address to a physical address. The translation method depends on whether the metablock has been relinked.

STEP 890: Physical sector address obtained.

The various address translation processes are described in more detail as follows:

### Sequential Update Block Address Translation (STEP 840)

Address translation for a target logical sector address in a logical group associated with a sequential update block can be accomplished directly from information in the open update block list 614 (FIGS. 15 and 18), as follows.

### 1. It is determined from the “page tag” and “number of sectors written” fields in the list whether the target logical sector is located in the update block or its associated original block.

### 2. The metablock address appropriate to the target logical sector is read from the list.

### 3. The sector address within the metablock is determined from the appropriate “page tag” field.

### Chaotic Update Block Address Translation (STEP 850)

The address translation sequence for a target logical sector address in a logical group associated with a chaotic update block is as follows.

1. If it is determined from the chaotic sector list in RAM that the sector is a recently written sector, address translation may be accomplished directly from its position in this list.

2. The most recently written sector in the CBI block contains, within its chaotic block data field, the physical address of the chaotic update block relevant to the target logical sector address. It also contains, within its indirect sector index field, the offset within the CBI block of the last written CBI sector relating to this chaotic update block (see FIGS. 16A-16E).

3. The information in these fields is cached in RAM, eliminating the need to read the sector during subsequent address translation.

4. The CBI sector identified by the indirect sector index field at step 3 is read.

5. The direct sector index field for the most recently accessed chaotic update sub-group is cached in RAM, eliminating the need to perform the read at step 4 for repeated accesses to the same chaotic update block.

6. The direct sector index field read at step 4 or step 5 identifies in turn the CBI sector relating to the logical sub-group containing the target logical sector address.

7. The chaotic block index entry for the target logical sector address is read from the CBI sector identified in step 6.

8. The most recently read chaotic block index field may be cached in controller RAM, eliminating the need to perform the reads at step 4 and step 7 for repeated accesses to the same logical sub-group.

9. The chaotic block index entry defines the location of the target logical sector either in the chaotic update block or in the associated original block. If the valid copy of the target logical sector is in the original block, it is located by use of the original metablock and page tag information.

### Closed Update Block Address Translation (STEP 860)

Address translation for a target logical sector address in a logical group associated with a closed update block can be accomplished directly from information in the closed block update list (see FIG. 18), as follows.

1. The metablock address assigned to the target logical group is read from the list.

2. The sector address within the metablock is determined from the “page tag” field in the list.

### GAT Address Translation (STEP 870)

If a logical group is not referenced by either the open or closed block update lists, its entry in the GAT is valid. The address translation sequence for a target logical sector address in a logical group referenced by the GAT is as follows.

1. The ranges of the available GAT caches in RAM are evaluated to determine if an entry for the target logical group is contained in a GAT cache.

2. If the target logical group is found in step 1, the GAT cache contains full group address information, including both metablock address and page tag, allowing translation of the target logical sector address.

3. If the target address is not in a GAT cache, the GAT index must be read for the target GAT block, to identify the location of the GAT sector relating to the target logical group address.

4. The GAT index for the last accessed GAT block is held in controller RAM, and may be accessed without need to read a sector from flash memory.

5. A list of metablock addresses for every GAT block, and the number of sectors written in each GAT block, is held in controller RAM. If the required GAT index is not available at step 4, it may therefore be read immediately from flash memory.

6. The GAT sector relating to the target logical group address is read from the sector location in the GAT block defined by the GAT index obtained at step 4 or step 6. A GAT cache is updated with the subdivision of the sector containing the target entry.

7. The target sector address is obtained from the metablock address and “page tag” fields within the target GAT entry.

### Metablock to Physical Address Translation (STEP 880)

If a flag associated with the metablock address indicates that the metablock has been re-linked, the relevant LT sector is read from the BLM block, to determine the erase block address for the target sector address. Otherwise, the erase block address is determined directly from the metablock address.

### Scratch Pad Block

In another embodiment, a scratch pad block (“SPB”) is implemented to buffer data written to an update block. Update data to a non-volatile memory may be recorded in at least two interleaving streams such as either into an update block or a scratch pad block depending on a predetermined condition. The scratch pad block is used to buffered update data that are ultimately destined for the update block. In a preferred embodiment, an index (“SPBI/CBI”) of the data stored in the scratch pad block as well that stored in the update block is kept in the data structures of the controller RAM. These data structures allow tracking and fast access of all valid sectors in the scratch pad block (SPB) and the chaotic blocks. At appropriate time, as described below, the SPBI/CBI data will be saved in an unused portion of a page of the scratch pad block.

In this embodiment, the address translation shown in FIG. 19 is modified to include lookup of any data buffered in the SPB. Thus, in between Open Update Block 810 and Sequential Update Block 830 will be an additional query box to determine if there is any data buffered in the SPB. If there is not, the flow proceeds to the Sequential Update Block 830, otherwise, there will be a SPB address translation before proceeding to the Metablock to Physical Address Translation module 890.

Implementation of scratch pad block has been described in U.S. Application Publication No. US-2006-0155922-A1 published Jul. 13, 2006, entitled “Non-Volatile Memory And Method With Improved Indexing For Scratch Pad And Update Blocks”, by Gorobets et al.

### Control Data Management

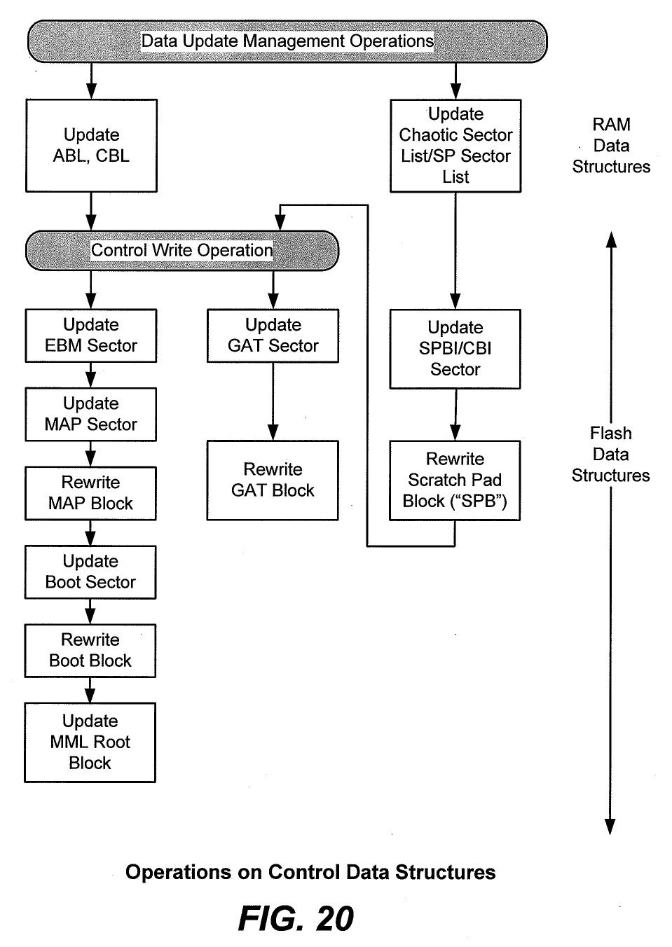

FIG. 20 illustrates the hierarchy of the operations performed on control data structures in the course of the operation of the memory management. Data Update Management Operations act on the various lists that reside in RAM. Control write operations act on the various control data sectors and dedicated blocks in flash memory and also exchange data with the lists in RAM.

Data update management operations are performed in RAM on the ABL, the CBL and the Scratch Pad Sector List/Chaotic Sector List. The ABL is updated when an erased block is allocated as an update block or a control block, or when an update block is closed. The CBL is updated when a control block is erased or when an entry for a closed update block is written to the GAT. The Scratch Pad Sector List is updated when sectors are written to a scratch pad block. The update chaotic sector list is updated when a sector is written to a chaotic update block. It will be understood, the sector here is an example of a unit of write data, which is also referred to as a page.

A control write operation causes information from control data structures in RAM to be written to control data structures in flash memory, with consequent update of other supporting control data structures in flash memory and RAM, if necessary. It is triggered either when the ABL contains no further entries for erased blocks to be allocated as update blocks, or when the SP block is rewritten.

In the preferred embodiment, the ABL fill operation, the CBL empty operation and the EBM sector update operation are performed during every control write operation. When the MAP block containing the EBM sector becomes full, valid EBM and MAP sectors are copied to an allocated erased block, and the previous MAP block is erased.

One GAT sector is written, and the Closed Update Block List is modified accordingly, during every control write operation.

A GAT block rewrite takes place when a GAT block becomes full and the data in the full block will be relocated to an allocated erased block.

A SPBI/CBI sector is written, after certain chaotic sector write operations.

A SPB block rewrite takes place when the SPBI/CBI block becomes full. Valid SPBI/CBI sectors are copied to an allocated erased block, and the previous SPB block is erased.

A MAP exchange operation, as described earlier, is performed when there are no further erased block entries in the EBB list in the EBM sector.

A MAP Block rewrite takes place when the MAP block becomes full and valid EBM and MAP sectors are copied to an allocated erased block, and the previous MAP block is erased.

A Boot sector is written in a current Boot block on each occasion the MAP block is moved.

A Boot Block rewrite takes place when the boot block becomes full. The valid Boot sector is copied from the current version of the Boot block to the backup version, which then becomes the current version. The previous current version is erased and becomes the backup version, and the valid Boot sector is written back to it.

Example of control data are the directory information and block allocation information associated with the memory block management system, such as those described in connection with FIG. 20. As described earlier, the control data is maintained in both high speed RAM and the slower nonvolatile memory blocks. Any frequently changing control data is maintained in RAM with periodic control writes to update equivalent information stored in a nonvolatile metablock. In this way, the control data is stored in nonvolatile, but slower flash memory without the need for frequent access. A hierarchy of control data structures such as Boot sector, GAT, SBI/CBI and MAP shown in FIG. 20 is maintained in flash memory. Thus, a control write operation causes information from control data structures in RAM to update equivalent control data structures in flash memory.

As described in connection with FIG. 20, the block management system maintains a set of control data in flash memory during its operation. This set of control data is stored in the metablocks similar to host data. As such, the control data itself will be block managed and will be subject to updates and therefore garbage collection operations.

### One-Time Programmable Memory (“OTP”)

There are certain memory applications where the data is intended to be committed to memory not to be updated again. Therefore memory devices for these applications, referred to as one-time programmable memory or OTP memory devices, need not provide erase and reprogram facilities. OTP memory devices can have simplified block management system, thereby reducing complexity and overheads.

The block management system described herein is compatible with the implementation of a OTP memory device. Essentially for the OTP memory, each block is treated as a unit of memory storage. The difference with the erasable block management system described is that the blocks are not erased. However, the techniques of pre-emptive relocation of data from one block to another is equally applicable to OTP memory.

OTP memory systems has been described in U.S. Application Publication No. US-2006-0047920-A1 published Mar. 2, 2006, entitled “Method and Apparatus for Using a One-Time or Few-Time Programmable Memory with a Host Device designated for Erasable/Rewriteable Memory.”

### Pre-emptive Data Relocation

It has also been described earlier that a hierarchy of control data exists, with the ones in the lower hierarchy being updated more often than those higher up. For example, assuming that every control block has N control sectors to write, the following sequence of control updates and control block relocations, normally happens. Referring to FIG. 20 again, every N SPBI/CBI updates fill up the SP block and trigger a SPB relocation (rewrite) and a MAP update. If the Chaotic block gets closed then it may also trigger a GAT update. Every GAT update triggers a MAP update. Every N GAT updates fill up the block and trigger a GAT block relocation. In addition, when a MAP block gets full it also triggers a MAP block relocation, a BOOT Block update. In addition, when a BOOT Block gets full, it triggers an active BOOT Block relocation to another BOOT Block.

Since the hierarchy is formed by the BOOT control data at the top followed by MAP and then GAT, thus, in some instances after a GAT update there will be a “cascade control update”, where all of the GAT, MAP and BOOT blocks would be relocated. In the case when GAT update is caused by a Chaotic or Sequential Update block closure as a result of a host write, there will also be a garbage collection operation (i.e., relocation or rewrite.) In that case of Chaotic Update Block garbage collection, a SPBI/CBI index would be updated, and that can also trigger a SP block relocation. Thus, in this extreme situation, a large number of metablocks need be garbage collected at the same time.

In can be seen that each control data block of the hierarchy has its own periodicity in terms of getting filled and being relocated. If each proceeds normally, there will be times when the phases of a large number of the blocks will line up and trigger a massive relocation or garbage collection involving all those blocks at the same time. Relocation of many control blocks will take a long time and should be avoided as some hosts do not tolerate long delays caused by such massive control operations.

For example, this undesirable situation can happen when updating control data used for controlling the operation of the block management system. A hierarchy of control data type can exist with varying degree of update frequencies, resulting in their associated update blocks requiring garbage collection or relocation at different rates. There will be certain times that the garbage collection operations of more than one control data types coincide. In the extreme situation, the relocation phases of the blocks for all control data types could line up, resulting in all of the blocks requiring relocation or rewrite at the same time.

One solution to avoid cascade relocation of data has been described in U.S. Application Publication No. US-2005-0144365-A1 published Jun. 30, 2005, entitled “Non-Volatile Memory and Method with Control Data Management,” by Gorobets et al. In a nonvolatile memory with a block management system, a preemptive relocation of a memory block or controlled rewrite is implemented to avoid the situation where a large number of control update blocks all happen to need relocation at the same time. This undesirable situation is avoided by whenever a current host operation can also accommodate a housekeeping operation, a preemptive relocation of a control block takes place in advance the block being totally filled. In particular, priority is given to the block with a data type having the fastest fill rate. The method can be regarded as introducing some sort of dithering to the overall mix of things in order to avoid alignment of the phases of the various blocks in question. Thus, whenever an opportunity arises, a fast-filling block that has a slight margin from being totally filled is to be relocated preemptively.

### Scheduling Internal Housekeeping Operations with Time Budget Analysis

As described earlier, rewrite operations will be necessary where a block containing control data is full. After undergoing a series of updates, the filled block typically contains valid data as well as obsolete data. The valid data will be copied to another block with empty space. This relocation operation is a garbage collection operation where the full block is erased and recycled after its valid data are salvaged and copied to another block. Another reason for relocation is when a defect has been encountered in a block, rendering the block unusable. This is particular true for those defects that requires excessive error correction by a built-in error correction code or that simply cannot be corrected. Yet another reason for relocation is the need to ensure uniform usage of all blocks in the memory so that no block gets excessive erase/program cycling to wear out prematurely.

The relocation operations mentioned above are all examples of a system housekeeping operation. Relocation of data from one block to another is typically relatively time consuming as it involves reading and writing substantial amount of data. The housekeeping operations can be performed in the background when a host is not actively engaging the memory. However, while it is ongoing, a host is excluded from sending a command to the memory and may even power down the memory thereby interrupting the ongoing housekeeping operation. A preferred way is to perform the housekeeping operations in the foreground, contemporaneously with the memory executing a host command.

U.S. Application Publication No. US-2006-0161728-A1 published Jul. 20, 2006, entitled “Scheduling of Housekeeping Operations in Flash Memory Systems,” by Bennett et al discloses execution of a host command performed together with one or more such housekeeping operations within a time budget established for executing the particular host command. In particular, one such host command is to write data being received to the memory. One such housekeeping operation is to level out the wear of the individual blocks that accumulates through repetitive erasing and re-programming.

### Worst-Case Control Data Management

According to the present invention, an improved scheme is provided to avoid possible lengthy cascade updates of the control data. This is accomplished by setting a block margin for each type of control data and rewriting the block at the earliest opportunity when the block margin has been reached. In particular, the margin is set just sufficient to accommodate data accumulated in a predetermined interval before the rewrite can take place so as not to totally fill the block before the rewrite can take place. The predetermined interval is determined, among other things, by considering a host write pattern that yields a worst-case interval before the rewrite can take place. Other considerations for setting the margin include the time required for each control block rewrite and the time available for control block rewrites based on the configuration of the update blocks for storing host data, the time required in the foreground host operation and the host write latency.

The improvement also makes allowance for multiple program errors per the cascade control update, so that it is able to handle more than one ECC or program error occurring one soon after another within the timing limitation. This feature is particularly important for one-time programmable (“OTP”) memory since the risk is quite high if the defects are not patched on the lower level. The improvement also enables a minimum of blocks to be reserved in a pool of update blocks for storing control data. The reserved blocks enable the memory control system to handle the worst cascade update where all control data blocks can potentially be filled at the same time, and must all be rewritten in the same busy period. If fewer blocks are required to be reserved for control data, more blocks will be available for host data updates.

The advantages of the invention include the following. An increased number of errors can be handled in the worst-case update sequence. A worst-case of a longest combination of garbage collections (GC) and control block compaction can be avoided. For example, Chaotic GC takes longer than Sequential GC, so by avoiding doing control updates at the same time as Chaotic GC the worst case command latency can be reduced. Optimized performance is obtained by optimum selection of the block margins (e.g., by selecting a fuller control block to compact) and scheduling of an internal operation to perform. Reduced number of reserved erased blocks is required to handle the worst case update sequence. Errors can be handled much quicker in the cases of pre-emptive internal operations as the error handling can be rescheduled. Partial error handling and schedule completion of the error handling is possible. It is possible to schedule ECC error handling during read operation, which has short latency, to be done later (e.g., during next write operation.)

### Estimation of Host Command Operation Duration

In a typical host command such as write host data, the host specifies a timeout or write latency designed to accommodate the worst-case situation for the memory to complete the command. The actual duration for the memory to execute the command depends on the state of the memory block the data is being written to. In particular it depends on whether the writing includes additional time-consuming data relocation between blocks. These data relocation is caused by closure of a block in response to a new block being allocated. The closure of a block typically requires a garbage collection before being erased and recycled.

### Configuration of a Pool of Update Blocks

A block is typically closed after it is full or when data are no longer written to it for some reason. Another factor that affects the timing of a block getting closed is how a pool of update blocks opened for updates concurrently is configured. Since there is a limit on the number of blocks in the pool, an existing block must be closed if a new block is introduced into a fully populated pool.

The practical system limitation of supporting up to a maximum number of concurrently opened update blocks has been described earlier. For example, in one embodiment described in connection with FIG. 10, STEP 410 tests if a new allocation will exceed the maximum number U_{MAX} of update blocks that can be concurrently opened for accepting update data. If U_{MAX} will be exceeded, the least active among the update blocks, will be closed in STEP 420 to keep the system within the prescribed limit.

Alternative selection of which update blocks in a full pool to close has been disclosed in U.S. patent application Ser. No. 11/532,456 filed Sep. 15, 2006, entitled “Method For Class-Based Update Block Replacement Rules In Non-Volatile Memory,” by Jason Lin.

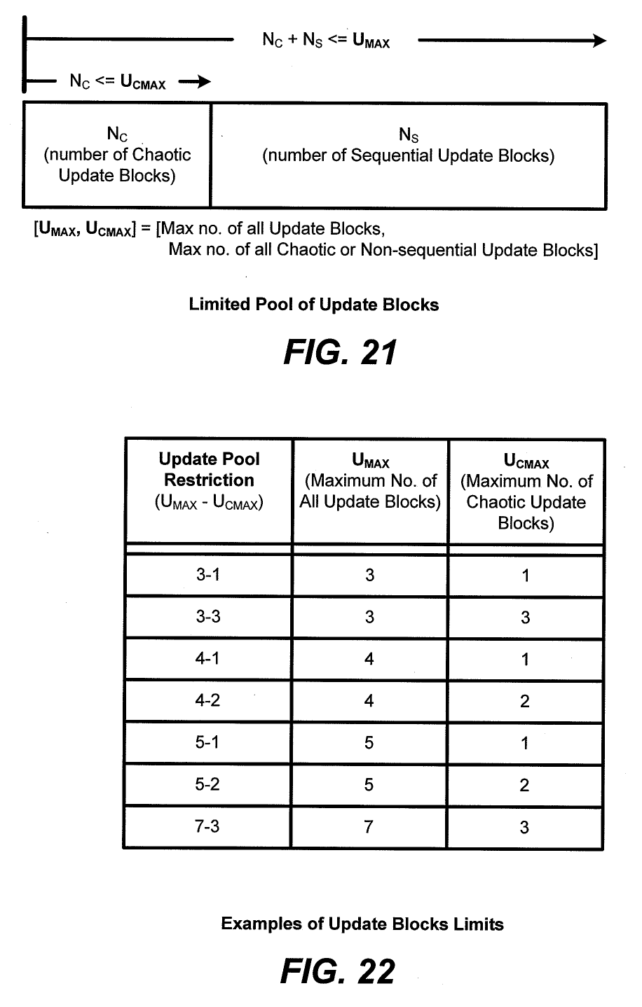

FIG. 21 illustrates schematically the two prescribed limits on the number of update blocks for a block managing system. There is an overall limit in a pool of update blocks maintained by the system. The total number of update blocks can not exceed a maximum (U_{MAX}), which is given by the sum of the number of chaotic update blocks N_{C} and the number of sequential update blocks N_{S}. Thus, the update pool can contain a mixture of sequential and chaotic update blocks. Since a chaotic update block is more resource-intensive, requiring additional maintenance of a chaotic block index (CBI), preferably there is also a limit on the maximum number of chaotic update blocks (“U_{CMAX}”). Thus, the first limit requires that the total number of update blocks, N_{C}+N_{S}<=U_{MAX}. The second limit requires that the number of chaotic update blocks N_{C}<=U_{CMAX}. It is therefore possible to have the number of sequential update blocks N_{S}=U_{MAX}, but in general the number chaotic update block U_{CMAX} is less than U_{MAX}.

FIG. 22 illustrates typical examples of combinations of the two limits optimized for various memory devices. A given combination is designated by U_{MAX} “dash” U_{CMAX}. For example, “3-1” designates a block managing system allowing up to a maximum of three update blocks in the update pool and of which only up to one is a chaotic update block. Similarly, “7-3” designates a block managing system supporting up to a maximum of seven update blocks and of which up to three can be chaotic update blocks. In general simpler memory systems having smaller memory capacity will be more restrictive, having smaller maximum numbers.

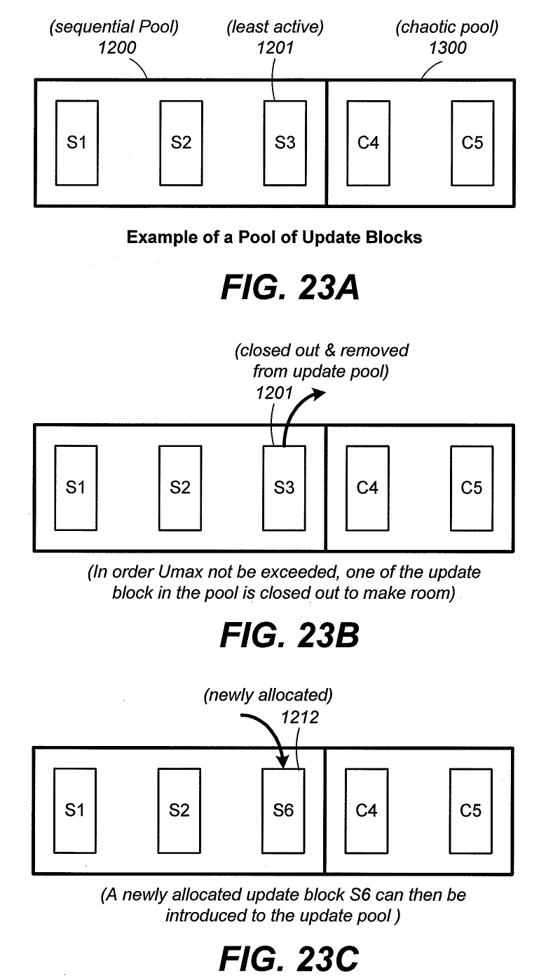

FIG. 23A, FIG. 23B and FIG. 23C illustrate schematically the sequence of event for introducing a new update block into a pool of update blocks, resulting in a closure of an existing sequential block.

FIG. 23A illustrates schematically an update pool with a “5-2” configuration as described in FIG. 22. In this example, the update pool is fully populated with a maximum of five allowable update blocks. The update pool is further partitioned into a sequential pool 1200 that contains three sequential update blocks, S1, S2 and S3 and a chaotic pool 1300 that contains a maximum of two chaotic or non-sequential update blocks, C4 and C5. The example shows the least active block happens to be a sequential update block such as S3 1201.

In the event that a new update block needs to be allocated, one of the existing update blocks in the update pool will need to be closed to make room. For example in the event when the host writes sequential data for a logical group of sectors not serviced by the existing update blocks in the pool, a new update block will need to be allocated for recording the data.

FIG. 23B illustrates schematically the closing of the least active update block in order to make room for a new update block. The least active update block, in this case happens to be S3 1201 and it will be closed and removed from the pool of the update blocks. As described earlier, the closing of a sequential block generally involves relative little relocation if at all, such as padding any remaining empty space with data copied from other blocks.

FIG. 23C illustrates schematically introducing a newly allocated update block into the pool after a closed update block has been removed to make room. In this case, S6 1212 which is a newly allocated update block will be introduced into the sequential pool 1200 for recording data in logically sequential order. In this way, U_{MAX}, the maximum number of update blocks allowed is not exceeded.

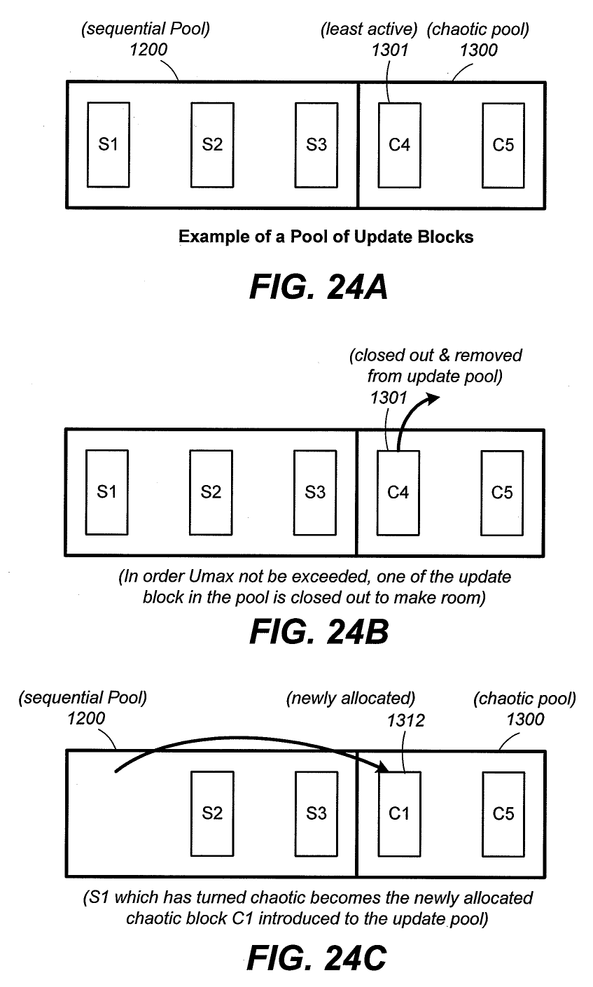

FIG. 24A, FIG. 24B and FIG. 24C illustrate schematically the sequence of event for introducing a new update block into a pool of update blocks, resulting in a closure of an existing chaotic block.

FIG. 24A illustrates schematically an update pool with a “5-2” configuration as described in FIG. 22. In this example, the update pool is fully populated with a maximum of five allowable update blocks. The update pool is further partitioned into a sequential pool 1200 that contains three sequential update blocks, S1, S2 and S3 and a chaotic pool 1300 that contains a maximum of two chaotic or non-sequential update blocks, C4 and C5. The example shows the chaotic block to be closed out happens to be a chaotic update block such as C4 1301.

FIG. 24B illustrates schematically the closing of the chaotic update block in order to make room for a new chaotic update block. For example, if the sequential update block S1 is beginning to record data non-sequentially and turns into a chaotic update block C1 1312, an existing chaotic block (e.g., C4 1301) will be closed and removed from the chaotic pool 1300. Another example could be when the chaotic update block is C4 1301 becomes full. It will be closed and removed from the pool after its data is compacted to a new chaotic block. As described earlier, the closing of a chaotic block may involve a consolidation where the chaotic block will be replaced by a new block carrying the consolidated data.

FIG. 24C illustrates schematically introducing a newly allocated chaotic update block into the pool after a closed chaotic update block has been removed to make room. In this case, C1 1312 which is a newly allocated chaotic update block will replace the closed chaotic block C4 1301 and carries the consolidated data (see FIG. 24B). The newly introduced C1 1312 into the chaotic pool 1300 will record data in logically non-sequential order. In this way, U_{CMAX}, the maximum number of chaotic update blocks allowed is not exceeded.

### Host Command Execution Timing

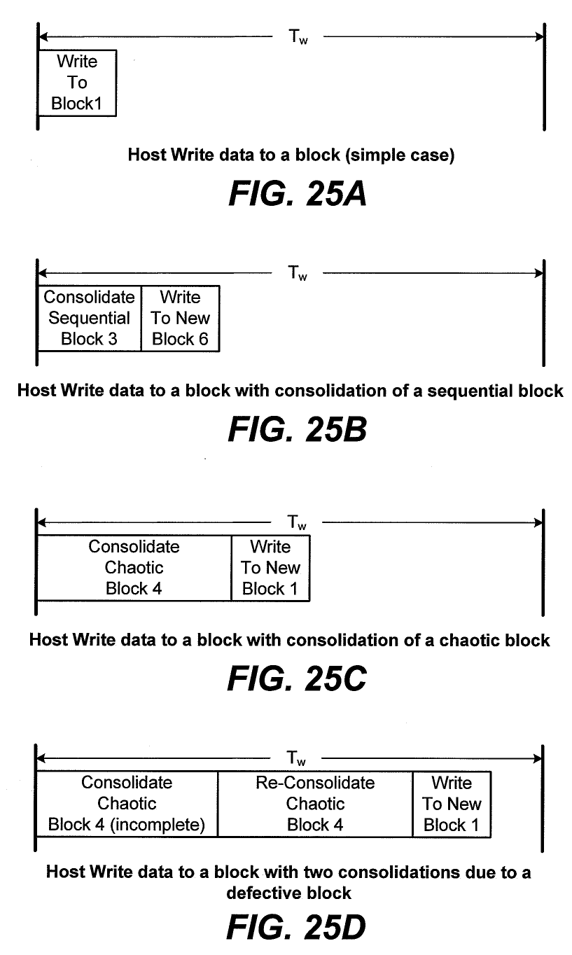

FIG. 25A to FIG. 25D illustrate example timings of a host write command on the memory. Typically, the host issues a write command for the memory to execute. The host has a specified timeout or write latency within which the command is expected to be completed. While the memory is executing the host command it communicates this fact by asserting a BUSY signal to the host. If the BUSY signal goes beyond the write latency period, the host will timeout and abort the write command. If the memory completed the write command within the latency period, it will de-assert the BUSY signal to signal READY to the host that it is done executing and is ready to receive the next command.

FIG. 25A to FIG. 25D illustrate various scenarios where the execution duration may be different owning to the nature of the write data and the state of the update blocks in a resource-limited pool.

FIG. 25A illustrates schematically a timing diagram for a memory executing a host write involving a simple sequential update. Host Write 1 is a simple update in which some host data is written to a block such as block 1. Using the examples in FIG. 23A, the data is appended to a sequential block, say S1, in the sequential update pool 1200. It will be seen from FIG. 25A that in this simple case where no other data relocations are involved, the write operation is completed well within a latency period T_{W} for the write command. Similarly, a simple write to a chaotic block in the chaotic pool 1300 will also be relatively quick if no other data relocations are involved.

FIG. 25B illustrates schematically a timing diagram for a memory executing a host write involving a sequential update plus a closure of another sequential block. In Host Write 2, writing data happens to require the allocation of a new sequential block for recording the data. For example, the data belongs to a logical group not currently covered by any of the update blocks in the update pool. Using the examples in FIG. 23B, because the update pool is already at a maximum number of seven update blocks, one of the existing update blocks must first be closed to make room for the newly allocated one. In this case, the sequential block S3 is closed. This typically its remaining empty space to be padded with existing data transferred from another block. Also referring to the example in FIG. 23C, a new sequential block S6 is allocated and host will then write the data to it. It will be seen from FIG. 25B that in this sequential close case the write operation takes a bit longer to completed due to the extra operation of closing a sequential block, but the total operation is still well within the latency period T_{W} for the write command.

FIG. 25C illustrates schematically a timing diagram for a memory executing a host write involving a chaotic update plus a closure and relocation of another chaotic update block. In Host Write 3, writing data is written non-sequentially to a sequential block. This has the effect of turning the sequential block into a chaotic block and effectively requires the allocation of a new chaotic block into the update pool. Using the examples in FIG. 24B; because the chaotic update pool 1300 is already at a maximum number of two update blocks, one of the existing chaotic update blocks (e.g., C4 1301) must first be closed to make room for the newly allocated one. In this case, the chaotic block C4 is closed after its data has been relocated to a newly allocated block (e.g., C6 1312.) Also referring to the example in FIG. 24C, the new chaotic block C6 is allocated and replaces C4 in the chaotic update pool. The host will then write the data to it. It will be seen from FIG. 25C that in this chaotic close case the write operation takes even longer to completed due to the extra operation of closing a chaotic block. In general, the closure of a chaotic block usually requires more relocation of data than that of a sequential block and thus will take relatively longer to do. However, the total operation combining a chaotic block closure and a chaotic write is still within the latency period T_{W} for the write command.

FIG. 25D illustrates schematically a timing diagram for a memory executing a host write involving a chaotic update plus two passes in closing another chaotic update block. The example is similar to that illustrated in FIG. 25C except the relocation of the data from the closure of C4 is repeated more than once. This can happen when data from C4 is being consolidated to C6 encounters a defect in C6. Yet another new block will need to be allocated to receive the compacted data. It will be seen from FIG. 25D that in this chaotic close case where an error is encountered, the write operation will take longer than the cases shown in FIG. 25A to FIG. 25C. This is due to having to relocate the data of a chaotic block two times. In this case, the total operation substantially uses up most of the latency period T_{W} for the write command. A method for avoiding handling program errors in realtime has been described in U.S. Application Publication No. US-2005-0144365-A1. Instead, the error encountered is dealt with in a later time. In this way, the danger of exceeding T_{W} is minimized at the expense of adding to the number of scheduled task to be performed later.

### Rewrites of Control Data Blocks

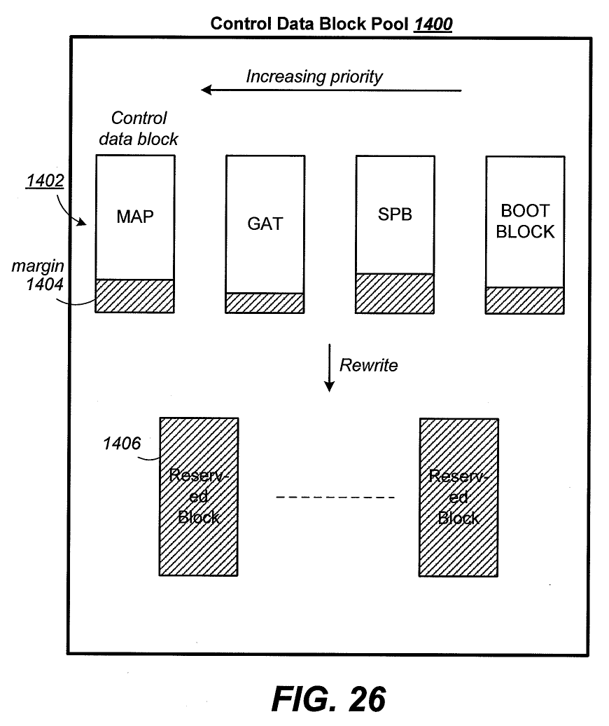

FIG. 26 illustrates schematically a pool of blocks reserved for storing control data. Using the example given in FIG. 20, there are four types of control information with at least one block dedicated to storing each type of control data. Thus the pool of control data blocks 1400 contains a number blocks 1402 reserved for storing control data. In particular, a MAP block is for storing MAP control data, a GAT block is for storing GAT control data, a SPB block is for storing SPBI/CBI control data and a Boot block is for storing boot block control data.

As a control block becomes full, an internal rewrite operation relocates valid data from it to a new block which replaces it in the pool. In some implementation, a number of erased blocks 1406 are reserved in the pool in case a cascade of rewrites takes place at the same time.

The worst-case cascade update is when the Boot block, the MAP block, the Scratch Pad block and the GAT block are rewritten in the same busy period. Compound to this, the cascade update could also coincide with an update block garbage collection during a host write. In order to avoid such cascade updates, when the control blocks are nearly full, they will be rewritten at the earliest available opportunity so that in a worst case scenario, there will always be enough time to rewrite the control blocks preemptively before being forced to rewrite them as a result of a host write with critical timing.

FIG. 26 illustrates a ‘nearly full’ threshold or margin 1404 for each of the control blocks 1402. When the write pointer for the control block reaches this threshold, a flag will be set to rewrite the block. The block will then be rewritten at the next earliest opportunity. Such a preemptive rewrite scheme has also been disclosed in U.S. Application Publication No. US-2005-0144365-A1. If this ‘nearly full’ threshold or margin is set too high, the block may not be rewritten before it is forced to do so. On the other hand, if this threshold is set too low, then the block will be rewritten more frequently than required, and so increase the overhead of maintaining the data structure.

In the case where more than one control block becomes nearly full at the same time, control blocks will be rewritten in a predetermined order to ensure that there is always a free reserved block 1406 available for the update, and that an update to one control block will not trigger the rewrite of another control block, forcing the cascade.

### Prioritized Control Data Type

In one implementation, when there are more than one control block rewrites pending, the one with a control data type that is more active is preferentially executed in the next available opportunity found in a host operation. In this way, a minimum of reserved blocks need be set aside as resource for the control block rewrites as only one control block rewrite will take place at a time.

FIG. 26 illustrates the control data types or blocks being prioritized in the order: MAP block->GAT block->SPB Block->Boot block in accordance to a preferred implementation. Generally, the order is that the more active data type will have a higher priority of getting rewritten. Also, by rewriting the MAP block before the GAT block, a GAT block rewrite is guaranteed not to trigger a MAP block rewrite. Furthermore, after the MAP block rewrite, the old MAP block is returned to the erase pool and can immediately be reused for any subsequent control block rewrites. The activity of the SPB depends on the host write patterns, and it can be ranked before the GAT block in an alternative implementation. The Boot block is given the lowest priority since it is updated less frequently than the other blocks, so there is less urgency to rewrite it. In this way, the number of reserved blocks 1406 in the control data block pool 1400 can be reduced to a minimum, such as one reserved block to support one rewrite at any one time.

### Setting margins for Preemptive Rewrites for Worst-Case Host Write Pattern

By ensuring that the threshold is set to allow the worst case host write pattern to happen, a cascade update will be assuredly avoided at any time. The thresholds for each of the control data blocks (e.g., MAP, GAT, SPB and BOOT) are set with a margin of a predetermined number of pages from end. The exact margin for each of the blocks will be dependant on the cascade avoidance mechanism used.

The worst case scenario is compounded by the maximum amount of data pages to transfer during each control block rewrite and the worst case of host write pattern that results in the least opportunity for piggy-backing control block rewrite during the host write.

### Amount of Data to Rewrite for Each Data Type

Using specific example memory systems given earlier, the worst case from the point of amount of data page to transfer during each control block rewrite are as follows. A MAP block rewrite involves copying a maximum of 8 MAP sectors and the EBM sector. If each sector is written in a page, there will be 9 pages to be copied to the new MAP block. A GAT block rewrite involves copying 64 GAT sectors as 16 pages copied to the new GAT block, plus an EBM update of 1 page to the MAP block, which amounts to 8 pages to be copied plus one page to be written. A Scratch Pad block rewrite involves copying 8 Scratch Pad pages (assume there are 8 pages in the update pool) of buffered host data to the new SP block, plus 1 Scratch Pad index update on the new SP block, and 1 EBM update of 1 page to the MAP block, which amounts to 8 pages to be copied and 2 pages to be written. Boot block rewrite involves copying 8 LT sectors, 8 SPBL sectors, and the Boot Sector, which amounts to 17 pages. If two copies of the Boot block are maintained in the memory, the copies are repeated.

Each of the four types of control data block rewrites will require significant time to complete. In an implementation where the update pool is less than 8, or the host data do not needed to be buffered as much, the SPB block rewrites may be faster than the others since there are relatively less pages to copy.

### Case Studies of Control Blocks Rewrites Possibilities for Various Memory Configurations During a Sequence of Worst-Case Host Writes

The ideal time to perform a pre-emptive control block rewrite is to “piggy-back” onto the foreground execution of a host command. This is especially desirable when the new host command itself does not trigger a garbage collection so that there will be more time to perform the control block rewrites within the host command's latency period. However, in many instances a host command such as a host write will be executed along with additional garbage collection (sequential block close, or chaotic block consolidation.) In these instances, there will be less or even insufficient time to piggy-back a control block rewrite.

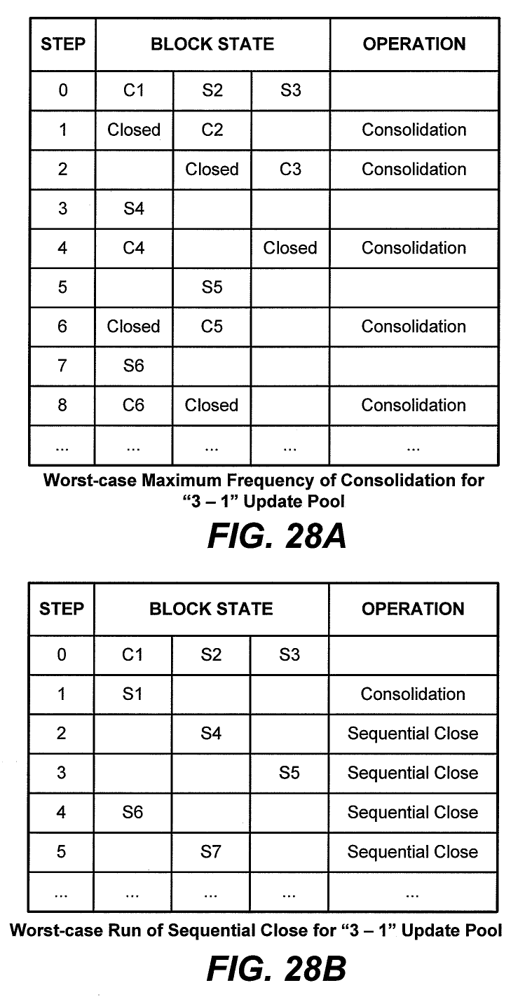

The case studies below of specific memory system and configurations will show that in a worst-case host write pattern, it is possible to get a sequential block close with every host write (see FIG. 28B for example.) Alternatively, it is also possible to get a chaotic block consolidation with every other host write. In order to find room to schedule control data rewrites under these worst-case scenarios, a number of rewrite scheduling methods are possible depending on various timings.

To guarantee that cascade updates are avoided, at least one pre-emptive control block rewrite must be allowed in conjunction with a garbage collection. One method would be to allow one control block rewrite in conjunction with a sequential close, but not with a chaotic block consolidation, since a sequential close is generally a shorter operation. Generally, it is not possible to trigger many consolidations in a row. When there is no garbage collection triggered by the host command operation, the operation time can support up to two control block rewrites.

The method relies on rewriting control blocks at a convenient time, before they become absolutely full. These case studies aim to find the worst sequence of commands with respect to the overheads of garbage collection, and control updates that they trigger. This can then be used to define the order in which control blocks should be rewritten, and how much space must be reserved before they are considered nearly full.

Example calculations for typical update pool configurations (see FIG. 22) are given, differentiating between a worst case with a maximum frequency of chaotic consolidations and one with a run of continuous sequential closes. The following worst-case assumptions are made:

(1) Every write is a single sector write to the Scratch Pad (only 1 busy period, and at least 1 control block write)

(2) Each sequential close triggers a Scratch Pad update. This happens if there was valid host data in the Scratch Pad for this block.

(3) Each chaotic consolidation always triggers a Scratch Pad update.

(4) Each sequential to chaotic conversion triggers a Scratch Pad update.

(5) During the worst run, 1 of the MAP updates will involve a MAP exchange

(6) The update pool or Blocklist is always full, so every request for a new erased metablock triggers a Blocklist release (GAT, and MAP update)

(7) All GAT updates are to the same GAT block since updating different GAT blocks slows down the rate at which GAT blocks fill.

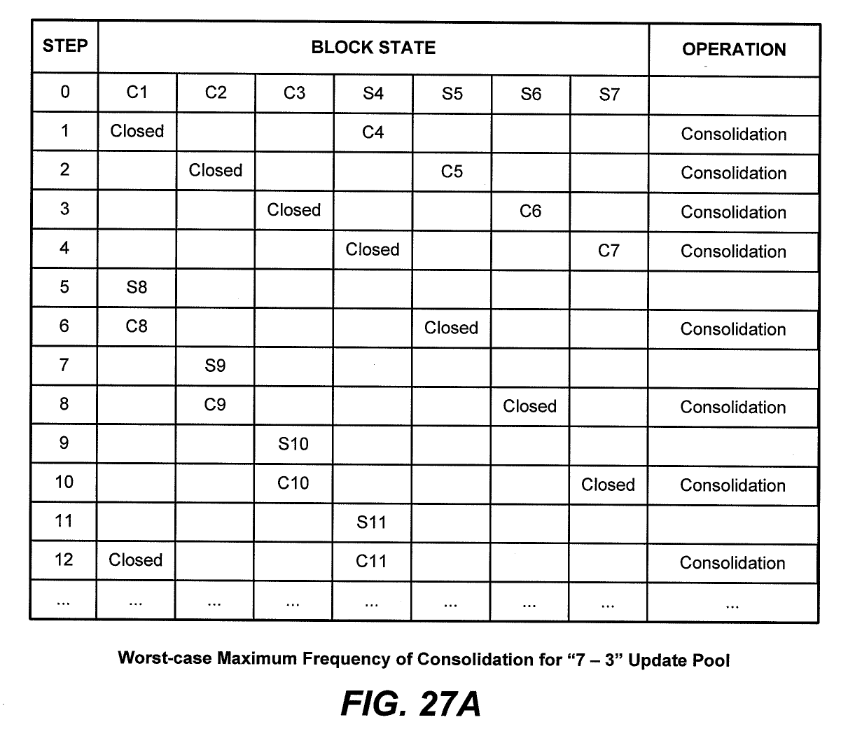

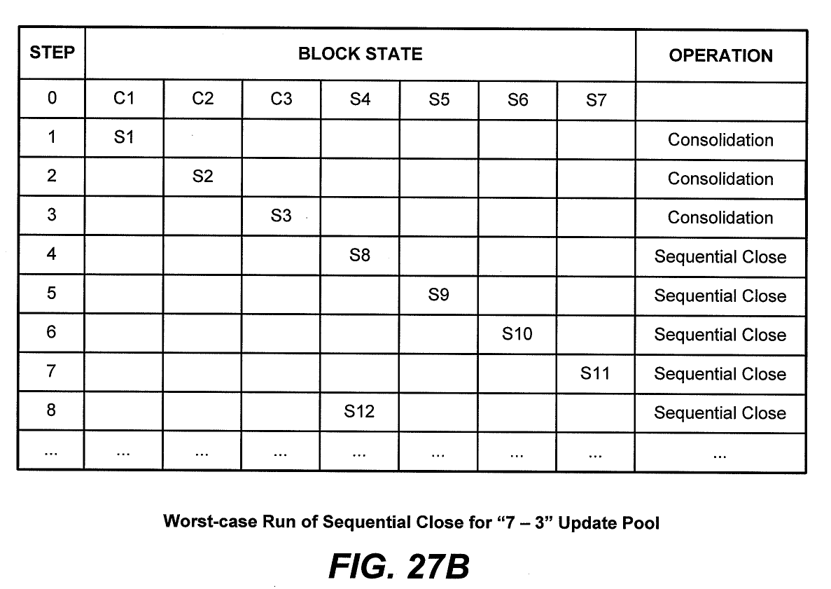

FIG. 27A is a table illustrates a worst-case write pattern producing a maximum frequency of chaotic block consolidations for a memory configuration with a “7-3” update pool. As described earlier in connection with FIG. 22, a “7-3” update pool configuration is one where the memory supports simultaneously a maximum of seven update blocks for storing host data and of which a maximum of three update blocks can be chaotic or non-sequential.

The initial state of the update pool has all 7 update blocks open, with 3 of them being chaotic update blocks. The host write pattern is such the host writes chaotically to each sequential update block, repeatedly opens a new sequential block and, on the next write, makes it go chaotic.

Step 0: Initial state

Step 1: Chaotic block 1 is closed which needs a new metablock (GAT and MAP update), and a write to the Scratch Pad. The new command makes sequential block 4 go chaotic (Scratch Pad update), and then the host data could be written to the Scratch Pad. Total control data triggered: 1 GAT update, 1 MAP update, and 3 Scratch Pad updates. Closing the chaotic block results in the valid data on it being relocated (or consolidated) into another block. According to the method, with this consolidation overhead, no rewrite of control blocks will be piggy-backed in this step.

Step 2-4: As step 1. So no rewrite of control blocks is possible.

Step 5: This is the first opportunity to do a pre-emptive rewrite. The new command opens a new sequential update block. There is a spare update block, so another block need not be closed, but the host write could go to the Scratch Pad. By this point 4 MAP updates, 4 GAT update, and 13 Scratch Pad updates could have been made.

Step 6: As step 1

Step 7: As step 5. By this point 6 MAP pages, 6 GAT pages, and 16 Scratch Pad pages could have been written.

Thus, it is possible to guarantee that the various control blocks get rewritten in time to avoid cascade by rewriting the MAP and GAT blocks in step 5, and the Scratch Pad in step 7, if a margin is set with 6 free MAP pages for the MAP block, with 4 free GAT pages for the GAT block, and with 16 free Scratch Pad pages for the SP block.

FIG. 27B is a table illustrates a worst-case write pattern producing a continuous run of sequential block closes for a memory configuration with a “7-3” update pool.

The initial state of the update pool has all 7 update blocks open, with 3 of them being chaotic update blocks and full. The host write pattern is such that the host writes chaotically to full chaotic blocks, and then repeatedly opens a sequential update block.

Step 0: Initial state

Step 1: Write to chaotic block 1 which is already full. This triggers a consolidation which triggers a GAT and MAP update and a Scratch Pad update. A new sequential update block is opened and the host data is written to the Scratch Pad.

Steps 2 and 3: As step 1

Step 4: This is the first opportunity to do a pre-emptive rewrite. The new command needs a new update block, which closes an existing sequential update block. The close needs a Scratch Pad write, and the new block needs a GAT and MAP update. By this point, 4 MAP updates, 4 GAT updates, and 8 Scratch Pad updates could have been done.

Steps 5 onward: As in step 4, each triggering a sequential close, and allocating a new block triggering 1 GAT, 1 MAP and 2 Scratch Pad updates.

Assuming the MAP block is rewritten in step 4, the GAT block in step 5 and the Scratch Pad in step 6, then the margin need be set with 6 pages in the MAP block, 5 pages in the GAT block, and 12 pages in the Scratch Pad block.

FIG. 28A is a table illustrates a worst-case write pattern producing a maximum frequency of chaotic block consolidations for a memory configuration with a “3-1” update pool. As described earlier in connection with FIG. 22, a “3-1” update pool configuration is one where the memory supports simultaneously a maximum of three update blocks for storing host data and at most one of three update blocks can be chaotic or non-sequential.

The initial state of the update pool has all 3 update blocks open, with 1 of them being chaotic update block. The host write pattern is such the host writes chaotically to each sequential update block, repeatedly opens a new sequential block and, on the next write, makes it go chaotic.

Step 0: Initial state

Step 1: Chaotic block 1 is closed which needs a new metablock (GAT and MAP update), and a write to the Scratch Pad. The new command makes sequential block 2 go chaotic (Scratch Pad update), and then the host data could be written to the Scratch Pad. Total 1 GAT page, 1 MAP page, and 3 Scratch Pad pages.

Step 2: As step 1

Step 3: This is the first opportunity to do a pre-emptive rewrite. The new command opens a new sequential update block. There is a spare update block, so another block need not be closed, but the host write could go to the Scratch Pad. By this point 3 MAP updates, 3 GAT updates, and 7 Scratch Pad updates could have been made.

Step 4: As step 1

Step 5: As step 3. By this point 6 MAP updates, 6 GAT updates, and 11 Scratch Pad updates could have been made.

Thus, it is possible to guarantee that the various control blocks get rewritten in time to avoid cascade by rewriting the MAP and GAT blocks in step 3, and the Scratch Pad in step 5, if a margin is set with 5 free MAP pages for the MAP block, with 3 free GAT pages for the GAT block, and with 11 free Scratch Pad pages for the SP block.

FIG. 28B is a table illustrates a worst-case write pattern producing a continuous run of sequential block closes for a memory configuration with a “3-1” update pool.

The initial state of the update pool has all 3 update blocks open, with 1 of them being chaotic update block and full. The host write pattern is such that the host writes chaotically to full chaotic blocks, and then repeatedly opens a sequential update block.

Step 0: Initial state

Step 1: Write to chaotic block 1 which is already full. This triggers a consolidation which triggers a GAT and MAP update and a Scratch Pad update. A new sequential update block is opened and the host data is written to the Scratch Pad. A total of 2 GAT updates, 2 MAP updates and 2 Scratch Pad updates could have been made by this point.

Step 2: This is the first opportunity to do a pre-emptive rewrite. The new command needs a new update block, which closes an existing sequential update block. The close needs a Scratch Pad write, and the new block needs a GAT and MAP update. By this point, 3 MAP updates, 3 GAT updates, and 6 Scratch Pad updates could have been done.

Steps 3 onward: As in step 2, each triggering a sequential close, and allocating a new block triggering 1 GAT, 1 MAP and 2 Scratch Pad updates.

Assuming the MAP block is rewritten in step 2, the GAT block in step 3 and the Scratch Pad in step 4, then the margin need be set with 5 pages in the MAP block, 4 pages in the GAT block, and 10 pages in the Scratch Pad block.

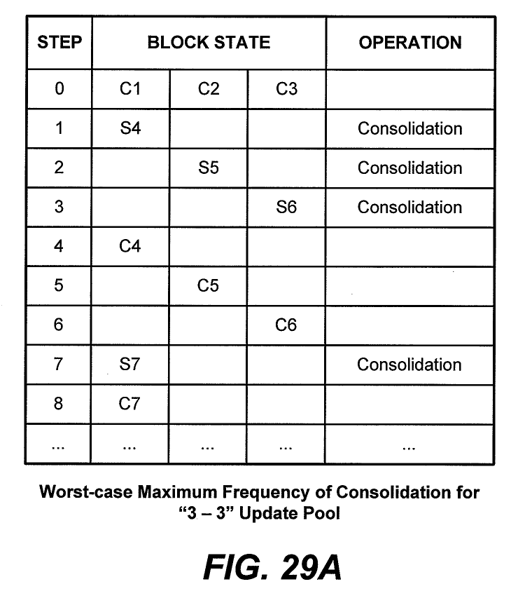

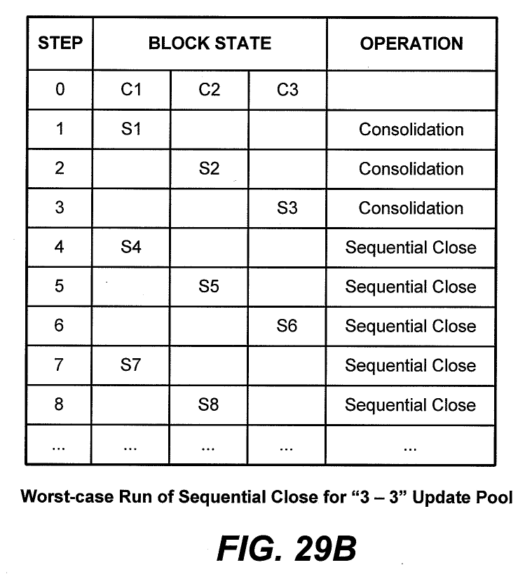

FIG. 29A is a table illustrates a worst-case write pattern producing a maximum frequency of chaotic block consolidations for a memory configuration with a “3-3” update pool. As described earlier in connection with FIG. 22, a “3-3” update pool configuration is one where the memory supports simultaneously a maximum of three update blocks for storing host data and any of the three update blocks can be either sequential or chaotic.

The initial state of the update pool has all 3 update blocks open, with 3 of them being chaotic update blocks. The host write pattern is such the host writes chaotically to each sequential update block, repeatedly opens a new sequential block and, on the next write, makes it go chaotic.

Step 0: Initial state

Step 1: Chaotic block 1 is closed which needs a new metablock (GAT and MAP update), and a write to the Scratch Pad. The new command needs a new metablock, (GAT and MAP updates), and goes to the Scratch Pad. A total of 2 GAT updates, 2 MAP updates, and 2 Scratch Pad updates could have been made by this point.

Steps 2 and 3: As step 1

Step 4: This is the first opportunity to do a pre-emptive rewrite. The new command opens a new sequential update block. There is a spare update block, so another block need not be closed, but the host write could go to the Scratch Pad. By this point 6 MAP updates, 6 GAT updates, and 8 Scratch Pad updates could have been done.

Steps 5 and 6: As step 4

Step 7: As step 1

Thus, it is possible to guarantee that the various control blocks get rewritten in time to avoid cascade by rewriting the MAP and GAT blocks in step 4, and the Scratch Pad in step 5, if the margin is set with 8 free MAP pages for the MAP block, with 6 free GAT pages for the GAT block, and with 10 free Scratch Pad pages for the SP block.

FIG. 29B is a table illustrates a worst-case write pattern producing a continuous run of sequential block closes for a memory configuration with a “3-3” update pool.

The initial state of the update pool has all 3 update blocks open, with 3 of them being chaotic update blocks and full. The host write pattern is such that the host writes chaotically to full chaotic blocks, and then repeatedly opens a sequential update block.

Step 0: Initial state

Step 1: Write to chaotic block 1 which is already full. This triggers a consolidation which triggers a GAT and MAP update and a Scratch Pad update. A new sequential update block is opened and the host data is written to the Scratch Pad. A total of 2 GAT updates, 2 MAP updates and 2 Scratch Pad updates could have been made by this point.

Steps 2 and 3: As step 1

Step 4: This is the first opportunity to do a pre-emptive rewrite. The new command needs a new update block, which closes an existing sequential update block. The close needs a Scratch Pad write, and the new block needs a GAT and MAP update. By this point, 7 MAP updates, 4 GAT updates, and 8 Scratch Pad updates could have been done.

Steps 5 on: As step 4, each triggering a sequential close, and allocating a new block triggering 1 GAT, 1 MAP and 2 Scratch Pad updates.

Thus, it is possible to guarantee that the various control blocks get rewritten in time to avoid cascade by writing the MAP block in step 4, the GAT block in step 5 and the Scratch Pad in step 6, if the margin is set with 9 pages in the MAP block, 5 pages in the GAT block, and 12 pages in the Scratch Pad block.

### Error Handling

A program error during a data relocation operation is more critical since the time-consuming operation may need to be restarted again. One possible occurrence is during a chaotic block consolidation or a sequential block close triggered by a host command. Another possible occurrence is during a control block rewrite. The pre-emptive control block rewrite to avoid cascade will need to take these problems into consideration.

A program error during consolidation is handled in one of two ways. If the error happens near the start of the consolidation, then the consolidation is restarted using another block. If the error happens nearer the end of the consolidation, then the phased error block is used to store the remaining sectors. Phased program error handling has been disclosed in U.S. Application Publication No. US-2005-0166087-A1, published Jul. 28, 2005. If phased error is used, then the phased error block will be closed at the next convenient time and its data relocated to a non-defective block. This means that pre-emptive rewrites would be delayed. To account for this more sectors need to be reserved in the margin of each of the control blocks. A program error during sequential close is essentially handled in the same manner as that during a consolidation.

A program error may also occur during a control data update. One way of handling the error is to relocate the control data to a new control block. An alternative is to write the sector to the next available page in the control block. A flag could then be set so this block is rewritten at the next convenient time. This would require reserving an extra page in the margin of the control block.

A program error during a pre-emptive control block rewrite is handled by repeating the rewrite to another block. An alternative is to abandon the pre-emptive rewrite and attempt the rewrite again at the next convenient time.

In both cases, any other pending pre-emptive rewrites would be delayed. To account for this, extra sectors need to be reserved in the margin of each of the control blocks.

### Scheduling Methods for Pre-emptive Control Blocks Rewrite

As mentioned earlier, a number of control block rewrite scheduling methods are possible depending on various timings of the host and memory systems. The following is some examples of the control block rewrite scheduling methods.

Method 1 is the method used to perform the calculations for the case studies illustrated in FIGS. 27A-27B, FIGS. 28A-28B and FIGS. 29A-29B. It basically assumes that the host write latency allows sufficient time to do two rewrites when there is no garbage collection triggered by the command; to do one rewrite when the garbage collection involves a sequential close; and no rewrite when the garbage collection involves a chaotic close.

1. Do no pre-emptive control block rewrites in the same busy period as a chaotic block consolidation.

2. Allow 1 pre-emptive control block rewrite in the same busy period as a sequential block close.

3. Allow 2 pre-emptive control block rewrites when there is no update block garbage collection.

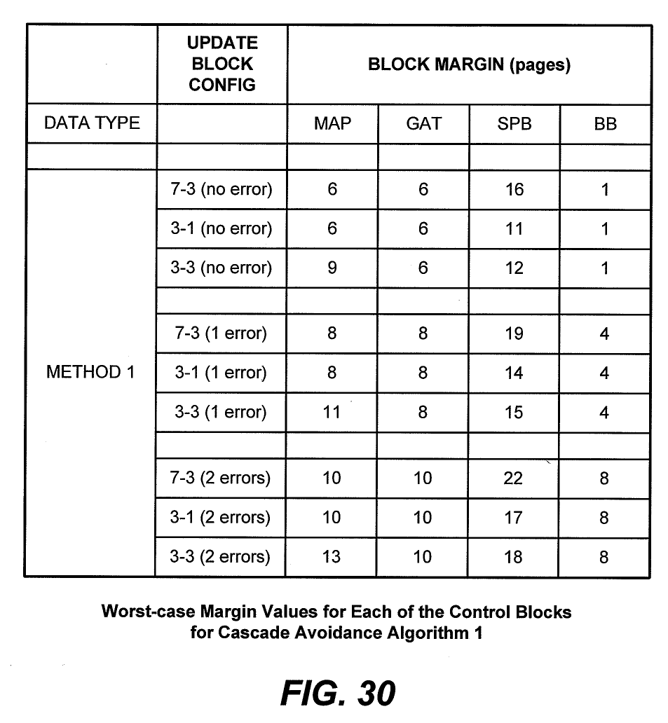

FIG. 30 is a table listing example calculated margins for each control data type by applying the control block rewrite schedule of Method 1. In summary, Method 1 should have the margins set with 9 MAP pages for the MAP block, 6 GAT pages for the GAT block and 16 pages for the Scratch Pad block for all update pool configurations. Also for each error to be handled, 2 extra pages should be added to each margin.

Method 2 basically assumes that the host write latency allows sufficient time to do a short control block rewrite such as a Scratch Pad rewrite even if the host write has triggered a garbage collection.

1. Allow pre-emptive Scratch Pad rewrite at any time.

2. Allow 1 pre-emptive control block rewrite in same busy period as sequential close.

3. Allow 2 pre-emptive control block rewrites when there is no update block garbage collection.

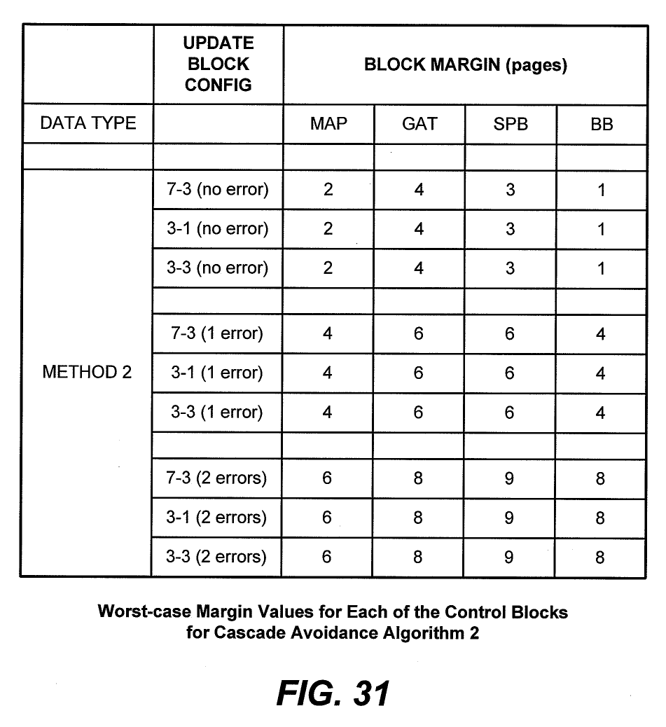

FIG. 31 is a table listing example calculated margins for each control data type by applying the control block rewrite schedule of Method 2. In summary, Method 2 should have the margins set with 2 MAP pages for the MAP block, 4 GAT pages for the GAT block and 3 pages for the Scratch Pad block for all update pool configurations. Also for each error to be handled, 2 extra pages should be added to each margin.

Method 3 basically takes a more quantitatively approach by examining the amount of pages to relocate for each of the rewrites and if any of them could be executed within the remaining time set by the host write latency. This method will utilize the host write latency period most efficiently at the expense of micro-tracking the amount of relocation for each rewrite. The advantage is that the margins will be at a minimum.

1. Count work required for each control block rewrite (number of page copies).

2. Allow pre-emptive control block rewrites until total work done exceeds a defined threshold.

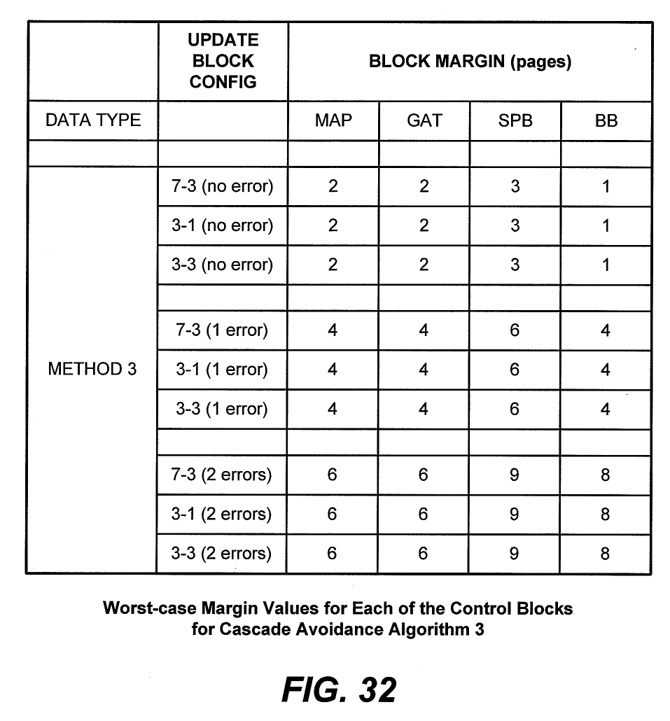

FIG. 32 is a table listing example calculated margins for each control data type by applying the control block rewrite schedule of Method 3. In summary, Method 3 should have the margins set with 2 MAP pages for the MAP block, 2 GAT pages for the GAT block and 3 pages for the Scratch Pad block for all update pool configurations. Also for each error to be handled, 2 extra pages should be added to each margin.

Method 4 is similar to Method 1 with the additional assumption that a chaotic close can be performed at the same speed as a sequential close.

1. Rewrite the control blocks in the order MAP->Scratch Pad->GAT->BB. This allows us to reserve 4 less pages in the SP

2. Allow 1 pre-emptive control block rewrite in the same busy period as either a sequential close or chaotic compaction.

3. Allow 2 pre-emptive control block rewrites when there is no update block garbage collection.

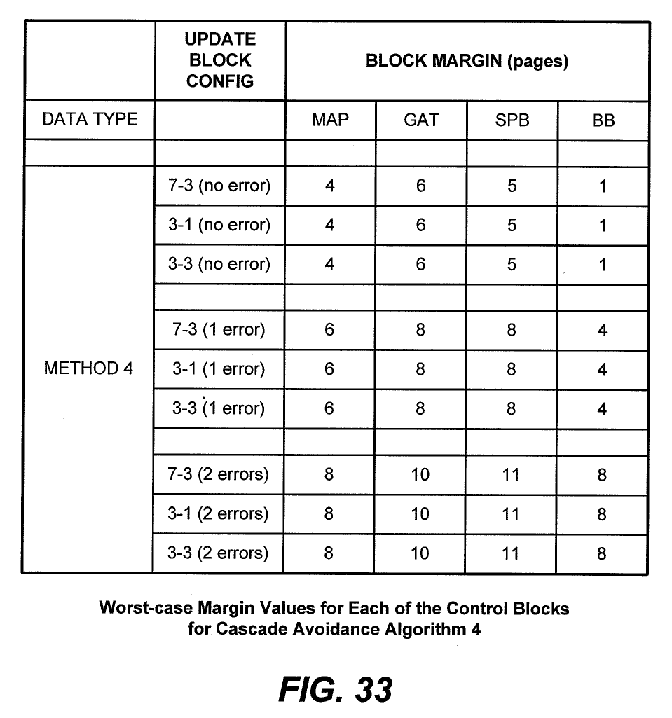

FIG. 33 is a table listing example calculated margins for each control data type by applying the control block rewrite schedule of Method 4. In summary, Method 4 should have the margins set with 4 MAP pages for the MAP block, 6 GAT pages for the GAT block and 5 pages for the Scratch Pad block for all update pool configurations. Also for each error to be handled, 2 extra pages should be added to each margin.

### Improved Pre-emptive Control Data Relocation

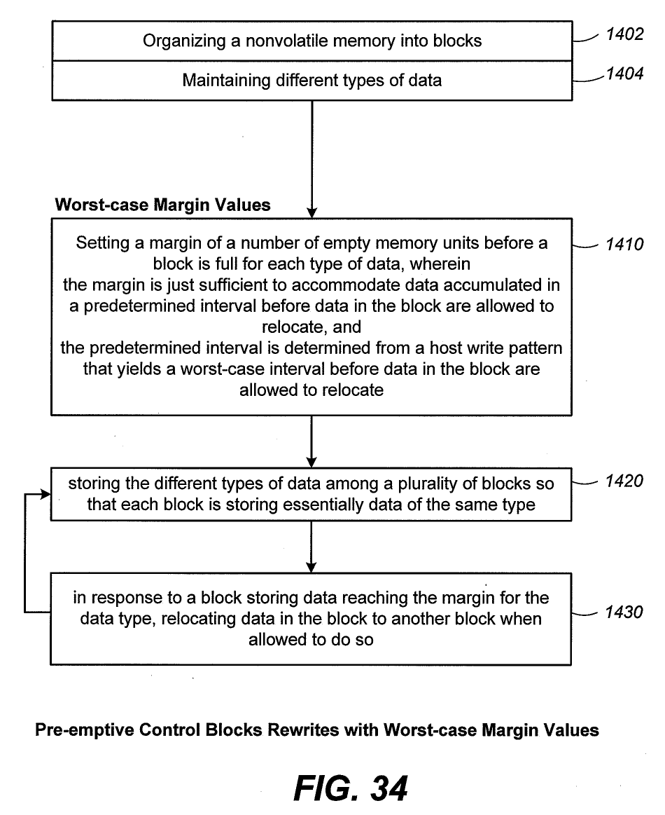

FIG. 34 is a flow diagram illustrating a scheme for pre-emptive rewrites of control data blocks based on worst-case considerations.

### STEP 1402: Organizing a nonvolatile memory into blocks.

### STEP 1404: Maintaining different types of data.

STEP 1410: Setting a margin of a number of empty memory units before a block is full for each type of data, wherein the margin is just sufficient to accommodate data accumulated in a predetermined interval before data in the block are allowed to relocate, and the predetermined interval is determined from a host write pattern that yields a worst-case interval before data in the block are allowed to relocate.

### STEP 1420: Storing updates of said different types of data among a plurality of blocks so that each block is storing essentially data of the same type.

STEP 1430: In response to a block storing data reaching the margin for the data type, relocating data in the block to another block when allowed to do so. Go to STEP 1420 unless interrupted.

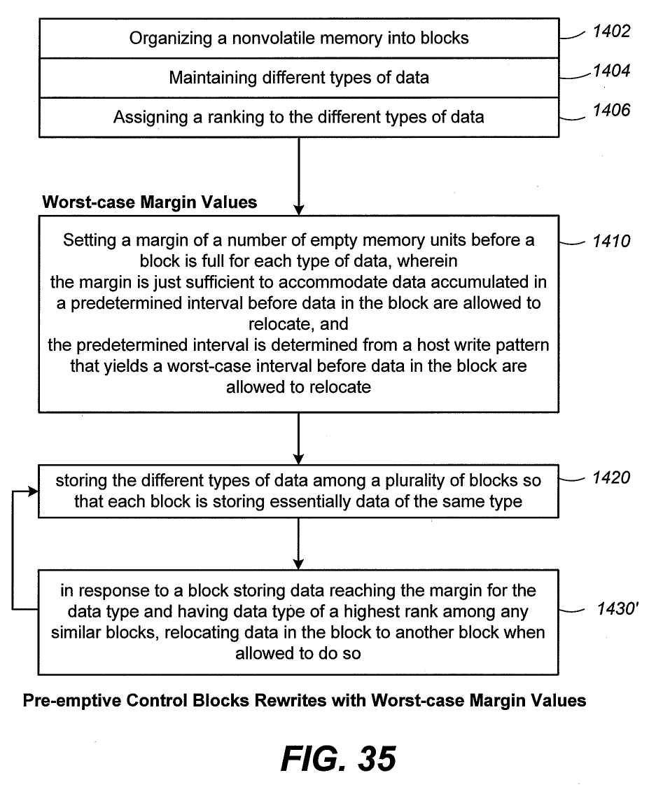

FIG. 35 is a flow diagram illustrating an alternative scheme for pre-emptive rewrites similar to that of FIG. 34 except with the additional preferential treatment of a higher ranked data type.

### STEP 1402: Organizing a nonvolatile memory into blocks.

### STEP 1404: Maintaining different types of data.

### STEP 1406: Assigning a ranking to the different types of data.

STEP 1410: Setting a margin of a number of empty memory units before a block is full for each type of data, wherein the margin is just sufficient to accommodate data accumulated in a predetermined interval before data in the block are allowed to relocate, and the predetermined interval is determined from a host write pattern that yields a worst-case interval before data in the block are allowed to relocate.

### STEP 1420: Storing updates of said different types of data among a plurality of blocks so that each block is storing essentially data of the same type.

STEP 1430′: In response to a block storing data reaching the margin for the data type and having data type of a highest rank among any similar blocks, relocating data in the block to another block when allowed to do so. Go to STEP 1420 unless interrupted.

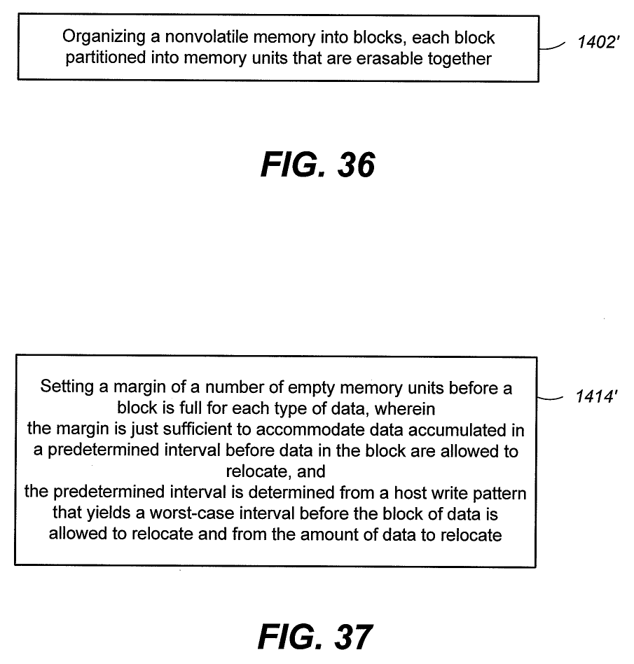

FIG. 36 illustrates an alternative step for one of the steps of the flow diagrams of FIGS. 34 and 35. STEP 1402′ is an alternative step for STEP 1402 shown in FIG. 34 and FIG. 35.

### STEP 1402′: Organizing a nonvolatile memory into blocks, each block partitioned into memory units that are erasable together.

FIG. 37 illustrates another alternative step for one of the steps of the flow diagrams of FIGS. 34 and 35. STEP 1410′ is an alternative step for STEP 1410 shown in FIG. 34 and FIG. 35.

STEP 1410′: Setting a margin of a number of empty memory units before a block is full for each type of data, wherein the margin is just sufficient to accommodate data accumulated in a predetermined interval before data in the block are allowed to relocate, and the predetermined interval is determined from a host write pattern that yields a worst-case interval before the block of data is allowed to relocate and from the amount of data to relocate.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

Although the various aspects of the present invention have been described with respect to certain embodiments, it is understood that the invention is entitled to protection within the full scope of the appended claims.

It is claimed:

1. A memory, comprising:
a nonvolatile memory organized into blocks;
one or more types of data maintained in the memory;
a margin for each type of data, said margin being a number of empty memory units before a block is full such that said margin is just sufficient to accommodate data accumulated in a predetermined interval before data in the block are allowed to relocate, the predetermined interval being determined from a host write pattern that yields a worst-case interval before data in the block are allowed to relocate;
a plurality of blocks for storing updates of said one or more type of data with each of the blocks therein storing essentially data of the same type; and
read/write circuits for relocating data in the block to another block when allowed to do so in response to a block storing data reaching the margin for the data type.

2. The memory as in claim 1, wherein:
operating the memory includes a host writing thereto, and
the predetermined interval is dependent on a worst-case host write pattern that yields a maximum interval before data in the block are allowed to relocate.

3. The memory as in claim 1, wherein:
the predetermined interval is dependent on a worst-case configuration of blocks that yields a maximum amount of data to relocate.

4. The memory as in claim 1, wherein:
said different types of data have predetermined ranking; and
said read/write circuit relocating data is responsive to a block storing data reaching the margin for the data type and having data type of a highest rank among any similar blocks.

5. The memory as in claim 4, wherein the type of data having the highest rank is one that is expected to fill the blocks the fastest.

6. The memory as in claim 1, wherein the different types of data are control data the memory uses to manage the blocks.

7. The memory as in claim 6, wherein the different types of control data include one that controls provisioning of the blocks.

8. The memory as in claim 6, wherein the different types of control data include one that pertains to location of data stored in the blocks.

9. The memory as in claim 6, wherein data in the block are allowed to relocate during execution of a host command on the memory.

10. The memory as in claim 1, wherein the predetermined interval before data in the block are allowed to relocate depends on the time required for relocating the data in the block.

11. The memory as in claim 1, wherein the predetermined interval before data in the block are allowed to relocate depends on how a pool of blocks opened for receiving host data is configured.

12. The memory as in claim 1, wherein the predetermined interval before data in the block are allowed to relocate depends on a maximum time set by a host command.

13. The memory as in claim 1, wherein the data in each block are erasable together.

14. The memory as in claim 2, wherein the data in each block are erasable together.

15. The memory as in claim 3, wherein the data in each block are erasable together.

16. The memory as in claim 4, wherein the data in each block are erasable together.

17. The memory as in claim 5, wherein the data in each block are erasable together.

18. The memory as in claim 6, wherein the data in each block are erasable together.

19. The memory as in claim 7, wherein the data in each block are erasable together.

20. The memory as in claim 8, wherein the data in each block are erasable together.

21. The memory as in claim 9, wherein the data in each block are erasable together.

22. The memory as in claim 10, wherein the data in each block are erasable together.

23. The memory as in claim 11, wherein the data in each block are erasable together.

24. The memory as in claim 12, wherein the data in each block are erasable together.

25. The memory as in claim 1, wherein the memory is a one-time programmable memory.

26. The memory as in claim 1, wherein the memory is flash EEPROM.

27. The memory as in claim 1, wherein the memory is embodied in a removable memory card.

28. A memory, comprising:
a nonvolatile memory organized into blocks;
one or more type of data maintained in the memory;
a margin for each type of data, said margin being a number of empty memory units before a block is full such that said margin is just sufficient to accommodate data accumulated in a predetermined interval before data in the block are allowed to relocate, the predetermined interval being determined from a host write pattern that yields a worst-case interval before data in the block are allowed to relocate;
a plurality of blocks for storing updates of said one or more type of data with each of the blocks therein storing essentially data of the same type; and
means for relocating data in the block to another block when allowed to do so in response to a block storing data reaching the margin for the data type.

29. The memory as in claim 28, wherein:
said different types of data have predetermined ranking; and
said means for relocating data is responsive to a block storing data reaching the margin for the data type and having data type of a highest rank among any similar blocks.

30. The memory as any one of claims 1 to 29, wherein the memory has memory cells that each stores one bit of data.

31. The memory as any one of claims 1 to 29, wherein the memory has memory cells that each stores more than one bit of data.
